(19) United States
(12) Patent Application Publication
(10) Pub. No.: US 2025/0340724 A1
(43) Pub. Date: Nov. 6, 2025

(54) POLYMER BLEND AND MULTILAYER FILM STRUCTURE

(71) Applicant: NOVA CHEMICALS (INTERNATIONAL) S.A., Fribourg (CH)

(72) Inventors: Vinod Konaganti, Seattle, WA (US); Soheil Sadeghi, Calgary (CA)

(73) Assignee: NOVA CHEMICALS (INTERNATIONAL) S.A., Fribourg (CH)

(21) Appl. No.: 18/866,390

(22) PCT Filed: Apr. 27, 2023
(86) PCT No.: PCT/IB2023/054370

§ 371 Date: Nov. 15, 2024

Related U.S. Application Data
(60) Provisional application No. 63/345,600, filed on May 25, 2022.

(51) Int. Cl. C08L 23/0807

(52) U.S. Cl. CPC C08L 23/0815; C08L 2203/16; C08L 2205/025; C08L 2205/03; C08L 2207/066; C08L 2314/02; C08L 2314/06

(57) ABSTRACT

The present invention provides a polymer blend, which comprises a low-density polyethylene and an ethylene copolymer composition and which is suitable for use in a film layer. The invention also relates to film layers and to multilayer film structures comprising such film layers, which structures are particularly useful in collation shrink packaging applications.

### TECHNICAL FIELD

The present invention relates to a polymer blend suitable for use in a film layer. The invention also relates to film layers and to multilayer film structures comprising such film layers, which structures are particularly useful in collation shrink packaging applications.

### BACKGROUND ART

Collation shrink packaging generally involves wrapping one or more articles in a heat shrink film to form a package, and then heat shrinking the film (near the melting point) by exposing it to sufficient heat to cause shrinkage and intimate contact between the film and article(s). Collation shrink films are typically used for bundling goods such as beverages, bottled water, food cans, health and beauty products, newspaper and magazine bundles, and household items.

Collation shrink films are typically made of polyethylene. It is highly desirable to use polyethylenes that provide optimum mechanical properties, such as stiffness-toughness balance and MD/TD tear balance (essential for good package integrity), and enhanced optical properties (for shelf appeal), especially for premium shrink packaging applications. Such resins allow the production of thinner and tougher/stronger films, while offering excellent package integrity. For instance, U.S. Pat. Nos. 6,045,882; 7,588,830; and 9,206,303 disclose examples of multilayer polyethylene shrink films, having good strength and optical properties.

Multicomponent polyethylene compositions are well known in the art. One method to access multicomponent polyethylene compositions is to use two or more distinct polymerization catalysts in one or more polymerization reactors, which may be configured in series or in parallel. For example, the use of single-site and Ziegler-Natta-type polymerization catalysts in at least two distinct solution polymerization reactors is known, such as in WO 2018/193375 and WO 2021/019370, which disclose ethylene copolymer compositions comprising at least two ethylene copolymers of particular properties which are made in distinct reactors.

Solution polymerization processes are generally carried out at temperatures above the melting point of the ethylene homopolymer or copolymer product being made. In a typical solution polymerization process, catalyst components, solvent, monomers and hydrogen are fed under pressure to one or more reactors.

For solution phase ethylene polymerization, or ethylene copolymerization, reactor temperatures can range from about 80° C. to about 300° C., while pressures generally range from about 3 MPag to about 45 MPag. The ethylene homopolymer or copolymer produced remains dissolved in the solvent under reactor conditions. The residence time of the solvent in the reactor is relatively short, for example from about 1 second to about 20 minutes. The solution process can be operated under a wide range of process conditions that allow the production of a wide variety of ethylene polymers. Post-reactor, the polymerization reactor is quenched to prevent further polymerization, by adding a catalyst deactivator, and optionally passivated, by adding an acid scavenger. Once deactivated (and optionally passivated), the polymer solution is passed to a polymer recovery operation (a devolatilization system), where the ethylene homopolymer or copolymer is separated from process solvent, unreacted residual ethylene and unreacted optional α-olefin(s).

Regardless of the manner of production, there remains a need to improve the performance of multicomponent polyethylene compositions in film applications.

Low-density polyethylene (LDPE) is a commonly used type of material for collation shrink films. Blending LDPE with linear low-density polyethylene (LLDPE) or medium-density polyethylene (MDPE) tends to improve overall toughness and stiffness of a film structure, but typically leads to inferior shrink performance and poor package integrity (see F. J. Velisek, Journal of Plastic Film & Sheeting (1991), 7 (4), page 332-354; and A. Torres et al., Journal of Plastic Film & Sheeting (2006), 22 (1), page 29-37).

The present invention has been devised in light of the above considerations.

### SUMMARY OF INVENTION

A first aspect of the invention is a polymer blend comprising from 20 to 50 weight percent of a low-density polyethylene (LDPE), and from 80 to 50 weight percent of an ethylene copolymer composition; wherein the ethylene copolymer composition is an ethylene-alpha-olefin copolymer composition comprising:
(i) from 30 to 50 weight percent of a first ethylene copolymer having a density of from 0.890 to 0.930 g/cm³, a molecular weight distribution (Mw/Mn) of from 1.7 to 2.3, and a melt index (I₂) of from 0.1 to 20 g/10 min;
(ii) from 50 to 70 weight percent of a second ethylene copolymer having a density of from 0.925 to 0.945 g/cm³, a molecular weight distribution (Mw/Mn) of from 2.3 to 6.0, and a melt index (I₂) of from 0.3 to 100 g/10 min; and
(iii) from 0 to 20 weight percent of a third ethylene copolymer;
   wherein the number of short chain branches per thousand carbon atoms in the first ethylene copolymer (SCB1) is greater than the number of short chain branches per thousand carbon atoms in the second ethylene copolymer (SCB2);
the density of the second ethylene copolymer is greater than the density of the first ethylene copolymer;
the ethylene copolymer composition has a density of from 0.916 to 0.940 g/cm³, a molecular weight distribution (Mw/Mn) of from 2.3 to 6.0, a melt index (I₂) of less than 1 g/10 min, a nonlinear rheology network parameter (Δ_{int.}) of from 0.055 to 0.075, and a normalized molecular weight (Z) of from 80 to 120 wherein the normalized molecular weight is defined by Z=M_{w}/Mₑ;
   and the LDPE has a melt index (I₂) of less than 3 g/10 min;
wherein the weight percent of the first, second or third ethylene copolymer is defined as the weight of the first, second or third copolymer respectively divided by the weight of the sum of (i) the first ethylene copolymer; (ii) the second ethylene copolymer; and (iii) the third ethylene copolymer, multiplied by 100; and the weight percent of the LDPE or the ethylene copolymer composition is defined as the weight of the LDPE or the ethylene copolymer composition respectively divided by the weight of the sum of the LDPE and the ethylene copolymer composition, multiplied by 100.

By making a blend of the particular ethylene copolymer composition with the LDPE, which has a specific combination of properties including molecular weight distribution, comonomer distribution and high density fraction, a polymer blend is obtained that surprisingly leads to collation shrink films with an improved balance of optical properties (haze and gloss) and physical properties (toughness/stiffness and MD/TD tear balance), compared with an equivalent LLDPE or MDPE of similar melt index and density, while yielding similar or better shrink performance characteristics (measurable by shrink force, percentage shrinkage, package integrity).

A second aspect of the invention is an ethylene copolymer composition, as defined above in relation to the first aspect. The ethylene copolymer composition has the specific combination of properties as described herein, and in particular high levels of long chain branching, as indicated by Network parameter (Δ_{int.}) and LCBF values. Hence, the first aspect provides a polymer blend comprising the ethylene copolymer composition of the second aspect.

In some embodiments, the first ethylene copolymer of the ethylene copolymer composition is present in from 35 to 45 weight percent. In some embodiments, the first ethylene copolymer is present in from 40 to 45 weight percent.

In some embodiments, the second ethylene copolymer of the ethylene copolymer composition is present in from 55 to 65 weight percent. In some embodiments, the second ethylene copolymer is present in from 55 to 60 weight percent.

The presence of the third ethylene copolymer is optional. In some embodiments, the third ethylene copolymer is present. In some embodiments, the third ethylene copolymer is present in from 5 to 15 weight percent. In alternative embodiments, the third ethylene copolymer is absent, i.e. present in 0 weight percent.

In some embodiments, the first ethylene copolymer is present in from 30 to 50 weight percent, the second ethylene copolymer is present in from 50 to 70 weight percent, and the third ethylene copolymer is present in 0 weight percent.

In some embodiments, the first ethylene copolymer is present in from 35 to 45 weight percent, and the second ethylene copolymer is present in from 55 to 65 weight percent. In some embodiments, the first ethylene copolymer is present in from 40 to 45 weight percent, and the second ethylene copolymer is present in from 55 to 60 weight percent.

In some embodiments, the first ethylene copolymer is present in from 35 to 45 weight percent, the second ethylene copolymer is present in from 55 to 65 weight percent, and the third ethylene copolymer is present in 0 weight percent. In some embodiments, the first ethylene copolymer is present in from 40 to 45 weight percent, the second ethylene copolymer is present in from 55 to 60 weight percent, and the third ethylene copolymer is present in 0 weight percent.

In some embodiments, the ethylene copolymer composition (which is an ethylene-alpha-olefin copolymer composition) has at least 0.8 mole percent of one or more than one alpha-olefin, for example at least 1 mole percent or at least 2 mole percent. In some embodiments, the ethylene copolymer composition has at most 10 mole percent of one or more than one alpha-olefin, for example at most 8 mole percent or at most 5 mole percent or at most 3 mole percent.

In some embodiments, the ethylene copolymer composition has from 0.8 to 10 mole percent of one or more than one alpha-olefin, for example from 0.8 to 8 mole percent, or from 1 to 10 mole percent, or from 1 to 8 mole percent, or from 1 to 5 mole percent, or from 1 to 3 mole percent, or from 2 to 8 mole percent, or from 2 to 5 mole percent, or from 2 to 3 mole percent.

In some embodiments, the said one or more than one alpha-olefin is selected from the group comprising 1-hexene, 1-octene and mixtures thereof. In some embodiments, the said one or more than one alpha-olefin is 1-octene.

In some embodiments, the first ethylene copolymer is made with a single-site catalyst system. In some embodiments, the second ethylene copolymer is made with a Ziegler-Natta catalyst system. In some embodiments, where the third ethylene copolymer is present, the third ethylene copolymer is made with a Ziegler-Natta catalyst system.

In some embodiments, the first ethylene copolymer is made with a single-site catalyst system and the second ethylene copolymer is made with a Ziegler-Natta catalyst system. In some embodiments, the first ethylene copolymer is made with a single-site catalyst system and the third ethylene copolymer is made with a Ziegler-Natta catalyst system. In some embodiments, the second ethylene copolymer is made with a Ziegler-Natta catalyst system and the third ethylene copolymer is made with a Ziegler-Natta catalyst system. In some embodiments, the first ethylene copolymer is made with a single-site catalyst system, the second ethylene copolymer is made with a Ziegler-Natta catalyst system and the third ethylene copolymer is made with a Ziegler-Natta catalyst system.

In some embodiments, the polymer blend comprises from 20 to 45 weight percent of the LDPE. In some embodiments, the polymer blend comprises from 25 to 50 weight percent of the LDPE. In some embodiments, the polymer blend comprises from 25 to 45 weight percent of the LDPE. In some embodiments, the polymer blend comprises from 30 to 50 weight percent of the LDPE. In some embodiments, the polymer blend comprises from 30 to 45 weight percent of the LDPE. In some embodiments, the polymer blend comprises from 35 to 45 weight percent of the LDPE. In some embodiments, the polymer blend comprises from 37 to 43 weight percent of the LDPE. In some embodiments, the polymer blend comprises from 39 to 41 weight percent of the LDPE. In some embodiments, the polymer blend comprises about 40 weight percent of the LDPE.

In some embodiments, the polymer blend comprises from 80 to 55 weight percent of the ethylene copolymer composition. In some embodiments, the polymer blend comprises from 75 to 50 weight percent of the ethylene copolymer composition. In some embodiments, the polymer blend comprises from 75 to 55 weight percent of the ethylene copolymer composition. In some embodiments, the polymer blend comprises from 70 to 50 weight percent of the ethylene copolymer composition. In some embodiments, the polymer blend comprises from 70 to 55 weight percent of the ethylene copolymer composition. In some embodiments, the polymer blend comprises from 65 to 55 weight percent of the ethylene copolymer composition. In some embodiments, the polymer blend comprises from 63 to 57 weight percent of the ethylene copolymer composition. In some embodiments, the polymer blend comprises from 61 to 59 weight percent of the ethylene copolymer composition. In some embodiments, the polymer blend comprises about 60 weight percent of the ethylene copolymer composition.

In some embodiments, the polymer blend comprises from 20 to 45 weight percent of the LDPE and from 80 to 55 weight percent of the ethylene copolymer composition. In some embodiments, the polymer blend comprises from 25 to 45 weight percent of the LDPE and from 75 to 55 weight percent of the ethylene copolymer composition. In some embodiments, the polymer blend comprises from 35 to 45 weight percent of the LDPE and from 65 to 55 weight percent of the ethylene copolymer composition.

In some embodiments, the polymer blend comprises about 40 weight percent of the LDPE and about 60 weight percent of the ethylene copolymer composition.

A third aspect of the invention is a film layer comprising the polymer blend as defined in the first aspect. Hence, the third aspect also provides a film layer comprising the ethylene copolymer composition as defined in the second aspect.

A fourth aspect of the invention is a multilayer film structure comprising the film layer as defined in the third aspect. Hence, the fourth aspect also provides a multilayer film structure comprising the polymer blend as defined in the first aspect. The fourth aspect therefore also provides a multilayer film structure comprising the ethylene copolymer composition as defined in the second aspect.

The multilayer film structure has good tear resistance and impact resistance, high gloss and low haze, allowing for the production of packages with low or no defects and excellent visual appearance. This is particularly beneficial, because high toughness and high abuse resistance (i.e. puncturing, dart impact) are greatly needed performance attributes in collation shrink film applications, which afford downgauge properties. Meanwhile, the clarity (i.e. high gloss and low haze) of the film structure serves shelf appeal and reverse printing. Simultaneously, desirable shrink performance characteristics are also obtained.

The multilayer film structure comprises multiple layers. These layers may be selected from one or more film layer as defined in the third aspect, one or more skin layer, and one or more other types of layer.

In some embodiments, the film structure comprises at least two layers. In some embodiments, the film structure comprises at least three layers. In some embodiments, the film structure comprises at least four layers. In some embodiments, the film structure comprises at least five layers. In some embodiments, the film structure comprises at least six layers.

In some embodiments, the film structure comprises two layers. In some embodiments, the film structure comprises three layers. In some embodiments, the film structure comprises four layers. In some embodiments, the film structure comprises five layers. In some embodiments, the film structure comprises six layers.

The film layer as defined in the third aspect may be a core layer in the multilayer film structure. The core layer may be between, for example sandwiched between, at least two other layers. In some embodiments, the core layer is between, for example sandwiched between, at least two skin layers as defined herein. In some embodiments, the core layer is between, for example sandwiched between, two skin layers as defined herein.

In some embodiments, the multilayer film structure comprises at least one core layer. In some embodiments, the multilayer film structure comprises at least two core layers. In some embodiments, the multilayer film structure comprises at least three core layers. In some embodiments, the multilayer film structure comprises at least four core layers.

In some embodiments, the multilayer film structure comprises one core layer. In some embodiments, the multilayer film structure comprises two core layers. In some embodiments, the multilayer film structure comprises three core layers. In some embodiments, the multilayer film structure comprises four core layers.

In some embodiments, the multilayer film structure comprises at least one skin layer. In some embodiments, the multilayer film structure comprises at least two skin layers. In some embodiments, the multilayer film structure comprises at least three skin layers. In some embodiments, the multilayer film structure comprises at least four skin layers.

In some embodiments, the multilayer film structure comprises one skin layer.

In some embodiments, the multilayer film structure comprises two skin layers. In some embodiments, the multilayer film structure comprises three skin layers. In some embodiments, the multilayer film structure comprises four skin layers.

In some embodiments, where there are two or more skin layers, the skin layers are of approximately equal thickness.

In some embodiments, the multilayer film structure comprises at least one core layer and at least two skin layers. In some embodiments, the multilayer film structure comprises one core layer and two skin layers.

A fifth aspect of the invention is a collation shrink film structure comprising the multilayer film structure as defined in the fourth aspect. Hence, the fifth aspect also provides a collation shrink film structure comprising the film layer as defined in the third aspect. The fifth aspect therefore also provides a collation shrink film structure comprising the polymer blend as defined in the first aspect. The fifth aspect therefore also provides a collation shrink film structure comprising the ethylene copolymer composition as defined in the second aspect.

The invention includes the combination of the aspects and preferred features described except where such a combination is clearly impermissible or expressly avoided.

### BRIEF DESCRIPTION OF THE FIGURES

Embodiments and experiments illustrating the principles of the invention will now be discussed with reference to the accompanying figures in which:

FIG. 1 shows percentage shrinkage in the MD direction of three-layer coextruded film specimens, having a polymer blend of 40 wt % of a low density polyethylene (LDPE) and 60 wt % of an ethylene copolymer composition in the core layer with a density of ethylene copolymer composition of approximately 0.934 g/cm³;

FIG. 2 shows percentage shrinkage in the MD direction of three-layer coextruded film specimens, having a polymer blend of 40 wt % of an LDPE and 60 wt % of an ethylene copolymer composition in the core layer with a density of ethylene copolymer composition of between 0.918 and 0.921 g/cm³;

FIG. 3 shows a schematic representation of the shrink force measurement system;

FIG. 4 shows shrink force measured at different conveyer speeds in the MD direction of three-layer coextruded film specimens, having a polymer blend of 40 wt % of an LDPE and 60 wt % of an ethylene copolymer composition in the core layer with a density of ethylene copolymer composition of approximately 0.934 g/cm³;

FIG. 5 shows shrink force measured at different conveyer speeds in the MD direction of three-layer coextruded film specimens, having a polymer blend of 40 wt % of an LDPE and 60 wt % of an ethylene copolymer composition in the core layer with a density of ethylene copolymer composition of between 0.918 and 0.921 g/cm³;

FIG. 6 (A and B) shows 1% secant modulus and dart impact of three-layer coextruded film specimens;

FIG. 7 (A and B) shows MD tear and TD tear of three-layer coextruded film specimens;

FIG. 8 (A and B) shows optical properties of three-layer coextruded film specimens;

FIG. 9 (A and B) shows representative images of bottle packages, specifically a comparison of bullseye strength that is good (image A) and poor (image B);

FIG. 10 (A and B) shows images of burn holes in representative bottle packages;

FIG. 11 (A and B) shows, for various ethylene copolymer compositions, the nonlinear rheology network parameter (Δ_{int.}) as a function of normalized molecular weight;

FIG. 12 (A and B) shows, for various ethylene copolymer compositions, cosine of phase angle (cos d) as a function of weighted angular frequency; and

FIG. 13 (A, B, C, D, E, F, G, H, and I) shows relaxation time spectra of various ethylene copolymer compositions.

### DESCRIPTION OF EMBODIMENTS

Aspects and embodiments of the present invention will now be discussed with reference to the accompanying figures. Further aspects and embodiments will be apparent to those skilled in the art. All documents mentioned in this text are incorporated herein by reference.

### Definition of Terms

Other than in the examples or where otherwise indicated, all numbers or expressions referring to quantities of ingredients, extrusion conditions, etc., used in the specification and claims are to be understood as modified in all instances by the term “about”. Accordingly, unless indicated to the contrary, the numerical parameters set forth in the following specification and attached claims are approximations that can vary depending upon the desired properties that the various embodiments desire to obtain. At the very least, and not as an attempt to limit the application of the doctrine of equivalents to the scope of the claims, each numerical parameter should at least be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements. It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer.

As used herein, the term “α-olefin” or “alpha-olefin” is used to describe a monomer having a linear hydrocarbon chain containing from 3 to 20 carbon atoms having a double bond at one end of the chain; an equivalent term is “linear α-olefin”. As used herein, the term “polyethylene” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. The term “copolymer” refers to a polymer that contains two or more types of monomer. An “ethylene copolymer” is made using ethylene and one or more other types of polymerizable monomer. Common polyethylenes include high density polyethylene (HDPE), medium density polyethylene (MDPE), linear low density polyethylene (LLDPE), very low density polyethylene (VLDPE), ultralow density polyethylene (ULDPE), plastomer and elastomers. The term polyethylene also includes polyethylene terpolymers which may include two or more comonomers in addition to ethylene. The term polyethylene also includes combinations of, or blends of, the polyethylenes described above.

The term “heterogeneously branched polyethylene” refers to a subset of polymers in the ethylene polymer group that are produced using a heterogeneous catalyst system; non-limiting examples of which include Ziegler-Natta or chromium catalysts, both of which are well known in the art.

The term “homogeneously branched polyethylene” refers to a subset of polymers in the ethylene polymer group that are produced using single-site catalysts; non-limiting examples of which include metallocene catalysts, phosphinimine catalysts, and constrained geometry catalysts all of which are well known in the art.

Typically, homogeneously branched polyethylenes have narrow molecular weight distributions, for example gel permeation chromatography (GPC) M_{w}/Mₙ values of less than about 2.8, especially less than about 2.3, although exceptions may arise; M_{w} and Mₙ refer to weight and number average molecular weights, respectively. In contrast, the M_{w}/Mₙ of heterogeneously branched ethylene polymers are typically greater than the M_{w}/Mₙ of homogeneous polyethylene. In general, homogeneously branched ethylene polymers also have a narrow composition distribution, i.e. each macromolecule within the molecular weight distribution has a similar comonomer content. Frequently, the composition distribution breadth index “CDBI” is used to quantify how the comonomer is distributed within an ethylene polymer, as well as to differentiate ethylene polymers produced with different catalysts or processes. The “CDBI₅₀” is defined as the percent of ethylene polymer whose composition is within 50 weight percent (wt %) of the median comonomer composition; this definition is consistent with that described in WO 93/03093 assigned to Exxon Chemical Patents Inc. The CDBI₅₀ of an ethylene copolymer can be calculated from TREF curves (Temperature Rising Elution Fractionation); the TREF method is described in Wild, et al., J. Polym. Sci., Part B, Polym. Phys., Vol. 20 (3), pages 441-455. Typically the CDBI₅₀ of homogeneously branched ethylene polymers are greater than about 70% or greater than about 75%. In contrast, the CDBI₅₀ of α-olefin-containing heterogeneously branched ethylene polymers are generally lower than the CDBI₅₀ of homogeneous ethylene polymers. For example, the CDBI₅₀ of a heterogeneously branched ethylene polymer may be less than about 75%, or less than about 70%.

It is well known to those skilled in the art, that homogeneously branched ethylene polymers are frequently further subdivided into “linear homogeneous ethylene polymers” and “substantially linear homogeneous ethylene polymers”. These two subgroups differ in the amount of long chain branching: more specifically, linear homogeneous ethylene polymers have less than about 0.01 long chain branches per 1000 carbon atoms; while substantially linear ethylene polymers have greater than about 0.01 to about 3.0 long chain branches per 1000 carbon atoms. A long chain branch is macromolecular in nature, i.e. similar in length to the macromolecule that the long chain branch is attached to. Hereafter, in this disclosure, the term “homogeneously branched polyethylene” or “homogeneously branched ethylene polymer” refers to both linear homogeneous ethylene polymers and substantially linear homogeneous ethylene polymers.

The term “thermoplastic” refers to a polymer that becomes liquid when heated, will flow under pressure and solidify when cooled. Thermoplastic polymers include ethylene polymers as well as other polymers used in the plastic industry; non-limiting examples of other polymers commonly used in film applications include barrier resins (EVOH), tie resins, polyethylene terephthalate (PET), polyamides and the like.

As used herein the term “monolayer film” refers to a film containing a single layer of one or more thermoplastics.

As used herein the term “multilayer film” or “multilayer film structure” refers to a film comprised of more than one thermoplastic layer, or optionally non-thermoplastic layers. Non-limiting examples of non-thermoplastic materials include metals (foil) or cellulosic (paper) products. One or more of the thermoplastic layers within a multilayer film (or film structure) may be comprised of more than one thermoplastic.

As used herein, the term “tie resin” refers to a thermoplastic that when formed into an intermediate layer, or a “tie layer” within a multilayer film structure, promotes adhesion between adjacent film layers that are dissimilar in chemical composition. Thus, a multilayer film structure as described herein may comprise a tie resin.

As used herein, the term “sealant layer” refers to a layer of thermoplastic film that is capable of being attached to a second substrate, forming a leak proof seal. A “sealant layer” may be a skin layer or the innermost layer in a multilayer film structure. Thus, a multilayer film structure as described herein may comprise a sealant layer.

As used herein, the term “adhesive lamination” and the term “extrusion lamination” describes continuous processes through which two or more substrates, or webs of material, are combined to form a multilayer product or sheet; wherein the two or more webs are joined using an adhesive or a molten thermoplastic film, respectively.

As used herein, the term “extrusion coating” describes a continuous process through which a molten thermoplastic layer is combined with, or deposited on, a moving solid web or substrate. Non-limiting examples of substrates include paper, paperboard, foil, monolayer plastic film, multilayer plastic film or fabric. The molten thermoplastic layer could be monolayer or multilayer.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched and cyclic paraffin radicals that are deficient by one hydrogen radical; non-limiting examples include methyl (—CH₃) and ethyl (—CH₂CH₃) radicals. The term “alkenyl radical” refers to linear, branched and cyclic hydrocarbons containing at least one carbon-carbon double bond that is deficient by one hydrogen radical.

As used herein, the term “aryl” group includes phenyl, naphthyl, pyridyl and other radicals whose molecules have an aromatic ring structure; non-limiting examples include naphthylene, phenanthrene and anthracene. An “arylalkyl” group is an alkyl group having an aryl group pendant there from; non-limiting examples include benzyl, phenethyl and tolylmethyl; an “alkylaryl” is an aryl group having one or more alkyl groups pendant there from; non-limiting examples include tolyl, xylyl, mesityl and cumyl.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. In one embodiment, a heteroatom-containing group is a hydrocarbyl group containing from 1 to 3 atoms selected from the group consisting of boron, aluminum, silicon, germanium, nitrogen, phosphorous, oxygen and sulfur. Non-limiting examples of heteroatom-containing groups include radicals of imines, amines, oxides, phosphines, ethers, ketones, oxoazolines heterocyclics, oxazolines, thioethers, and the like. The term “heterocyclic” refers to ring systems having a carbon backbone that comprise from 1 to 3 atoms selected from the group consisting of boron, aluminum, silicon, germanium, nitrogen, phosphorous, oxygen and sulfur.

As used herein the term “unsubstituted” means that hydrogen radicals are bounded to the molecular group that follows the term unsubstituted. The term “substituted” means that the group following this term possesses one or more moieties (non-hydrogen radicals) that have replaced one or more hydrogen radicals in any position within the group; non-limiting examples of moieties include halogen radicals (F, Cl, Br), hydroxyl groups, carbonyl groups, carboxyl groups, silyl groups, amine groups, phosphine groups, alkoxy groups, phenyl groups, naphthyl groups, C₁ to C₃₀ alkyl groups, C₂ to C₃₀ alkenyl groups, and combinations thereof. Non-limiting examples of substituted alkyls and aryls include: acyl radicals, alkyl silyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals and combinations thereof.

In the present disclosure, an ethylene copolymer composition will comprise a first ethylene copolymer having a density, d1; a second ethylene copolymer having a density, d2; and optionally a third ethylene copolymer having a density, d3; wherein the density of the second ethylene copolymer is equal to or greater than the density of the first ethylene copolymer. Each of these ethylene copolymer components and the ethylene copolymer composition of which they are a part are further described below.

### The First Ethylene Copolymer

In an embodiment of the disclosure, the first ethylene copolymer is made with a single site catalyst, non-limiting examples of which include phosphinimine catalysts, metallocene catalysts, and constrained geometry catalysts, all of which are well known in the art.

In an embodiment of the disclosure, the first ethylene copolymer is made with a single site catalyst system comprising a metallocene catalyst.

In an embodiment of the disclosure, the first ethylene copolymer is made with a single site catalyst, having hafnium, Hf, as the active metal center (i.e. the catalyst is a hafnocene catalyst).

In embodiments of the disclosure, alpha-olefins which may be copolymerized with ethylene to make the first ethylene copolymer may be selected from the group comprising 1-propene, 1-butene, 1-pentene, 1-hexene and 1-octene and mixtures thereof.

In an embodiment of the disclosure, the first ethylene copolymer is a homogeneously branched ethylene copolymer.

In an embodiment of the disclosure, the first ethylene copolymer is an ethylene/1-octene copolymer.

In an embodiment of the disclosure, the first ethylene copolymer is made with a metallocene catalyst.

In an embodiment of the disclosure, the first ethylene copolymer is made with a bridged metallocene catalyst.

In an embodiment of the disclosure, the first ethylene copolymer is made with a bridged metallocene catalyst having the Formula (I):

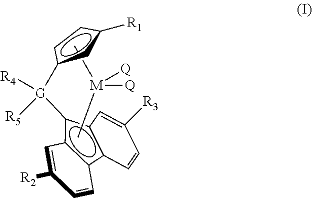

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₅ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R₁ and R₂ are a substituted phenyl group, wherein the phenyl group is substituted at the para position with a trimethylsilyl group. In an embodiment, R₁ and R₂ are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₅ are independently a hydrocarbyl group having from 1 to 30 carbon atoms.

In an embodiment, R₂ and R₃ are independently an aryl group.

In an embodiment, R₂ and R₅ are independently an alkyl group.

In an embodiment, R₂ and R₅ are independently an alkyl group having from 1 to 20 carbon atoms.

In an embodiment, R₂ and R₅ are independently a phenyl group or a substituted phenyl group.

In an embodiment, R₂ and R₃ are a tert-butyl group.

In an embodiment, R₂ and R₅ are hydrogen.

In an embodiment, M is hafnium, Hf.

In an embodiment of the disclosure, the first ethylene copolymer is made with a bridged metallocene catalyst having the Formula (I):

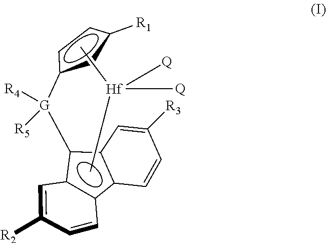

In Formula (I): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g. a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g. 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g. chloride) or a hydrocarbyl (e.g. methyl, benzyl).

In an embodiment of the disclosure, the single site catalyst used to make the first ethylene copolymer is diphenylmethylene (cyclopentadienyl) (2,7-di-t-butylfluorenyl) hafnium dichloride having the molecular formula:

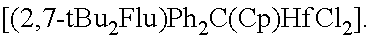

In an embodiment of the disclosure the single site catalyst used to make the first ethylene copolymer is diphenylmethylene (cyclopentadienyl) (2,7-di-t-butylfluorenyl) hafnium dimethyl having the molecular formula:

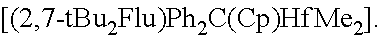

In addition to the single site catalyst molecule per se, an active single site catalyst system may further comprise one or more of the following: an alkylaluminoxane co-catalyst and an ionic activator. The single site catalyst system may also optionally comprise a hindered phenol.

Although the exact structure of alkylaluminoxane is uncertain, subject matter experts generally agree that it is an oligomeric species that contain repeating units of the general formula:

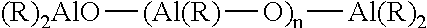

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40.

In an embodiment of the disclosure, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

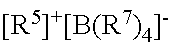

where B represents a boron atom, R⁵ is an aromatic hydrocarbyl (e.g. triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula-Si(R⁹)₃, where each R⁹ is independently selected from hydrogen atoms and C₁₋₄ alkyl radicals, and

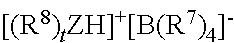

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl) boron with anilinium and trityl (or triphenylmethylium). Additional non-limiting examples of ionic activators include: triethylammonium tetra(phenyl) boron, tripropylammonium tetra(phenyl) boron, tri (n-butyl) ammonium tetra(phenyl) boron, trimethylammonium tetra(p-tolyl) boron, trimethylammonium tetra(o-tolyl) boron, tributylammonium tetra(pentafluorophenyl) boron, tripropylammonium tetra(o,p-dimethylphenyl) boron, tributylammonium tetra(m,m-dimethylphenyl) boron, tributylammonium tetra(p-trifluoromethylphenyl) boron, tributylammonium tetra(pentafluorophenyl) boron, tri (n-butyl) ammonium tetra(o-tolyl) boron, N,N-dimethylanilinium tetra(phenyl) boron, N,N-diethylanilinium tetra(phenyl) boron, N,N-diethylanilinium tetra(phenyl) n-butylboron, N,N-2,4,6-pentamethylanilinium tetra(phenyl) boron, di-(isopropyl) ammonium tetra(pentafluorophenyl) boron, dicyclohexylammonium tetra(phenyl) boron, triphenylphosphonium tetra(phenyl) boron, tri(methylphenyl)phosphonium tetra(phenyl) boron, tri (dimethylphenyl)phosphonium tetra(phenyl) boron, tropillium tetrakispentafluorophenyl borate, triphenylmethylium tetrakispentafluorophenyl borate, benzene (diazonium)tetrakispentafluorophenyl borate, tropillium tetrakis(2,3,5,6-tetrafluorophenyl) borate, triphenylmethylium tetrakis(2,3,5,6-tetrafluorophenyl) borate, benzene (diazonium)tetrakis(3,4,5-trifluorophenyl) borate, tropillium tetrakis(3,4,5-trifluorophenyl) borate, benzene (diazonium)tetrakis(3,4,5-trifluorophenyl) borate, tropillium tetrakis(1,2,2-trifluoroethenyl) borate, triphenylmethylium tetrakis(1,2,2-trifluoroethenyl) borate, benzene (diazonium) tetrakis(1,2,2-trifluoroethenyl) borate, tropillium tetrakis(2,3,4,5-tetrafluorophenyl) borate, triphenylmethylium tetrakis(2,3,4,5-tetrafluorophenyl) borate, and benzene (diazonium) tetrakis (2,3,4,5 tetrafluorophenyl) borate. Readily available commercial ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis(2,6-di-tertiary-butylphenol), 1,3, 5-trimethyl-2,4,6-tris(3,5-di-tert-butyl-4-hydroxybenzyl)benzene and octadecyl-3-(3′,5′-di-tert-butyl-4′-hydroxyphenyl) propionate.

To produce an active single site catalyst system the quantity and mole ratios of the three or four components: the single site catalyst, the alkylaluminoxane, the ionic activator, and the optional hindered phenol are optimized.

In an embodiment of the disclosure, the single site catalyst used to make the first ethylene copolymer produces no long chain branches, and/or the first ethylene copolymer will contain no measurable amounts of long chain branches.

In an embodiment of the disclosure, the single site catalyst used to make the first ethylene copolymer produces long chain branches, and the first ethylene copolymer will contain long chain branches, hereinafter “LCB”. LCB is a well-known structural phenomenon in ethylene copolymers and well known to those of ordinary skill in the art. Traditionally, there are three methods for LCB analysis, namely, nuclear magnetic resonance spectroscopy (NMR), for example see J. C. Randall, J Macromol. Sci., Rev. Macromol. Chem. Phys. 1989, 29, 201; triple detection SEC equipped with a DRI, a viscometer and a low-angle laser light scattering detector, for example see W. W. Yau and D. R. Hill, Int. J. Polym. Anal. Charact. 1996; 2:151; and rheology, for example see W. W. Graessley, Acc. Chem. Res. 1977, 10, 332-339. In this disclosure, a long chain branch is macromolecular in nature, i.e. long enough to be seen in an NMR spectra, triple detector SEC experiments or rheological experiments.

In an embodiment of the disclosure, the first ethylene copolymer contains long chain branching characterized by the LCBF disclosed herein. In embodiments of the disclosure, the upper limit on the LCBF of the first ethylene copolymer may be about 0.5, in other cases about 0.4 and in still other cases about 0.3 (dimensionless). In embodiments of the disclosure, the lower limit on the LCBF of the first ethylene copolymer may be about 0.001, in other cases about 0.0015 and in still other cases about 0.002 (dimensionless).

The first ethylene copolymer may contain catalyst residues that reflect the chemical composition of the catalyst formulation used to make it. Those skilled in the art will understand that catalyst residues are typically quantified by the parts per million of metal, in for example the first ethylene copolymer (or the ethylene copolymer composition; see below), where the metal present originates from the metal in the catalyst formulation used to make it. Non-limiting examples of the metal residue which may be present include Group 4 metals, titanium, zirconium and hafnium. In embodiments of the disclosure, the upper limit on the ppm of metal in the first ethylene copolymer may be about 3.0 ppm, in other cases about 2.0 ppm and in still other cases about 1.5 ppm. In embodiments of the disclosure, the lower limit on the ppm of metal in the first ethylene copolymer may be about 0.03 ppm, in other cases about 0.09 ppm and in still other cases about 0.15 ppm.

In an embodiment of the disclosure, the first ethylene copolymer has a density of from 0.890 to 0.930 g/cm³, a molecular weight distribution (M_{w}/Mₙ) of from 1.7 to 2.3, and a melt index (I₂) of from 0.1 to 20 g/10 min.

In some embodiments of the disclosure, the upper limit of the molecular weight distribution (M_{w}/Mₙ) of the first ethylene copolymer is about 2.3, or about 2.2, or about 2.1, or about 2.0. In some embodiments of the disclosure, the lower limit of the molecular weight distribution (M_{w}/Mₙ) of the first ethylene copolymer is about 1.7, or about 1.8, or about 1.9.

In some embodiments of the disclosure, the first ethylene copolymer has a molecular weight distribution (M_{w}/Mₙ) of ≤2.3, or <2.3, or ≤2.2, or <2.2, or ≤2.1, or <2.1. In some embodiments of the disclosure, the first ethylene copolymer has a molecular weight distribution (M_{w}/Mₙ) of from about 1.7 to about 2.3, or from about 1.8 to about 2.3, or from about 1.8 to about 2.2.

In an embodiment of the disclosure, the first ethylene copolymer has from 1 to 150 short chain branches per thousand carbon atoms (SCB1). In further embodiments, the first ethylene copolymer has from 3 to 100 short chain branches per thousand carbon atoms (SCB1), or from 5 to 100 short chain branches per thousand carbon atoms (SCB1), or from 5 to 75 short chain branches per thousand carbon atoms (SCB1), or from 10 to 75 short chain branches per thousand carbon atoms (SCB1), or from 5 to 50 short chain branches per thousand carbon atoms (SCB1), or from 10 to 50 short chain branches per thousand carbon atoms (SCB1), or from 15 to 75 short chain branches per thousand carbon atoms (SCB1). In still further embodiments, the first ethylene copolymer has from 15 to 50 short chain branches per thousand carbon atoms (SCB1), or from 20 to 75 short chain branches per thousand carbon atoms (SCB1), or from 20 to 50 short chain branches per thousand carbon atoms (SCB1), or from 5 to 40 short chain branches per thousand carbon atoms (SCB1), or from 10 to 40 short chain branches per thousand carbon atoms (SCB1), or from 15 to 40 short chain branches per thousand carbon atoms (SCB1), or from 20 to 35 short chain branches per thousand carbon atoms (SCB1).

The short chain branching (i.e. the short chain branching per thousand backbone carbon atoms, SCB1) is the branching due to the presence of an alpha-olefin comonomer in the ethylene copolymer and will for example have two carbon atoms for a 1-butene comonomer, or four carbon atoms for a 1-hexene comonomer, or six carbon atoms for a 1-octene comonomer, etc.

In an embodiment of the disclosure, the number of short chain branches per thousand carbon atoms in the first ethylene copolymer (SCB1), is greater than the number of short chain branches per thousand carbon atoms in the second ethylene copolymer (SCB2).

In an embodiment of the disclosure, the number of short chain branches per thousand carbon atoms in the first ethylene copolymer (SCB1), is greater than the number of short chain branches per thousand carbon atoms in the third ethylene copolymer (SCB3).

In an embodiment of the disclosure, the number of short chain branches per thousand carbon atoms in the first ethylene copolymer (SCB1), is greater than the number of short chain branches per thousand carbon atoms in each of the second ethylene copolymer (SCB2) and the third ethylene copolymer (SCB3).

In embodiments of the disclosure, the upper limit on the density (d1) of the first ethylene copolymer may be about 0.930 g/cm³, in some cases about 0.927 g/cm³, in other cases about 0.924 g/cm³, in still other cases about 0.921 g/cm³, in yet still other cases about 0.918 g/cm³, or about 0.915 g/cm³, or about 0.912 g/cm³, or about 0.910 g/cm³. In embodiments of the disclosure, the lower limit on the density (d1) of the first ethylene copolymer may be about 0.890 g/cm³, in some cases about 0.895 g/cm³, in some cases about 0.900 g/cm³, and in other cases about 0.905 g/cm³.

In embodiments of the disclosure the density (d1) of the first ethylene copolymer may be from about 0.890 g/cm³ to about 0.930 g/cm³, or from about 0.890 g/cm³ to about 0.927 g/cm³, or from about 0.890 g/cm³ to about 0.924 g/cm³, or from about 0.890 g/cm³ to about 0.921 g/cm³, or from about 0.890 g/cm³ to about 0.918 g/cm³, or from about 0.890 g/cm³ to about 0.915 g/cm³, or from about 0.890 g/cm³ to about 0.912 g/cm³, or from about 0.890 g/cm³ to about 0.910 g/cm³, or from about 0.895 g/cm³ to about 0.930 g/cm³, or from about 0.895 g/cm³ to about 0.927 g/cm³, or from about 0.895 g/cm³ to about 0.924 g/cm³, or from about 0.895 g/cm³ to about 0.921 g/cm³, or from about 0.895 g/cm³ to about 0.918 g/cm³, or from about 0.895 g/cm³ to about 0.915 g/cm³, or from about 0.895 g/cm³ to about 0.912 g/cm³, or from about 0.895 g/cm³ to about 0.910 g/cm³, or from about 0.900 g/cm³ to about 0.930 g/cm³, or from about 0.900 g/cm³ to about 0.927 g/cm³, or from about 0.900 g/cm³ to about 0.924 g/cm³, or from about 0.900 g/cm³ to about 0.921 g/cm³, or from about 0.900 g/cm³ to about 0.918 g/cm³, or from about 0.900 g/cm³ to about 0.915 g/cm³, or from about 0.900 g/cm³ to about 0.912 g/cm³, or from about 0.900 g/cm³ to about 0.910 g/cm³, or from about 0.900 g/cm³ to about 0.930 g/cm³, or from about 0.900 g/cm³ to about 0.927 g/cm³, or from about 0.905 g/cm³ to about 0.924 g/cm³, or from about 0.905 g/cm³ to about 0.921 g/cm³, or from about 0.905 g/cm³ to about 0.918 g/cm³, or from about 0.905 g/cm³ to about 0.915 g/cm³, or from about 0.905 g/cm³ to about 0.912 g/cm³, or from about 0.905 g/cm³ to about 0.910 g/cm³.

In an embodiment of the disclosure, the density of the first ethylene copolymer (d1) is equal to or less than the density of the second ethylene copolymer (d2).

In an embodiment of the disclosure, the density of the first ethylene copolymer, d1 is less than the density of the second ethylene copolymer (d2).

In embodiments of the disclosure, the upper limit on the CDBI₅₀ of the first ethylene copolymer may be about 98 wt %, in other cases about 95 wt % and in still other cases about 90 wt %. In embodiments of the disclosure, the lower limit on the CDBI₅₀ of the first ethylene copolymer may be about 70 weight percent, in other cases about 75 wt % and in still other cases about 80 wt %. In some embodiments, the first ethylene copolymer has a CDBI₅₀ of at least 75 wt %.

In embodiments of the disclosure, the melt index of the first ethylene copolymer (121) may be from about 0.1 g/10 min to about 20 g/10 min, or from about 0.1 g/10 min to about 15 g/10 min, or from about 1 g/10 min to about 20 g/10 min, or from about 1 g/10 min to about 15 g/10 min, or from about 0.1 g/10 min to about 10 g/10 min, or from about 1 g/10 min to about 10 g/10 min, or from about 0.1 g/10 min to about 8 g/10 min, or from about 1 g/10 min to about 8 g/10 min, or from about 0.1 g/10 min to about 5 g/10 min, or from about 1 g/10 min to about 5 g/10 min, or less than about 10 g/10 min, or less than about 8 g/10 min, or less than about 5 g/10 min.

In an embodiment of the disclosure, the first ethylene copolymer has a weight average molecular weight, M_{w} of from about 50,000 to about 300,000, or from about 50,000 to about 250,000, or from about 60,000 to about 250,000, or from about 70,000 to about 250,000, or from about 75,000 to about 200,000, or from about 75,000 to about 175,000; or from about 70,000 to about 175,000, or from about 75,000 to about 150,000.

In an embodiment of the disclosure, the first ethylene copolymer has a weight average molecular weight, M_{w} which is greater than the weight average molecular weight, M_{w} of the second ethylene copolymer.

In some embodiments of the disclosure, the upper limit on the weight percent (wt %) of the first ethylene copolymer in the ethylene copolymer composition (i.e. the weight percent of the first ethylene copolymer based on the total weight of the first, the second and the third ethylene copolymer) is about 50 wt %, or about 47 wt %, or about 44 wt %, or about 41 wt %, or about 38 wt %, or about 35 wt %. In some embodiments of the disclosure, the lower limit on the wt % of the first ethylene copolymer in the ethylene copolymer composition is about 30 wt %, or about 33 wt %, or about 36 wt %, or about 39 wt %, or about 42 wt %, or about 45 wt %.

### The Second Ethylene Copolymer

In an embodiment of the disclosure, the second ethylene copolymer is made with a multi-site catalyst system, non-limiting examples of which include Ziegler-Natta catalysts and chromium catalysts, both of which are well known in the art.

In embodiments of the disclosure, alpha-olefins which may be copolymerized with ethylene to make the second ethylene copolymer may be selected from the group comprising 1-propene, 1-butene, 1-pentene, 1-hexene and 1-octene and mixtures thereof.

In an embodiment of the disclosure, the second ethylene copolymer is a heterogeneously branched ethylene copolymer.

In an embodiment of the disclosure, the second ethylene copolymer is an ethylene/1-octene copolymer.

In an embodiment of the disclosure, the second ethylene copolymer is made with a Ziegler-Natta catalyst system.

Ziegler-Natta catalyst systems are well known to those skilled in the art. A Ziegler-Natta catalyst may be an in-line Ziegler-Natta catalyst system or a batch Ziegler-Natta catalyst system. The term “in-line Ziegler-Natta catalyst system” refers to the continuous synthesis of a small quantity of an active Ziegler-Natta catalyst system and immediately injecting this catalyst into at least one continuously operating reactor, wherein the catalyst polymerizes ethylene and one or more optional α-olefins to form an ethylene polymer. The terms “batch Ziegler-Natta catalyst system” or “batch Ziegler-Natta procatalyst” refer to the synthesis of a much larger quantity of catalyst or procatalyst in one or more mixing vessels that are external to, or isolated from, the continuously operating solution polymerization process. Once prepared, the batch Ziegler-Natta catalyst system, or batch Ziegler-Natta procatalyst, is transferred to a catalyst storage tank. The term “procatalyst” refers to an inactive catalyst system (inactive with respect to ethylene polymerization); the procatalyst is converted into an active catalyst by adding an alkyl aluminum co-catalyst. As needed, the procatalyst is pumped from the storage tank to at least one continuously operating reactor, wherein an active catalyst polymerizes ethylene and one or more optional α-olefins to form an ethylene copolymer. The procatalyst may be converted into an active catalyst in the reactor or external to the reactor, or on route to the reactor.

A wide variety of compounds can be used to synthesize an active Ziegler-Natta catalyst system. The following describes various compounds that may be combined to produce an active Ziegler-Natta catalyst system. Those skilled in the art will understand that the embodiments in this disclosure are not limited to the specific compounds disclosed.

An active Ziegler-Natta catalyst system may be formed from: a magnesium compound, a chloride compound, a metal compound, an alkyl aluminum co-catalyst and an aluminum alkyl. As will be appreciated by those skilled in the art, Ziegler-Natta catalyst systems may contain additional components; a non-limiting example of an additional component is an electron donor, e.g. amines or ethers.

A non-limiting example of an active in-line (or batch) Ziegler-Natta catalyst system can be prepared as follows. In the first step, a solution of a magnesium compound is reacted with a solution of a chloride compound to form a magnesium chloride support suspended in solution. Non-limiting examples of magnesium compounds include Mg(R₁) 2; wherein the R₁ groups may be the same or different, linear, branched or cyclic hydrocarbyl radicals containing 1 to 10 carbon atoms. Non-limiting examples of chloride compounds include R₂Cl; wherein R₂ represents a hydrogen atom, or a linear, branched or cyclic hydrocarbyl radical containing 1 to 10 carbon atoms. In the first step, the solution of magnesium compound may also contain an aluminum alkyl. Non-limiting examples of aluminum alkyl include Al(R³)₃, wherein the R₃ groups may be the same or different, linear, branched or cyclic hydrocarbyl radicals containing from 1 to 10 carbon atoms. In the second step a solution of the metal compound is added to the solution of magnesium chloride and the metal compound is supported on the magnesium chloride. Non-limiting examples of suitable metal compounds include M (X) n or MO (X) n; where M represents a metal selected from Group 4 through Group 8 of the Periodic Table, or mixtures of metals selected from Group 4 through Group 8; O represents oxygen; and X represents chloride or bromide; n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In the third step a solution of an alkyl aluminum co-catalyst is added to the metal compound supported on the magnesium chloride. A wide variety of alkyl aluminum co-catalysts are suitable, as expressed by formula:

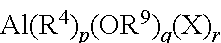

wherein the R⁴ groups may be the same or different, hydrocarbyl groups having from 1 to 10 carbon atoms; the OR⁹ groups may be the same or different, alkoxy or aryloxy groups wherein R₉ is a hydrocarbyl group having from 1 to 10 carbon atoms bonded to oxygen; X is chloride or bromide; and (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active in-line (or batch) Ziegler-Natta catalyst system, can be carried out in a variety of solvents; non-limiting examples of solvents include linear or branched C₅ to C₁₂ alkanes or mixtures thereof.

In an embodiment of the disclosure, the second ethylene copolymer has a density of from 0.925 to 0.945 g/cm³; a molecular weight distribution (M_{w}/Mₙ) of from 2.3 to 6.0, and a melt index (I₂) of from 0.3 to 100 g/10 min.

In some embodiments of the disclosure, the second ethylene copolymer has a molecular weight distribution (M_{w}/Mₙ) of ≥2.3, or >2.3, or ≥2.5, or >2.5, or ≥2.7, or >2.7, or ≥2.9, or >2.9, or ≥3.0, or about 3.0. In some embodiments of the disclosure, the second ethylene copolymer has a molecular weight distribution (M_{w}/Mₙ) of from 2.3 to 6.0, or from 2.3 to 5.5, or from 2.3 to 5.0, or from 2.3 to 4.5, or from 2.3 to 4.0, or from 2.3 to 3.5, or from 2.3 to 3.0, or from 2.5 to 6.0, or from 2.5 to 5.0, or from 2.5 to 4.5, or from 2.5 to 4.0, or from 2.5 to 3.5, or from 2.7 to 5.0, or from 2.7 to 4.5, or from 2.7 to 4.0, or from 2.7 to 3.5, or from 2.9 to 5.0, or from 2.9 to 4.5, or from 2.9 to 4.0, or from 2.9 to 3.5.

In an embodiment of the disclosure, the second ethylene copolymer has from 1 to 100 short chain branches per thousand carbon atoms (SCB2). In further embodiments, the second ethylene copolymer has from 1 to 50 short chain branches per thousand carbon atoms (SCB2), or from 1 to 30 short chain branches per thousand carbon atoms (SCB2), or from 1 to 25 short chain branches per thousand carbon atoms (SCB2), or from 3 to 50 short chain branches per thousand carbon atoms (SCB2), or from 5 to 50 short chain branches per thousand carbon atoms (SCB2), or from 3 to 30 short chain branches per thousand carbon atoms (SCB2), or from 5 to 30 short chain branches per thousand carbon atoms (SCB2), or from 3 to 25 short chain branches per thousand carbon atoms (SCB2), or from 5 to 25 short chain branches per thousand carbon atoms (SCB2).

The short chain branching (i.e. the short chain branching per thousand backbone carbon atoms, SCB2), is the branching due to the presence of alpha-olefin comonomer in the ethylene copolymer and will for example have two carbon atoms for a 1-butene comonomer, or four carbon atoms for a 1-hexene comonomer, or six carbon atoms for a 1-octene comonomer, etc.

In some embodiments of the disclosure, the upper limit on the density (d2) of the second ethylene copolymer is about 0.945 g/cm³, in some cases about 0.941 g/cm³, in some cases about 0.936 g/cm³, and in other cases about 0.932 g/cm³. In some embodiments of the disclosure, the lower limit on the density (d2) of the second ethylene copolymer is about 0.925 g/cm³, in some cases about 0.928 g/cm³, in some cases about 0.931 g/cm³, and in other cases about 0.934 g/cm³.

In embodiments of the disclosure the density (d2) of the second ethylene copolymer may be from about 0.925 g/cm³ to about 0.945 g/cm³, or from about 0.925 g/cm³ to about 0.941 g/cm³, or from about 0.925 g/cm³ to about 0.936 g/cm³, or from about 0.925 g/cm³ to about 0.932 g/cm³, or from about 0.928 g/cm³ to about 0.945 g/cm³, or from about 0.928 g/cm³ to about 0.941 g/cm³, or from about 0.928 g/cm³ to about 0.936 g/cm³, or from about 0.928 g/cm³ to about 0.932 g/cm³, or from about 0.931 g/cm³ to about 0.945 g/cm³, or from about 0.931 g/cm³ to about 0.941 g/cm³, or from about 0.931 g/cm³ to about 0.936 g/cm³, or from about 0.931 g/cm³ to about 0.932 g/cm³, or from about 0.934 g/cm³ to about 0.945 g/cm³, or from about 0.934 g/cm³ to about 0.941 g/cm³, or from about 0.934 g/cm³ to about 0.936 g/cm³.

In an embodiment of the disclosure, the density of the second ethylene copolymer (d2) is equal to or greater than the density of the first ethylene copolymer (d1).

In an embodiment of the disclosure, the density of the second ethylene copolymer (d2) is greater than the density of the first ethylene copolymer (d1).

In an embodiment of the disclosure, the second ethylene copolymer has a composition distribution breadth index, CDBI₅₀ of less than 75 wt % or 70 wt % or less. In further embodiments of the disclosure, the second ethylene copolymer has a CDBI₅₀ of 65 wt % or less, or 60 wt % or less, or 55 wt % or less, or 50 wt % or less, or 45 wt % or less.

In embodiments of the disclosure, the melt index of the second ethylene copolymer (122) may be from about 0.3 g/10 min to about 100 g/10 min, or from about 0.3 g/10 min to about 50 g/10 min, or from about 0.3 g/10 min to about 25 g/10 min, or from about 1 g/10 min to about 100 g/10 min, or from about 1 g/10 min to about 50 g/10 min, or from about 1 g/10 min to about 25 g/10 min, or from about 5 g/10 min to about 100 g/10 min, or from about 5 g/10 min to about 50 g/10 min, or from about 5 g/10 min to about 25 g/10 min, or from about 10 g/10 min to about 100 g/10 min, or from about 10 g/10 min to about 50 g/10 min, or from about 10 g/10 min to about 25 g/10 min.

In an embodiment of the disclosure, the second ethylene copolymer has a weight average molecular weight, M_{w} of from about 25,000 to about 250,000, or from about 25,000 to about 200,000, or from about 30,000 to about 150,000, or from about 40,000 to about 150,000, or from about 50,000 to about 130,000, or from about 50,000 to about 110,000.

In an embodiment of the disclosure, the weight average molecular weight of the second ethylene copolymer is less than the weight average molecular weight of the first ethylene copolymer.

In some embodiments of the disclosure, the upper limit on the weight percent (wt %) of the second ethylene copolymer in the ethylene copolymer composition (i.e. the weight percent of the second ethylene copolymer based on the total weight of the first, the second and the third ethylene copolymers) is about 70 wt %, or about 67 wt %, or about 64 wt %, or about 61 wt %, or about 58 wt %, or about 55 wt %. In some embodiments of the disclosure, the lower limit on the wt % of the second ethylene copolymer in the ethylene copolymer composition is about 50 wt %, or about 53 wt %, or about 56 wt %, or about 59 wt %, or about 62 wt %, or about 65 wt %.

In some embodiments of the disclosure, the second ethylene copolymer has no long chain branching present or does not have any detectable levels of long chain branching.

### The Third Ethylene Copolymer

In an embodiment of the disclosure, the third ethylene copolymer is made with a single site catalyst, non-limiting examples of which include phosphinimine catalysts, metallocene catalysts, and constrained geometry catalysts, all of which are well known in the art.

In an embodiment of the disclosure, the third ethylene copolymer is made with a multi-site catalyst system, non-limiting examples of which include Ziegler-Natta catalysts and chromium catalysts, both of which are well known in the art.

In embodiments of the disclosure, alpha-olefins which may be copolymerized with ethylene to make the third ethylene copolymer may be selected from the group comprising 1-propene, 1-butene, 1-pentene, 1-hexene and 1-octene and mixtures thereof.

In an embodiment of the disclosure, the third ethylene copolymer is a homogeneously branched ethylene copolymer.

In an embodiment of the disclosure, the third ethylene copolymer is an ethylene/1-octene copolymer.

In an embodiment of the disclosure, the third ethylene copolymer is made with a metallocene catalyst.

In an embodiment of the disclosure, the third ethylene copolymer is made with a Ziegler-Natta catalyst.

In an embodiment of the disclosure, the third ethylene copolymer is a heterogeneously branched ethylene copolymer.

In embodiments of the disclosure, the third ethylene copolymer has no long chain branching present or does not have any detectable levels of long chain branching.

In some embodiments, the third ethylene copolymer has a molecular weight distribution (M_{w}/Mₙ) of at least 2.0. In some embodiments, the third ethylene copolymer has a molecular weight distribution (M_{w}/Mₙ) of at most 6.0. In some embodiments, the third ethylene copolymer has a molecular weight distribution (M_{w}/Mₙ) of from 2.0 to 6.0.

In some embodiments, the third ethylene copolymer has a molecular weight distribution (M_{w}/Mₙ) of ≥2.3, or >2.3, or ≥2.5, or >2.5, or ≥2.7, or >2.7, or ≥2.9, or >2.9, or ≥3.0, or about 3.0. In some embodiments, the third ethylene copolymer has a molecular weight distribution (M_{w}/Mₙ) of from 2.3 to 6.0, or from 2.3 to 5.5, or from 2.3 to 5.0, or from 2.3 to 4.5, or from 2.3 to 4.0, or from 2.3 to 3.5, or from 2.3 to 3.0, or from 2.5 to 6.0, or from 2.5 to 5.0, or from 2.5 to 4.5, or from 2.5 to 4.0, or from 2.5 to 3.5, or from 2.7 to 5.0, or from 2.7 to 4.5, or from 2.7 to 4.0, or from 2.7 to 3.5, or from 2.9 to 5.0, or from 2.9 to 4.5, or from 2.9 to 4.0, or from 2.9 to 3.5.

In some embodiments of the disclosure, the upper limit on the density (d3) of the third ethylene copolymer is about 0.955 g/cm³, in some cases about 0.950 g/cm³, in some cases about 0.945 g/cm³, in some cases about 0.941 g/cm³, in some cases about 0.936 g/cm³, and in other cases about 0.932 g/cm³. In some embodiments of the disclosure, the lower limit on the density (d3) of the third ethylene copolymer is about 0.915 g/cm³, in some cases about 0.920 g/cm³, in some cases about 0.925 g/cm³, in some cases about 0.928 g/cm³, in some cases about 0.931 g/cm³, and in other cases about 0.934 g/cm³.

In embodiments of the disclosure the density (d3) of the third ethylene copolymer may be from about 0.915 g/cm³ to about 0.955 g/cm³, or from about 0.915 g/cm³ to about 0.950 g/cm³, or from about 0.915 g/cm³ to about 0.945 g/cm³, or from about 0.915 g/cm³ to about 0.941 g/cm³, or from about 0.915 g/cm³ to about 0.936 g/cm³, or from about 0.915 g/cm³ to about 0.932 g/cm³, or from about 0.920 g/cm³ to about 0.955 g/cm³, or from about 0.920 g/cm³ to about 0.950 g/cm³, or from about 0.920 g/cm³ to about 0.945 g/cm³, or from about 0.920 g/cm³ to about 0.941 g/cm³, or from about 0.920 g/cm³ to about 0.936 g/cm³, or from about 0.920 g/cm³ to about 0.932 g/cm³, or from about 0.925 g/cm³ to about 0.955 g/cm³, or from about 0.925 g/cm³ to about 0.950 g/cm³, or from about 0.925 g/cm³ to about 0.945 g/cm³, or from about 0.925 g/cm³ to about 0.941 g/cm³, or from about 0.931 g/cm³ to about 0.936 g/cm³, or from about 0.931 g/cm³ to about 0.932 g/cm³, or from about 0.931 g/cm³ to about 0.955 g/cm³, or from about 0.931 g/cm³ to about 0.950 g/cm³, or from about 0.931 g/cm³ to about 0.945 g/cm³, or from about 0.931 g/cm³ to about 0.941 g/cm³, or from about 0.931 g/cm³ to about 0.936 g/cm³, or from about 0.931 g/cm³ to about 0.932 g/cm³, or from about 0.934 g/cm³ to about 0.955 g/cm³, or from about 0.934 g/cm³ to about 0.950 g/cm³, or from about 0.934 g/cm³ to about 0.945 g/cm³, or from about 0.934 g/cm³ to about 0.941 g/cm³, or from about 0.934 g/cm³ to about 0.936 g/cm³.

In some embodiments, the third ethylene copolymer has a density of at least 0.915 g/cm³. In some embodiments, the third ethylene copolymer has a density of at most 0.955 g/cm³. In some embodiments, the third ethylene copolymer has a density of from 0.915 to 0.955 g/cm³.

In some embodiments, the third ethylene copolymer has a composition distribution breadth index (CDBI₅₀) of less than 75 wt % or 70 wt % or less. In further embodiments, the third ethylene copolymer has a CDBI₅₀ of 65 wt % or less, or 60 wt % or less, or 55 wt % or less, or 50 wt % or less, or 45 wt % or less.

In some embodiments, the melt index of the third ethylene copolymer (I₂³) is at least 0.3 g/10 min. In some embodiments, the melt index of the third ethylene copolymer (I₂³) is at most 100 g/10 min or at most 50 g/10 min. In some embodiments, the melt index of the third ethylene copolymer (I₂³) is from 0.3 to 100 g/10 min or from 0.3 to 50 g/10 min.

In some embodiments, the melt index of the third ethylene copolymer (I₂³) is from about 0.3 g/10 min to about 50 g/10 min, or from about 0.3 g/10 min to about 25 g/10 min, or from about 1 g/10 min to about 50 g/10 min, or from about 1 g/10 min to about 25 g/10 min, or from about 5 g/10 min to about 50 g/10 min, or from about 5 g/10 min to about 25 g/10 min, or from about 10 g/10 min to about 50 g/10 min, or from about 10 g/10 min to about 25 g/10 min.

In some embodiments, the third ethylene copolymer has a weight average molecular weight (M_{w}) of from about 25,000 to about 250,000, or from about 25,000 to about 200,000, or from about 30,000 to about 150,000, or from about 40,000 to about 150,000, or from about 50,000 to about 130,000, or from about 50,000 to about 110,000.

In some embodiments, the third ethylene copolymer has a density of from 0.915 to 0.955 g/cm³ and a M_{w}/Mₙ of from 2.0 to 6.0. In some embodiments, the third ethylene copolymer has a density of from 0.915 to 0.955 g/cm³ and a melt index (I₂) of from 0.3 to 100 g/10 min or from 0.3 to 50 g/10 min. In some embodiments, the third ethylene copolymer has a M_{w}/Mₙ of from 2.0 to 6.0 and a melt index (I₂) of from 0.3 to 100 g/10 min or from 0.3 to 50 g/10 min. In some embodiments, the third ethylene copolymer has a density of from 0.915 to 0.955 g/cm³, a molecular weight distribution (M_{w}/Mₙ) of from 2.0 to 6.0, and a melt index (I₂) of from 0.3 to 100 g/10 min or from 0.3 to 50 g/10 min.

In some embodiments of the disclosure, the upper limit on the weight percent (wt %) of the third ethylene copolymer in the ethylene copolymer composition (i.e. the weight percent of the third ethylene copolymer based on the total weight of the first, the second and the third ethylene copolymer) is about 20 wt %, or about 17 wt %, or about 14 wt %, or about 11 wt %, or about 8 wt %, or about 5 wt %. In some embodiments of the disclosure, the lower limit on the wt % of the third ethylene copolymer in the final ethylene copolymer composition is 0 wt %, or about 1 wt %, or about 3 wt %, or about 5 wt %, or about 10 wt %, or about 15 wt %.

### The Ethylene Copolymer Composition

The polyethylene compositions disclosed herein can be made using any well-known techniques in the art, including but not limited to melt blending, solution blending, or in-reactor blending to bring together a first ethylene copolymer, a second ethylene copolymer and optionally a third ethylene copolymer.

In an embodiment, the ethylene copolymer composition of the present disclosure is made using a single site catalyst in a first reactor to give a first ethylene copolymer, and a multi-site catalyst is used in a second reactor to give a second ethylene copolymer.

In an embodiment, the ethylene copolymer composition of the present disclosure is made using a single site catalyst in a first reactor to give a first ethylene copolymer, a multi-site catalyst is used in a second reactor to give a second ethylene copolymer, and a multi-site catalyst is used in a third reactor to give a third ethylene copolymer.

In an embodiment, the ethylene copolymer composition of the present disclosure is made using a single site catalyst in a first reactor to give a first ethylene copolymer, a multi-site catalyst is used in a second reactor to give a second ethylene copolymer, and a single site catalyst is used in a third reactor to give a third ethylene copolymer.

In an embodiment, the ethylene copolymer composition of the present disclosure is made by forming a first ethylene copolymer in a first reactor by polymerizing ethylene and an alpha-olefin with a single site catalyst; and forming a second ethylene copolymer in a second reactor by polymerizing ethylene and an alpha-olefin with a multi-site catalyst.

In an embodiment, the ethylene copolymer composition of the present disclosure is made by forming a first ethylene copolymer in a first reactor by polymerizing ethylene and an alpha-olefin with a single site catalyst; forming a second ethylene copolymer in a second reactor by polymerizing ethylene and an alpha-olefin with a multi-site catalyst, and forming a third ethylene copolymer in a third reactor by polymerizing ethylene and an alpha olefin with a multi-site catalyst.

In an embodiment, the ethylene copolymer composition of the present disclosure is made by forming a first ethylene copolymer in a first reactor by polymerizing ethylene and an alpha olefin with a single site catalyst; forming a second ethylene copolymer in a second reactor by polymerizing ethylene and an alpha olefin with a multi-site catalyst, and forming a third ethylene copolymer in a third reactor by polymerizing ethylene and an alpha olefin with a single site catalyst.

In an embodiment, the ethylene copolymer composition of the present disclosure is made by forming a first ethylene copolymer in a first solution phase polymerization reactor by polymerizing ethylene and an alpha olefin with a single site catalyst; and forming a second ethylene copolymer in a second solution phase polymerization reactor by polymerizing ethylene and an alpha olefin with a multi-site catalyst.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst.

In an embodiment, the ethylene copolymer composition of the present disclosure is made by forming a first ethylene copolymer in a first solution phase polymerization reactor by polymerizing ethylene and an alpha olefin with a single site catalyst; and forming a second ethylene copolymer in a second solution phase polymerization reactor by polymerizing ethylene and an alpha olefin with a multi-site catalyst, where the first and second solution phase polymerization reactors are configured in series with one another.

In an embodiment, the ethylene copolymer composition of the present disclosure is made by forming a first ethylene copolymer in a first solution phase polymerization reactor by polymerizing ethylene and an alpha olefin with a single site catalyst; and forming a second ethylene copolymer in a second solution phase polymerization reactor by polymerizing ethylene and an alpha olefin with a multi-site catalyst, where the first and second solution phase polymerization reactors are configured in parallel with one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where the first and second solution phase polymerization reactors are configured in series with one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where at least the first and second solution phase polymerization reactors are configured in series with one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where the first, second and third solution phase polymerization reactors are configured in series with one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where each of the first, second and third solution phase polymerization reactors are configured in parallel to one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where the first and second solution phase reactors are configured in series to one another, and the third solution phase reactor is configured in parallel to the first and second reactors.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where at least the first and second solution phase polymerization reactors are configured in series with one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where the first, second and third solution phase polymerization reactors are configured in series with one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where each of the first, second and third solution phase polymerization reactors are configured in parallel to one another.

In an embodiment, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where the first and second solution phase reactors are configured in series to one another, and the third solution phase reactor is configured in parallel to the first and second reactors.

In an embodiment, the solution phase polymerization reactor used as a first solution phase reactor, a second solution phase reactor, or a third solution phase reactor is a continuously stirred tank reactor or a tubular reactor.

In an embodiment, the solution phase polymerization reactor used as a first solution phase reactor, a second solution phase reactor, or a third solution phase reactor is a continuously stirred tank reactor.

In an embodiment, the solution phase polymerization reactor used as a first solution phase reactor, a second solution phase reactor, or a third solution phase reactor is a tubular reactor.

In an embodiment, the solution phase polymerization reactor used as a first solution phase reactor and a second solution phase reactor is a continuously stirred tank reactor, and the solution phase polymerization reactor used as a third solution phase reactor is a tubular reactor.

In solution polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g. methyl pentane, cyclohexane, hexane or toluene) is preferably treated in a similar manner.

The feedstock may be heated or cooled prior to feeding to the reactor.

Generally, the catalyst components may be premixed in the solvent for the reaction or fed as separate streams to the reactor. In some instances, premixing it may be desirable to provide a reaction time for the catalyst components prior to entering the reaction. Such an “in line mixing” technique is described in a number of patents in the name of DuPont Canada Inc. (e.g. U.S. Pat. No. 5,589,555 issued Dec. 31, 1996).

Solution polymerization processes for the polymerization or copolymerization of ethylene are well known in the art (see for example U.S. Pat. Nos. 6,372,864 and 6,777,509). These processes are conducted in the presence of an inert hydrocarbon solvent. In a solution phase polymerization reactor, a variety of solvents may be used as the process solvent; non-limiting examples include linear, branched or cyclic C₅ to C₁₂ alkanes. Non-limiting examples of α-olefins include 1-propene, 1-butene, 1-pentene, 1-hexene and 1-octene. Suitable catalyst component solvents include aliphatic and aromatic hydrocarbons. Non-limiting examples of aliphatic catalyst component solvents include linear, branched or cyclic C₅₋₁₂ aliphatic hydrocarbons, e.g. pentane, methyl pentane, hexane, heptane, octane, cyclohexane, cyclopentane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

The polymerization temperature in a conventional solution process may be from about 80° C. to about 300° C. In an embodiment of the disclosure the polymerization temperature in a solution process is from about 120° C. to about 250° C. The polymerization pressure in a solution process may be a “medium pressure process”, meaning that the pressure in the reactor is less than about 6,000 psi (about 42,000 kiloPascals or kPa). In an embodiment of the disclosure, the polymerization pressure in a solution process may be from about 10,000 to about 40,000 kPa, or from about 14,000 to about 22,000 kPa (i.e. from about 2,000 psi to about 3,000 psi).

Suitable monomers for copolymerization with ethylene include C₃₋₂₀ mono- and di-olefins. Preferred comonomers include C₃₋₁₂ alpha olefins which are unsubstituted or substituted by up to two C₁₋₆ alkyl radicals, C₈₋₁₂ vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g. 5-methylene-2-norbornene and 5-ethylidene-2-norbornene, bicyclo-(2,2,1)-hepta-2,5-diene).

In an embodiment of the disclosure, the ethylene copolymer composition has at least 1 mole percent of one or more than one alpha-olefin.

In an embodiment of the disclosure, the ethylene copolymer composition has at least 3 mole percent of one or more than one alpha-olefin.

In an embodiment of the disclosure, the ethylene copolymer composition has from about 1 to about 10 mole percent of one or more than one alpha-olefin.

In an embodiment of the disclosure, the ethylene copolymer composition has from about 3 to about 10 mole percent of one or more than one alpha-olefin.

In an embodiment of the disclosure, the ethylene copolymer composition has from about 3 to about 8 mole percent of one or more than one alpha-olefin.

In an embodiment of the disclosure, the ethylene copolymer composition comprises ethylene and one or more than one alpha-olefin selected from the group comprising 1-butene, 1-hexene, 1-octene and mixtures thereof.

In an embodiment of the disclosure, the ethylene copolymer composition comprises ethylene and one or more than one alpha-olefin selected from the group comprising 1-hexene, 1-octene and mixtures thereof.

In an embodiment of the disclosure, the ethylene copolymer composition comprises ethylene and 1-octene.

In an embodiment of the disclosure, the ethylene copolymer composition comprises ethylene and at least 1 mole percent 1-octene.

In an embodiment of the disclosure, the ethylene copolymer composition comprises ethylene and from 1 to 10 mole percent of 1-octene.

In an embodiment of the disclosure, the ethylene copolymer composition comprises ethylene and from 3 to 8 mole percent of 1-octene.

In some embodiments of the disclosure, the ethylene copolymer composition has a density which is from about 0.916 g/cm³ to about 0.940 g/cm³, or from about 0.917 g/cm³ to about 0.936 g/cm³. In some preferred embodiments, the ethylene copolymer composition has a density of from 0.917 to 0.922 g/cm³, preferably from 0.918 to 0.921 g/cm³. In alternative preferred embodiments, the ethylene copolymer composition has a density of from 0.932 to 0.936 g/cm³, preferably from 0.933 to 0.935 g/cm³, more preferably about 0.934 g/cm³.

In some embodiments of the disclosure, the melt index (I₂) of the ethylene copolymer composition is from about 0.1 g/10 min to about 1 g/10 min, or from about 0.3 g/10 min to about 1 g/10 min, or from about 0.5 g/10 min to about 1 g/10 min, or from about 0.7 g/10 min to about 1 g/10 min, or from about 0.1 g/10 min to about 0.8 g/10 min, or from about 0.3 g/10 min to about 0.8 g/10 min, or from about 0.5 g/10 min to about 0.8 g/10 min, or from 0.7 g/10 min to about 0.8 g/10 min, or from about 0.1 g/10 min to about 0.6 g/10 min, or from about 0.3 g/10 min to about 0.6 g/10 min, or from about 0.5 g/10 min to about 0.6 g/10 min, or from about 0.1 g/10 min to about 0.4 g/10 min, or from about 0.3 g/10 min to about 0.4 g/10 min, or from about 0.1 g/10 min to about 0.2 g/10 min, or less than about 1 g/10 min, or less than about 0.8 g/10 min, or less than about 0.6 g/10 min, or less than about 0.4 g/10 min, or less than about 0.2 g/10 min.

In some embodiments, the high load melt index (I₂₁) of the ethylene copolymer composition is from about 10 g/10 min to about 10,000 g/10 min, or from about 10 g/10 min to about 1000 g/10 min, or from about 10 g/10 min to about 500 g/10 min, or from about 10 g/10 min to about 250 g/10 min, or from about 10 g/10 min to about 150 g/10 min, or from about 10 g/10 min to about 100 g/10 min, or from about 10 g/10 min to about 50 g/10 min.

In some embodiments, the melt flow ratio (121/12) of the ethylene copolymer composition is from about 15 to about 1,000, or from about 15 to about 100, or from about 15 to about 75, or from about 15 to about 50, or from about 15 to about 40, or from about 18 to about 50, or from about 20 to about 75, or from about 20 to about 50, or from about 20 to about 45, or from about 20 to about 40, or from about 20 to about 38, or from about 20 to about 35, or from about 24 to about 48, or from about 27 to about 45, or from about 30 to about 42. In some embodiments, the melt flow ratio (121/12) of the ethylene copolymer composition is from 20 to 50.

In some embodiments, the melt flow ratio (121/2) of the ethylene copolymer composition is less than about 45, or less than about 40, or less than about 35, or less than about 30.

In some embodiments, the ethylene copolymer composition has a weight average molecular weight (M_{w}) of from about 40,000 to about 300,000, or from about 40,000 to about 250,000, or from about 50,000 to about 250,000, or from about 50,000 to about 225,000, or from about 50,000 to about 200,000, or from about 50,000 to about 175,000, or from about 50,000 to about 150,000, or from about 50,000 to about 125,000.

In embodiments of the disclosure, the ethylene copolymer composition has a lower limit molecular weight distribution (M_{w}/Mₙ) of 2.3, or 2.4, or 2.5, or 2.6. In embodiments of the disclosure, the ethylene copolymer composition has an upper limit molecular weight distribution (M_{w}/Mₙ) of 6.0, or 5.5, or 5.0, or 4.5, or 4.0, or 3.75, or 3.5.

In embodiments of the disclosure, the ethylene copolymer composition has a molecular weight distribution (M_{w}/Mₙ) of from 2.3 to 6.0, or from 2.3 to 5.5, or from 2.3 to 5.0, or from 2.3 to 4.5, or from 2.3 to 4.0, or from 2.3 to 3.75, or from 2.3 to 3.5, or from 2.4 to 5.5, or from 2.4 to 5.0, or from 2.4 to 4.5, or from 2.4 to 4.0, or from 2.4 to 3.75, or from 2.4 to 3.5, or from 2.5 to 5.5, or from 2.5 to 5.0, or from 2.5 to 4.5, or from 2.5 to 4.0, or from 2.5 to 3.75, or from 2.5 to 3.5, or from 2.6 to 3.3. In some embodiments, the ethylene copolymer composition has a molecular weight distribution (M_{w}/Mₙ) of from 2.3 to 5.0.

In embodiments of the disclosure, the ethylene copolymer composition has a Z-average molecular weight distribution, M_{z}/M_{w} of ≤4.0, or <4.0, or ≤3.5, or <3.5, or ≤3.0, or <3.0, or ≤2.75, or <2.75, or ≤2.50, or <2.50. In embodiments of the disclosure, the polyethylene composition has a Z-average molecular weight distribution, M_{z}/M_{w} of from 1.5 to 4.0, or from 1.5 to 3.5, or from 1.75 to 3.5, or from 1.75 to 3.0, or from 1.75 to 2.5, or from 2.0 to 4.0, or from 2.0 to 3.5, or from 2.0 to 3.0, or from 2.0 to 2.75.

In an embodiment of the disclosure, the ethylene copolymer composition has a unimodal profile in a gel permeation chromatograph generated according to the method of ASTM D6474-99. The term “unimodal” is herein defined to mean there will be only one significant peak or maximum evident in the GPC-curve. A unimodal profile includes a broad unimodal profile. In contrast, the use of the term “bimodal” is meant to convey that in addition to a first peak, there will be a secondary peak or shoulder which represents a higher or lower molecular weight component (i.e. the molecular weight distribution, can be said to have two maxima in a molecular weight distribution curve). Alternatively, the term “bimodal” connotes the presence of two maxima in a molecular weight distribution curve generated according to the method of ASTM D6474-99. The term “multi-modal” denotes the presence of two or more, typically more than two, maxima in a molecular weight distribution curve generated according to the method of ASTM D6474-99.

In an embodiment of the disclosure, the ethylene copolymer composition will have a reverse or partially reverse comonomer distribution profile as measured using GPC-FTIR. If the comonomer incorporation decreases with molecular weight, as measured using GPC-FTIR, the distribution is described as “normal”. If the comonomer incorporation is approximately constant with molecular weight, as measured using GPC-FTIR, the comonomer distribution is described as “flat” or “uniform”. The terms “reverse comonomer distribution” and “partially reverse comonomer distribution” mean that in the GPC-FTIR data obtained for a copolymer, there is one or more higher molecular weight components having a higher comonomer incorporation than in one or more lower molecular weight components. The term “reverse (d) comonomer distribution” is used herein to mean, that across the molecular weight range of an ethylene copolymer, comonomer contents for the various polymer fractions are not substantially uniform and the higher molecular weight fractions thereof have proportionally higher comonomer contents (i.e. if the comonomer incorporation rises with molecular weight, the distribution is described as “reverse” or “reversed”). Where the comonomer incorporation rises with increasing molecular weight and then declines, the comonomer distribution is still considered “reverse”, but may also be described as “partially reverse”. A partially reverse comonomer distribution will exhibit a peak or maximum.

In an embodiment of the disclosure the ethylene copolymer composition has a reversed comonomer distribution profile as measured using GPC-FTIR.

In an embodiment of the disclosure the ethylene copolymer composition has a partially reversed comonomer distribution profile as measured using GPC-FTIR.

In an embodiment of the disclosure, the ethylene copolymer composition has a fraction eluting at from 90 to 105° C., having an integrated area of greater than 3.0 wt %, in a temperature rising elution fractionation (TREF) analysis as obtained using a CTREF instrument (a “CRYSTAF/Temperature Rising Elution Fractionation” instrument). In an embodiment of the disclosure, the ethylene copolymer composition has a fraction eluting at from 90 to 105° C., having an integrated area of greater than 3.5 wt %, in a temperature rising elution fractionation (TREF) analysis as obtained using a CTREF instrument (a “CRYSTAF/Temperature Rising Elution Fractionation” instrument). In an embodiment of the disclosure, the ethylene copolymer composition has a fraction eluting at from 90 to 105° C., having an integrated area of greater than 4.0 weight percent, in a temperature rising elution fractionation (TREF) analysis as obtained using a CTREF instrument (a “CRYSTAF/Temperature Rising Elution Fractionation” instrument). In an embodiment of the disclosure, the ethylene copolymer composition has a fraction eluting at from 90 to 105° C., having an integrated area of greater than 4.5 wt %, in a temperature rising elution fractionation (TREF) analysis as obtained using a CTREF instrument (a “CRYSTAF/Temperature Rising Elution Fractionation” instrument). In an embodiment of the disclosure, the ethylene copolymer composition has a fraction eluting at from 90 to 105° C., having an integrated area of greater than 5.0 wt %, in a temperature rising elution fractionation (TREF) analysis as obtained using a CTREF instrument (a “CRYSTAF/Temperature Rising Elution Fractionation” instrument).

In embodiments of the disclosure, the ethylene copolymer composition has a CDBI₅₀ of from about 50 to 85 wt %, or from about 60 to 85 wt %, or from about 60 to about 80 wt %, or from about 60 to about 75 wt %, or from about 50 to about 80 wt %, or from about 50 to about 75 wt %, or from about 55 to about 80 wt %, or from about 55 to about 75 wt %. In some embodiments, the ethylene copolymer composition has a CDBI₅₀ of from 50 to 75 wt %.

In some embodiments of the disclosure, the upper limit on the parts per million by weight (ppm) of hafnium in the ethylene copolymer composition is about 3.0 ppm, or about 2.5 ppm, or about 2.0 ppm, or about 1.5 ppm, or about 1.0 ppm, or about 0.75 ppm, or about 0.5 ppm. In some embodiments, the ethylene copolymer composition has at most 2.5 ppm of hafnium.

In some embodiments of the disclosure, the lower limit on the parts per million by weight (ppm) of hafnium in the ethylene copolymer composition is about 0.0015 ppm, or about 0.0050 ppm, or about 0.0075 ppm, or about 0.010 ppm, or about 0.015 ppm, or about 0.030 ppm, or about 0.050 ppm, or about 0.075 ppm, or about 0.100 ppm, or about 0.150 ppm, or about 0.175 ppm, or about 0.200 ppm. In some embodiments, the ethylene copolymer composition has at least 0.050 ppm of hafnium.

In embodiments of the disclosure, the ethylene copolymer composition has from 0.0015 to 2.5 ppm of hafnium, or from 0.0050 to 2.5 ppm of hafnium, or from 0.0075 to 2.5 ppm of hafnium, or from 0.010 to 2.5 ppm of hafnium, or from 0.015 to 2.5 ppm of hafnium, or from 0.050 to 3.0 ppm of hafnium, or from 0.050 to 2.5 ppm, or from 0.075 to 2.5 ppm of hafnium, or from 0.075 to 2.0 ppm of hafnium, or from 0.075 to 1.5 ppm of hafnium, or from 0.075 to 1.0 ppm of hafnium, or from 0.075 to 0.5 ppm of hafnium, or from 0.100 to 2.0 ppm of hafnium, or from 0.100 to 1.5 ppm of hafnium, or from 0.100 to 1.0 ppm of hafnium, or from 0.100 to 0.75 ppm of hafnium, or from 0.10 to 0.5 ppm of hafnium, or from 0.15 to 0.5 ppm of hafnium, or from 0.20 to 0.5 ppm of hafnium. In some embodiments, the ethylene copolymer composition has from 0.050 ppm to 2.5 ppm of hafnium.

In some embodiments of the disclosure, the upper limit on the parts per million by weight (ppm) of titanium in the ethylene copolymer composition is about 18.0 ppm, or about 16.0 ppm, or about 14.0 ppm, or about 12.0 ppm, or about 10.0 ppm, or about 8.0 ppm. In some embodiments of the disclosure, the lower limit on the parts per million by weight (ppm) of titanium in the ethylene copolymer composition is about 0.050 ppm, or about 0.1 ppm, or about 0.5 ppm, or about 1.0 ppm, or about 2.0 ppm, or about 3.0 ppm.

In embodiments of the disclosure, the ethylene copolymer composition has from 0.050 to 14.0 ppm of titanium, or from 0.5 to 20.0 ppm of titanium, or from 0.5 to 18.0 ppm of titanium, or from 0.5 to 14.0 ppm of titanium, or from 1.0 to 18.0 ppm of titanium, or from 1.0 to 16.0 ppm of titanium, or from 1.0 to 14.0 ppm of titanium, or from 2.0 to 18.0 ppm of titanium, or from 2.0 to 16.0 ppm of titanium, or from 2.0 to 14.0 ppm of titanium, or from 3.0 to 18.0 ppm of titanium, or from 3.0 to 16.0 ppm of titanium, or from 3.0 to 14.0 ppm of titanium. In some embodiments, the ethylene copolymer composition has from 0.50 to 14.0 ppm of titanium.

In an embodiment of the disclosure, the ethylene copolymer composition has a stress exponent, defined as Log₁₀[I₆/I₂]/Log₁₀[6.48/2.16], which is ≤1.70. In further embodiments of the disclosure the ethylene copolymer composition has a stress exponent, Log₁₀[I₆/I₂]/Log₁₀[6.48/2.16], of less than 1.67, or less than 1.64, or less than 1.61, or less than 1.58.

In some embodiments, the ethylene copolymer composition has a dimensionless long chain branching factor (LCBF) of ≥0.001 or ≥0.01 or ≥0.025.

In some embodiments, the ethylene copolymer composition has a nonlinear rheology network parameter (Δ_{int.}) of at least 0.057, or at least 0.058. In some embodiments, the ethylene copolymer composition has a nonlinear rheology network parameter (Δ_{int.}) of at most 0.072, or at most 0.071. In some embodiments, the ethylene copolymer composition has a nonlinear rheology network parameter (Δ_{int.}) of from 0.055 to 0.072, or from 0.055 to 0.071, or from 0.057 to 0.075, or from 0.057 to 0.072, or from 0.057 to 0.071, or from 0.058 to 0.075, or from 0.058 to 0.072, or from 0.058 to 0.071.

In some embodiments, the ethylene copolymer composition has a normalized molecular weight Z (defined by Z=M_{w}/Mₑ) of at least 85, or at least 90. In some embodiments, the ethylene copolymer composition has a normalized molecular weight Z of at most 115, or at most 110. In some embodiments, the ethylene copolymer composition has a normalized molecular weight Z of from 80 to 115, or from 80 to 110, or from 85 to 120, or from 85 to 115, or from 85 to 110, or from 90 to 120, or from 90 to 115, or from 90 to 110.

In some embodiments, the ethylene copolymer composition has a weight average relaxation time of at least 30 seconds. In some embodiments, the ethylene copolymer composition has a weight average relaxation time of at most 1000 seconds. In some embodiments, the ethylene copolymer composition has a weight average relaxation time of from 30 seconds to 1000 seconds.

In the present disclosure, the ethylene copolymer composition described herein is blended with a low-density polyethylene (LDPE) to form a polymer blend.

### The Low Density Polyethylene (LDPE)

In embodiments, the low density polyethylene (LDPE) is an ethylene homopolymer and is prepared by the free radical homopolymerization of ethylene.

Without wishing to be bound by theory, LDPE has high degrees of so-called long chain branching (which may be as long as the main polymer backbone) and which gives the LDPE a non-linear microstructure. Accordingly, low density polyethylene (LDPE) is distinct from linear polyethylene which is made using ethylene polymerization catalysts, as further described below, and which has a linear polymer microstructure. Further description of low density polyethylene (LDPE) that may be used in embodiments of the present disclosure can be found in the Kirk-Othmer Encyclopedia of Chemical Technology, in the chapter titled “Polyethylene, Low Density” by Norma Maraschin (first published Mar. 18, 2005), which description is incorporated herein in its entirety by reference.

In embodiments of the disclosure, a low density polyethylene (LDPE), is prepared in either a tubular reactor or an autoclave reactor.

A tubular reactor operates in a continuous mode and at high pressures and temperatures. Typical operating pressures for a tubular reactor are from 2000 to 3500 bar. Operating temperatures can range from 140 to 340° C. The reactor is designed to have a large length to diameter ratio (for example, from 400 to 40,000) and may have multiple reaction zones which take the shape of an elongated coil. High gas velocities (at least 10 m/s) are used to provide optimal heat transfer. Conversions for multi-zone systems are typically 22 to 30% per pass but can be as high as 36 to 40%. Tubular reactors may have multiple injection points for the addition of monomer or initiators to different reaction zones having different temperatures.

An autoclave reactor may have a length to diameter ratio of between 2 and 20 and may be single stage or multistage. Typically, low temperature ethylene is passed into a hot reaction zone and conversion may be controlled by the temperature differential between the incoming ethylene gas and the temperature of the autoclave reactor. Conversions are usually lower in an autoclave reactor, up to 23% per pass, than in a tubular reactor which has a higher capacity to remove the heat of polymerization. Typical operating pressures for autoclave reactors are from 1100 to 2000 bar. Average operating temperatures are from 220 to 300° C., but temperatures can be as high as 340° C.

A wide variety of initiators may be used with each type of reactor to initiate the free radical polymerization of ethylene. Initiators may include oxygen or one or more organic peroxides, such as but not limited to di-tert-butylperoxide, cumuyl peroxide, tert-butyl-peroxypivalate, tert-butyl hydroperoxide, benzoyl peroxide, tert-amyl peroxypivalate, tert-butyl-peroxy-2-ethylhexanoate, and decanoyl peroxide. Chain transfer reagents may also be used with each type of reactor to control the polymer melt index. Chain transfer reagents include but are not limited to propane, n-butane, n-hexane, cyclohexane, propylene, 1-butene, and isobutylene.

In embodiments of the disclosure, the LDPE has a density of from about 0.910 g/cm³ to about 0.940 g/cm³, including sub ranges within this range or any value within this range. For example, in embodiments of the disclosure, the LDPE has a density of from about 0.914 g/cm³ to about 0.930 g/cm³, or from about 0.916 g/cm³ to about 0.930 g/cm³, or from about 0.920 g/cm³ to about 0.940 g/cm³, or from about 0.920 g/cm³ to about 0.930 g/cm³.

In some embodiments, the LDPE has a density of at most 0.930 g/cm³. In some embodiments, the LDPE has a density of at most 0.928 g/cm³. In some embodiments, the LDPE has a density of at most 0.925 g/cm³. In some embodiments, the LDPE has a density of at most 0.922 g/cm³. In some embodiments, the LDPE has a density of at least 0.917 g/cm³. In some embodiments, the LDPE has a density of at least 0.918 g/cm³.

In some embodiments, the LDPE has a density of from 0.917 to 0.930 g/cm³. In some embodiments, the LDPE has a density of from 0.917 to 0.925 g/cm³. In some embodiments, the LDPE has a density of from 0.918 to 0.922 g/cm³. In some embodiments, the LDPE has a density of about 0.920 g/cm³.

In some embodiments, the LDPE used in the present disclosure has a melt index (I₂) of from 0.1 to 20.0 g/10 min, or from 0.1 to 15.0 g/10 min, or from 0.1 to 10.0 g/10 min.

In some embodiments, the LDPE used in the present disclosure has a melt index (I₂) of at least 1.0 g/10 min, or at least 2.0 g/10 min, or at least 2.5 g/10 min, or at least 3.0 g/10 min.

In some embodiments, the LDPE used in the present disclosure has a melt index (I₂) of less than 3.0 g/10 min, or less than 2.0 g/10 min, or less than 1.0 g/10 min.

In some embodiments, the LDPE has a melt index (I₂) of at most 0.35 g/10 min. In some embodiments, the LDPE has a melt index (I₂) of at most 0.30 g/10 min. In some embodiments, the LDPE has a melt index (I₂) of at most 0.28 g/10 min. In some embodiments, the LDPE has a melt index (I₂) of at least 0.20 g/10 min. In some embodiments, the LDPE has a melt index (I₂) of at least 0.22 g/10 min.

In some embodiments, the LDPE has a melt index (I₂) of from 0.20 to 0.35 g/10 min. In some embodiments, the LDPE has a melt index (I₂) of from 0.20 to 0.30 g/10 min. In some embodiments, the LDPE has a melt index (I₂) of from 0.20 to 0.28 g/10 min. In some embodiments, the LDPE has a melt index (I₂) of from 0.22 to 0.30 g/10 min. In some embodiments, the LDPE has a melt index (I₂) of from 0.22 to 0.28 g/10 min. In some embodiments, the LDPE has a melt index (I₂) of about 0.25 g/10 min.

In some embodiments, the LDPE used in the present disclosure has a melt index (I₂) of from 1.0 to 10.0 g/10 min, or from 1.5 to 10.0 g/10 min, or from 2.0 to 10 g/10 min, or from 2.5 to 10.0 g/10 min, or from 3.0 to 10.0 g/10 min, or from 3.5 to 10.0 g/10 min, or from 4.0 to 10.0 g/10 min, or from 2.5 to 9.0 g/10 min, or from 2.5 to 8.5 g/10 min, or from 2.5 to 8.0 g/10 min, or from 3.0 to 9.0 g/10 min, or from 3.0 to 8.5 g/10 min, or from 3.0 to 8.0 g/10 min, or from 3.5 to 9.0 g/10 min, or from 3.5 to 8.5 g/10 min, or from 3.5 to 8.0 g/10 min, or from 4.0 to 9.0 g/10 min, or from 4.0 to 8.5 g/10 min or from 4.0 to 8.0 g/10 min.

In some embodiments, the LDPE has a melt index (I₂) of from 0.22 to 0.28 g/10 min and a density of from 0.918 to 0.922 g/cm³. In some embodiments, the LDPE has a melt index (I₂) of about 0.25 g/10 min and a density of about 0.920 g/cm³.

In embodiments of the disclosure, a high pressure low density polyethylene (LDPE) is a blend of LDPE materials having different densities and/or different melt indices (2).

In an embodiment, low density polyethylene (LDPE), is a blend of LDPE made in a tubular reactor and LDPE made in an autoclave reactor.

In an embodiment, a LDPE polymer blend is prepared by physically blending different high pressure LDPEs (e.g. a LDPE produced in a tubular reactor with the LDPE produced in an autoclave reactor). Physically blending is meant to encompass those processes in which two or more individual ethylene homopolymers are mixed after they are removed from a polymerization reaction zone. Physically blending of the individual LDPEs may be accomplished by dry blending (e.g. tumble blending), extrusion blending (co-extrusion), solution blending, melt blending or any other similar blending technique known to those skilled in the art.

In embodiments of the disclosure, the LDPE has a molecular weight distribution (M_{w}/Mₙ) of greater than about 5.0. In embodiments of the disclosure, the LDPE has a molecular weight distribution (M_{w}/Mₙ) of from about 8.0 to about 30.0.

The molecular weight of the of the LDPE or blends thereof can further be described as unimodal, bimodal or multimodal. By using the term “unimodal”, it is meant that the molecular weight distribution, can be said to have only one maximum in a molecular weight distribution curve. A molecular weight distribution curve can be generated according to the method of ASTM D6474-99. By using the term “bimodal”, it is meant that the molecular weight distribution, can be said to have two maxima in a molecular weight distribution curve. The term “multi-modal” denotes the presence of more than two maxima in such a curve.

In embodiments of the disclosure, the LDPE used has a unimodal, bimodal or multimodal molecular weight distributions.

In an embodiment of the disclosure, the LDPE used is made in a tubular reactor and has a multimodal molecular weight distribution.

In embodiments of the disclosure, the LDPE used is made in an autoclave reactor and has a bimodal or multimodal molecular weight distribution.

In an embodiment of the disclosure, a blend of LDPEs is used and the blend has a multimodal molecular weight distribution.

### The Polymer Blend

Polymer blends can be prepared in numerous ways known in the art, including but not limited to melt compounding and solution blending.

In the Examples described herein, resin blends used in Layer 2 were prepared by placing the target weight percentages of each component (e.g. 40% of NOVAPOL® LF-Y320-A, a high pressure low density polyethylene resin available from NOVA Chemicals Corporation, having a density of about 0.920 g/cm³ and a melt index [I₂] of about 0.25 g/10 min, together with 60% of either an inventive ethylene copolymer composition made according to the present disclosure or a comparative resin) into a batch mixer, and tumble blending for at least 15 minutes. Finished blends were fed directly into the Layer 2 extruder hopper as a dry blend.

### Films and Manufactured Articles

The polymer blend disclosed herein may be converted into flexible manufactured articles such as monolayer or multilayer films. Although films comprising the inventive polymer blend described herein are not known, related films and the concept thereof are well known to those experienced in the art. Non-limiting examples of processes to prepare such films include blown film and cast film processes.

In the blown film extrusion process, an extruder heats, melts, mixes and conveys a thermoplastic, or a thermoplastic blend. Once molten, the thermoplastic is forced through an annular die to produce a thermoplastic tube. In the case of coextrusion, multiple extruders are employed to produce a multilayer thermoplastic tube. The temperature of the extrusion process is primarily determined by the thermoplastic or thermoplastic blend being processed, for example the melting temperature or glass transition temperature of the thermoplastic and the desired viscosity of the melt. In the case of polyolefins, typical extrusion temperatures are from 330° F. to 550° F. (166° C. to 288° C.). Upon exit from the annular die, the thermoplastic tube is inflated with air, cooled, solidified and pulled through a pair of nip rollers. Due to air inflation, the tube increases in diameter forming a bubble of desired size. Due to the pulling action of the nip rollers the bubble is stretched in the machine direction. Thus, the bubble is stretched in two directions: the transverse direction (TD) where the inflating air increases the diameter of the bubble; and the machine direction (MD) where the nip rollers stretch the bubble. As a result, the physical properties of blown films are typically anisotropic, i.e. the physical properties differ in the MD and TD directions; for example, film tear strength and tensile properties typically differ in the MD and TD. In some prior art documents, the terms “cross direction” or “CD” is used; these terms are equivalent to the terms “transverse direction” or “TD” used in this disclosure. In the blown film process, air is also blown on the external bubble circumference to cool the thermoplastic as it exits the annular die. The final width of the film is determined by controlling the inflating air or the internal bubble pressure; in other words, increasing or decreasing bubble diameter. Film thickness is controlled primarily by increasing or decreasing the speed of the nip rollers to control the draw-down rate. After exiting the nip rollers, the bubble or tube is collapsed and may be slit in the machine direction thus creating sheeting. Each sheet may be wound into a roll of film. Each roll may be further slit to create film of the desired width. Each roll of film is further processed into a variety of consumer products as described below.

The cast film process is similar in that a single or multiple extruder(s) may be used; however, the various thermoplastic materials are metered into a flat die and extruded into a monolayer or multilayer sheet, rather than a tube. In the cast film process, the extruded sheet is solidified on a chill roll.

In the cast film process, films are extruded from a flat die onto a chilled roll or a nipped roll, optionally, with a vacuum box and/or air-knife. The cast films may be monolayer or coextruded multi-layer films obtained by various extrusion through a single or multiple dies. The resultant films may be used as-is or may be laminated to other films or substrates, for example by thermal, adhesive lamination or direct extrusion onto a substrate. The resultant films and laminates may be subjected to other forming operations such as embossing, stretching, thermoforming. Surface treatments such as corona may be applied and the films may be printed.

In the cast film extrusion process, a thin film is extruded through a slit onto a chilled, highly polished turning roll, where it is quenched from one side. The speed of the roller controls the draw ratio and final film thickness. The film is then sent to a second roller for cooling on the other side. Finally, it passes through a system of rollers and is wound onto a roll.

In an embodiment, two or more thin films are coextruded through two or more slits onto a chilled, highly polished turning roll, the coextruded film is quenched from one side. The speed of the roller controls the draw ratio and final coextruded film thickness. The coextruded film is then sent to a second roller for cooling on the other side. Finally, it passes through a system of rollers and is wound onto a roll.

A cast film may further be laminated, one or more layers, into a multilayer structure.

Depending on the end-use application, the disclosed polymer blend may be converted into films that span a wide range of thicknesses. Non-limiting examples include food packaging films, where thicknesses may range from about 0.5 mil (about 13 μm) to about 4 mil (about 102 μm), and heavy duty sack applications, where film thickness may range from about 2 mil (about 51 μm) to about 10 mil (about 254 μm).

The polymer blend disclosed herein may be used in monolayer films; where the monolayer may contain more than one polymer blend and/or additional thermoplastics; non-limiting examples of thermoplastics include polyethylene polymers and propylene polymers. The lower limit on the weight percent of the polymer blend in a monolayer film may be about 3 wt %, in other cases about 10 wt % and in still other cases about 30 wt %. The upper limit on the weight percent of the polymer blend in the monolayer film may be 100 wt %, in other cases about 90 wt % and in still other cases about 70 wt %.

The polymer blend disclosed herein may also be used in one or more layers of a multilayer film; non-limiting examples of multilayer films include two, three, four, five, six or more layers. The thickness of a specific layer (containing the polymer blend) within a multilayer film may be about 50% of the total multilayer film thickness, or about 55% or about 60% or about 65% or about 70% or about 75% or about 80% or about 85% or about 90% or about 95% of the total multilayer film thickness. Each individual layer of a multilayer film may contain more than one polymer blend and/or additional thermoplastics.

Additional embodiments include laminations and coatings, wherein mono-or multilayer films containing the disclosed polymer blend are extrusion laminated or adhesively laminated or extrusion coated. In extrusion lamination or adhesive lamination, two or more substrates are bonded together with a thermoplastic or an adhesive, respectively. In extrusion coating, a thermoplastic is applied to the surface of a substrate. These processes are well known to those experienced in the art. Frequently, adhesive lamination or extrusion lamination are used to bond dissimilar materials, non-limiting examples include the bonding of a paper web to a thermoplastic web, or the bonding of an aluminum foil containing web to a thermoplastic web, or the bonding of two thermoplastic webs that are chemically incompatible, e.g. the bonding of a polymer blend containing web to a polyester or polyamide web. Prior to lamination, the web containing the disclosed polymer blend(s) may be monolayer or multilayer. Prior to lamination, the individual webs may be surface treated to improve the bonding, a non-limiting example of a surface treatment is corona treating. A primary web or film may be laminated on its upper surface, its lower surface, or both its upper and lower surfaces with a secondary web. A secondary web and a tertiary web could be laminated to the primary web; wherein the secondary and tertiary webs differ in chemical composition. As non-limiting examples, secondary or tertiary webs may include: polyamide, polyester and polypropylene, or webs containing barrier resin layers such as EVOH. Such webs may also contain a vapor deposited barrier layer; for example, a thin silicon oxide (SiOₓ) or aluminum oxide (AlOₓ) layer. Multilayer webs (or films) may contain three, five, seven, nine, eleven or more layers.

The polymer blend disclosed herein can be used in a wide range of manufactured articles comprising one or more films or film layers (monolayer or multilayer). Non-limiting examples of such manufactured articles include: food packaging films (fresh and frozen foods, liquids and granular foods), stand-up pouches, retortable packaging and bag-in-box packaging; barrier films (oxygen, moisture, aroma, oil, etc.) and modified atmosphere packaging; light and heavy duty shrink films and wraps, collation shrink film, pallet shrink film, shrink bags, shrink bundling and shrink shrouds; light and heavy duty stretch films, hand stretch wrap, machine stretch wrap and stretch hood films; high clarity films; heavy-duty sacks; household wrap, overwrap films and sandwich bags; industrial and institutional films, trash bags, can liners, magazine overwrap, newspaper bags, mail bags, sacks and envelopes, bubble wrap, carpet film, furniture bags, garment bags, coin bags, auto panel films; medical applications such as gowns, draping and surgical garb; construction films and sheeting, asphalt films, insulation bags, masking film, landscaping film and bags; geomembrane liners for municipal waste disposal and mining applications; batch inclusion bags; agricultural films, mulch film and green house films; in-store packaging, self-service bags, boutique bags, grocery bags, carry-out sacks and T-shirt bags; oriented films, machine direction and biaxially oriented films and functional film layers in oriented polypropylene (OPP) films, e.g. sealant and/or toughness layers. Additional manufactured articles comprising one or more films containing at least one polymer blend include laminates and/or multilayer films; sealants and tie layers in multilayer films and composites; laminations with paper; aluminum foil laminates or laminates containing vacuum deposited aluminum; polyamide laminates; polyester laminates; extrusion coated laminates; and hot-melt adhesive formulations. The manufactured articles summarized in this paragraph contain at least one film (monolayer or multilayer) comprising at least one embodiment of the disclosed polymer blend. The polymer blend of the invention is particularly useful in collation shrink films and packaging.

Cast films and laminates made from polymer blends of the present disclosure may be used in a variety of end-uses, such as for example, for food packaging (dry foods, fresh foods, frozen foods, liquids, processed foods, powders, granules), for packaging of detergents, toothpaste, towels, for labels and release liners. The cast films may also be used in unitization and industrial packaging, notably in stretch films. The cast films may also be suitable in hygiene and medical applications, for example in breathable and non-breathable films used in diapers, adult incontinence products, feminine hygiene products, ostomy bags. The polymer blend of the present disclosure may also be useful in tapes and artificial turf applications.

Desired film physical properties (monolayer or multilayer) typically depend on the application of interest. Non-limiting examples of desirable film properties include: optical properties (gloss, haze and clarity), dart impact, Elmendorf tear, modulus (1% and 2% secant modulus), puncture-propagation tear resistance, tensile properties (yield strength, break strength, elongation at break, toughness, etc.) and heat sealing properties (heat seal initiation temperature and hot tack strength). Specific hot tack and heat sealing properties are desired in high speed vertical and horizontal form-fill-seal processes that load and seal a commercial product (liquid, solid, paste, part, etc.) inside a pouch-like package.

Where the application is collation shrink films or packaging, particularly desired properties are good optical properties (generally high gloss and low haze, or a good balance thereof), good physical properties (generally high toughness and high abuse resistance) and good shrink performance characteristics (measurable by shrink force, percentage shrinkage, package integrity).

In addition to desired film physical properties, it is desired that the disclosed polymer blend is easy to process on film lines. Those skilled in the art frequently use the term “processability” to differentiate polymers with improved processability, relative to polymers with inferior processability. A commonly used measure to quantify processability is extrusion pressure; more specifically, a polymer with improved processability has a lower extrusion pressure (on a blown film or a cast film extrusion line) relative to a polymer with inferior processability.

The films used in the manufactured articles described in this section may optionally include, depending on its intended use, additives and adjuvants. Non-limiting examples of additives and adjuvants include anti-blocking agents, antioxidants, heat stabilizers, slip agents, processing aids, anti-static additives, colorants, dyes, filler materials, light stabilizers, light absorbers, lubricants, pigments, plasticizers, nucleating agents and combinations thereof.

In an embodiment of the disclosure, a film or film layer comprises the polymer blend described herein.

In an embodiment of the disclosure, a film or film layer is a monolayer film and comprises the polymer blend described herein.

In an embodiment a film or film layer is a blown film.

In an embodiment a film or film layer is a cast film.

In embodiments of the disclosure, a film or film layer comprises the polymer blend described herein and has a thickness of from 10 to 250 μm.

In embodiments of the disclosure, a film or film layer has a thickness of from 10 to 250 μm.

The fourth aspect of the invention relates to a multilayer film structure comprising at least one film layer comprising the polymer blend described herein.

In an embodiment of the disclosure, a multilayer film structure comprises at least one layer comprising the polymer blend described herein, and the multilayer film structure has a thickness of from 10 to 250 μm.

An embodiment of the disclosure is a multilayer coextruded blown film structure.

An embodiment of the disclosure is a multilayer coextruded blown film structure having a thickness of from 10 to 250 μm.

An embodiment of the disclosure is a multilayer coextruded blown film structure comprising a film layer comprising the polymer blend described herein.

An embodiment of the disclosure is a multilayer coextruded blown film structure comprising a film layer comprising the polymer blend described herein, and the multilayer film structure has a thickness of from 10 to 250 μm.

An embodiment of the disclosure is a multilayer coextruded cast film structure.

An embodiment of the disclosure is a multilayer coextruded cast film structure having a thickness of from 10 to 250 μm.

An embodiment of the disclosure is a multilayer coextruded cast film structure comprising a film layer comprising the polymer blend described herein.

An embodiment of the disclosure is a multilayer coextruded cast film structure comprising a film layer comprising the polymer blend described herein, and the multilayer film structure has a thickness of from 10 to 250 μm.

An embodiment of the disclosure is a multilayer film structure comprising at least one film layer comprising the polymer blend described herein where the multilayer film structure has at least 2 layers, or at least 3 layers, or at least 4 layers, or at least 5 layers, or at least 6 layers.

An embodiment of the disclosure is a multilayer film structure comprising at least one film layer comprising the polymer blend described herein where the multilayer film structure has 3 layers.

An embodiment of the disclosure is a multilayer film structure comprising a core layer comprising the polymer blend described herein.

An embodiment of the disclosure is a multilayer film structure comprising at least one core layer comprising the polymer blend described herein.

An embodiment of the disclosure is a multilayer film structure comprising a core layer comprising the polymer blend described herein and where the multilayer film structure has at least 3 layers.

An embodiment of the disclosure is a multilayer film structure comprising a core layer comprising the polymer blend described herein and where the multilayer film structure has at least 5 layers.

An embodiment of the disclosure is a multilayer film structure comprising a core layer comprising the polymer blend described herein and where the multilayer film structure has at least 7 layers.

An embodiment of the disclosure is a multilayer film structure comprising a core layer comprising the polymer blend described herein and where the multilayer film structure has at least 9 layers.

An embodiment of the disclosure is a multilayer film structure comprising a core layer comprising the polymer blend described herein and where the multilayer film structure has 3 layers.

### Skin Layer

In preferred embodiments, the multilayer film structure comprises, in addition to the film layer as defined in the third aspect, a skin layer. In embodiments, the skin layer comprises a linear low density polyethylene (LLDPE), a medium density polyethylene (MDPE), a high density polyethylene (HDPE) or a very low density polyethylene (VLDPE). In an embodiment the skin layer comprises a linear low density polyethylene (LLDPE).

In the present disclosure, linear low density polyethylene (LLDPE) is an ethylene copolymer with another alpha olefin (such as, for example, 1-butene, 1-hexene, and/or 1-octene), and has a density of from about 0.910 g/cm³ to about 0.940 g/cm³ including subranges within this range or any value within this range. In embodiments of the disclosure, a LLDPE has a density of from 0.910 to 0.936 g/cm³, or from 0.912 to 0.936 g/cm³, or from 0.910 to 0.932 g/cm³, or from 0.912 to 0.932 g/cm³.

In the present disclosure, medium density polyethylene (MDPE) is an ethylene copolymer with another alpha olefin (such as, for example, 1-butene, 1-hexene, and/or 1-octene) and has a density of from about 0.940 g/cm³ to about 0.949 g/cm³ including subranges within this range or any value within this range.

In the present disclosure, a high density polyethylene (HDPE) is an ethylene homopolymer or an ethylene copolymer with another alpha olefin (such as, for example, 1-butene, 1-hexene, and/or 1-octene) and has a density of about 0.949 g/cm³ or greater. In embodiments, a HPDE is an ethylene homopolymer or an ethylene copolymer with another alpha olefin (such as, for example, 1-butene, 1-hexene, and/or 1-octene) having a density of at least 0.950 g/cm³, or at least 0.951 g/cm³, or at least 0.952 g/cm³, or at least 0.953 g/cm³. In embodiments, a HPDE is an ethylene homopolymer or an ethylene copolymer with another alpha olefin (such as, for example, 1-butene, 1-hexene, and/or 1-octene) having a density of from about 0.950 g/cm³ to about 0.970 g/cm³, or from about 0.950 g/cm³ to about 0.965 g/cm³.

In the present disclosure, very low density polyethylene is an ethylene copolymer with another alpha olefin (such as propylene, 1-butene, 4-methyl-1-pentene, 1-hexene, and/or 1-octene) and has a density of less than about 0.910 g/cm³ and may include so called elastomers and plastomers. In embodiments, a VLDPE is an ethylene copolymer with another alpha olefin (such as, for example, propylene, 1-butene, 4-methyl-1-pentene 1-hexene, and/or 1-octene) having a density of from about 0.880 g/cm³ to about 0.910 g/cm³, or from about 0.880 g/cm³ to about 0.905 g/cm³, or from about 0.880 g/cm³ to about 0.902 g/cm³.

Depending on the types of polymerization process and olefin polymerization catalyst used, in embodiments of the disclosure, the LLDPE may have a weight average molecular weight (M_{w}) of at least about 10,000 g/mol, and up to about 1,500,000 g/mol, including any sub range within this range or any value within this range. For example, in further embodiments, the LLDPE has a weight average molecular weight (M_{w}) of from about 50,000 to about 1,000,000 g/mol, or from about 100,000 to about 1,000,000 g/mol, or from about 75,000 to about 750,000 g/mol, or from about 100,000 to about 750,000 g/mol, or from about 75,000 to about 500,000 g/mol, or from about 100,000 to about 500.00 g/mol, or from about 50,000 to about 350.00 g/mol, or from about 75,000 to about 350,000 g/mol, or from about 100,000 to about 350,000 g/mol, or from about 50,000 to about 300,000 g/mol, or from about 75,000 to about 300,000 g/mol, or from about 100,000 to about 300,000 g/mol, or from about 50,000 to about 250,000 g/mol, or from about 75,000 to about 250,000 g/mol, or from about 100,000 to about 250,000 g/mol.

In embodiments of the disclosure, the LLDPE has a molecular weight distribution (M_{w}/Mₙ) of from about 2.0 to about 12.0, including sub ranges within this range or any value within this range. For example, in embodiments of the disclosure, the LLDPE has a M_{w}/Mₙ value of from about 2.0 to about 10.0, or from about 2.0 to about 8.0, or from about 2.0 to about 5.0.

In embodiments of the disclosure, a LLDPE is characterized by its melt index (12), as determined by ASTM D1238, Condition E, at 190° C. In embodiments of the disclosure, a LLDPE has a melt index (I₂) of from 0.1 to 20.0 g/10 min, including any sub range within this range or any value within this range. For example, in embodiments of the disclosure, a LLDPE has a melt index (I₂) of from 0.1 to 15.0 g/10 min, or from 0.1 to 10.0 g/10 min, or from 0.3 to 15.0 g/10 min, or from 0.3 to 10.0 g/10 min, or from 0.1 to 5.0 g/10 min, or from 0.3 to 5.0 g/10 min, or from 0.5 to 15.0 g/10 min, or from 0.5 to 10.0 g/10 min, or from 0.5 to 5.0 g/10 min.

In some embodiments, the LLDPE of which the skin layer is comprised has a melt index (I₂) of at least 0.6 g/10 min. In some embodiments, the LLDPE of which the skin layer is comprised has a melt index (I₂) of at least 0.7 g/10 min. In some embodiments, the LLDPE of which the skin layer is comprised has a melt index (I₂) of at least 0.8 g/10 min. In some embodiments, the LLDPE of which the skin layer is comprised has a melt index (I₂) of at least 0.9 g/10 min. In some embodiments, the LLDPE of which the skin layer is comprised has a melt index (I₂) of at least 0.95 g/10 min.

In some embodiments, the LLDPE of which the skin layer is comprised has a melt index (I₂) of at most 1.7 g/10 min. In some embodiments, the LLDPE of which the skin layer is comprised has a melt index (I₂) of at most 1.5 g/10 min. In some embodiments, the LLDPE of which the skin layer is comprised has a melt index (I₂) of at most 1.3 g/10 min. In some embodiments, the LLDPE of which the skin layer is comprised has a melt index (I₂) of at most 1.2 g/10 min. In some embodiments, the LLDPE of which the skin layer is comprised has a melt index (I₂) of at most 1.1 g/10 min. In some embodiments, the LLDPE of which the skin layer is comprised has a melt index (I₂) of at most 1.05 g/10 min.

In some embodiments, the LLDPE of which the skin layer is comprised has a melt index (I₂) of from 0.6 to 1.7 g/10 min. In some embodiments, the LLDPE of which the skin layer is comprised has a melt index (I₂) of from 0.7 to 1.5 g/10 min. In some embodiments, the LLDPE of which the skin layer is comprised has a melt index (I₂) of from 0.8 to 1.5 g/10 min. In some embodiments, the LLDPE of which the skin layer is comprised has a melt index (I₂) of from 0.8 to 1.3 g/10 min. In some embodiments, the LLDPE of which the skin layer is comprised has a melt index (I₂) of from 0.9 to 1.3 g/10 min. In some embodiments, the LLDPE of which the skin layer is comprised has a melt index (I₂) of from 0.8 to 1.1 g/10 min. In some embodiments, the LLDPE of which the skin layer is comprised has a melt index (I₂) of from 0.9 to 1.1 g/10 min. In some embodiments, the LLDPE of which the skin layer is comprised has a melt index (I₂) of from 0.95 to 1.05 g/10 min.

In some embodiments, the LLDPE of which the skin layer is comprised has a melt index (I₂) of about 1 g/10 min.

In some embodiments, the LLDPE of which the skin layer is comprised has a density of at least 0.910 g/cm³. In some embodiments, the LLDPE of which the skin layer is comprised has a density of at least 0.912 g/cm³. In some embodiments, the LLDPE of which the skin layer is comprised has a density of at least 0.914 g/cm³. In some embodiments, the LLDPE of which the skin layer is comprised has a density of at least 0.915 g/cm³.

In some embodiments, the LLDPE of which the skin layer is comprised has a density of at most 0.940 g/cm³. In some embodiments, the LLDPE of which the skin layer is comprised has a density of at most 0.935 g/cm³. In some embodiments, the LLDPE of which the skin layer is comprised has a density of at most 0.930 g/cm³. In some embodiments, the LLDPE of which the skin layer is comprised has a density of at most 0.928 g/cm³. In some embodiments, the LLDPE of which the skin layer is comprised has a density of at most 0.925 g/cm³. In some embodiments, the LLDPE of which the skin layer is comprised has a density of at least 0.922 g/cm³. In some embodiments, the LLDPE of which the skin layer is comprised has a density of at most 0.920 g/cm³. In some embodiments, the LLDPE of which the skin layer is comprised has a density of at most 0.918 g/cm³.

In some embodiments, the LLDPE of which the skin layer is comprised has a density of from 0.910 to 0.940 g/cm³. In some embodiments, the LLDPE of which the skin layer is comprised has a density of from 0.910 to 0.935 g/cm³. In some embodiments, the LLDPE of which the skin layer is comprised has a density of from 0.910 to 0.930 g/cm³. In some embodiments, the LLDPE of which the skin layer is comprised has a density of from 0.910 to 0.925 g/cm³. In some embodiments, the LLDPE of which the skin layer is comprised has a density of from 0.912 to 0.940 g/cm³. In some embodiments, the LLDPE of which the skin layer is comprised has a density of from 0.912 to 0.935 g/cm³. In some embodiments, the LLDPE of which the skin layer is comprised has a density of from 0.912 to 0.930 g/cm³. In some embodiments, the LLDPE of which the skin layer is comprised has a density of from 0.912 to 0.925 g/cm³. In some embodiments, the LLDPE of which the skin layer is comprised has a density of from 0.912 to 0.922 g/cm³. In some embodiments, the LLDPE of which the skin layer is comprised has a density of from 0.912 to 0.920 g/cm³. In some embodiments, the LLDPE of which the skin layer is comprised has a density of from 0.914 to 0.925 g/cm³. In some embodiments, the LLDPE of which the skin layer is comprised has a density of from 0.914 to 0.922 g/cm³. In some embodiments, the LLDPE of which the skin layer is comprised has a density of from 0.914 to 0.920 g/cm³. In some embodiments, the LLDPE of which the skin layer is comprised has a density of from 0.914 to 0.918 g/cm³.

In some embodiments, the LLDPE of which the skin layer is comprised has a density of about 0.916 g/cm³.

### Layer Thickness

In some embodiments, the core layer makes up at least 50 percent of the thickness of the multilayer film structure. In some embodiments, the core layer makes up at least 55 percent of the thickness of the multilayer film structure. In some embodiments, the core layer makes up at least 60 percent of the thickness of the multilayer film structure. In some embodiments, the core layer makes up at least 62 percent of the thickness of the multilayer film structure. In some embodiments, the core layer makes up at least 64 percent of the thickness of the multilayer film structure. In some embodiments, the core layer makes up at least 66 percent of the thickness of the multilayer film structure. In some embodiments, the core layer makes up at least 68 percent of the thickness of the multilayer film structure.

In some embodiments, the core layer makes up at most 85 percent of the thickness of the multilayer film structure. In some embodiments, the core layer makes up at most 80 percent of the thickness of the multilayer film structure. In some embodiments, the core layer makes up at most 78 percent of the thickness of the multilayer film structure. In some embodiments, the core layer makes up at most 76 percent of the thickness of the multilayer film structure. In some embodiments, the core layer makes up at most 74 percent of the thickness of the multilayer film structure. In some embodiments, the core layer makes up at most 72 percent of the thickness of the multilayer film structure.

In some embodiments, the core layer makes up between 50 and 85 percent of the thickness of the multilayer film structure. In some embodiments, the core layer makes up between 55 and 85 percent of the thickness of the multilayer film structure. In some embodiments, the core layer makes up between 50 and 80 percent of the thickness of the multilayer film structure. In some embodiments, the core layer makes up between 55 and 80 percent of the thickness of the multilayer film structure. In some embodiments, the core layer makes up between 50 and 76 percent of the thickness of the multilayer film structure. In some embodiments, the core layer makes up between 55 and 76 percent of the thickness of the multilayer film structure. In some embodiments, the core layer makes up between 60 and 80 percent of the thickness of the multilayer film structure. In some embodiments, the core layer makes up between 60 and 76 percent of the thickness of the multilayer film structure. In some embodiments, the core layer makes up between 64 and 76 percent of the thickness of the multilayer film structure. In some embodiments, the core layer makes up between 64 and 72 percent of the thickness of the multilayer film structure. In some embodiments, the core layer makes up between 68 and 76 percent of the thickness of the multilayer film structure. In some embodiments, the core layer makes up between 68 and 72 percent of the thickness of the multilayer film structure.

In some embodiments, the core layer makes up about 70 percent of the thickness of the multilayer film structure.

In some embodiments, a single skin layer makes up at least 5 percent of the thickness of the multilayer film structure. In some embodiments, a single skin layer makes up at least 8 percent of the thickness of the multilayer film structure. In some embodiments, a single skin layer makes up at least 10 percent of the thickness of the multilayer film structure. In some embodiments, a single skin layer makes up at least 12 percent of the thickness of the multilayer film structure. In some embodiments, a single skin layer makes up at least 14 percent of the thickness of the multilayer film structure.

In some embodiments, a single skin layer makes up at most 25 percent of the thickness of the multilayer film structure. In some embodiments, a single skin layer makes up at most 22 percent of the thickness of the multilayer film structure. In some embodiments, a single skin layer makes up at most 20 percent of the thickness of the multilayer film structure. In some embodiments, a single skin layer makes up at most 18 percent of the thickness of the multilayer film structure. In some embodiments, a single skin layer makes up at most 16 percent of the thickness of the multilayer film structure.

In some embodiments, a single skin layer makes up between 5 and 25 percent of the thickness of the multilayer film structure. In some embodiments, a single skin layer makes up between 5 and 20 percent of the thickness of the multilayer film structure. In some embodiments, a single skin layer makes up between 10 and 25 percent of the thickness of the multilayer film structure. In some embodiments, a single skin layer makes up between 10 and 20 percent of the thickness of the multilayer film structure. In some embodiments, a single skin layer makes up between 12 and 20 percent of the thickness of the multilayer film structure. In some embodiments, a single skin layer makes up between 10 and 18 percent of the thickness of the multilayer film structure. In some embodiments, a single skin layer makes up between 14 and 16 percent of the thickness of the multilayer film structure.

In some embodiments, a single skin layer makes up about 15 percent of the thickness of the multilayer film structure.

In some embodiments, the skin layers collectively make up at least 15 percent of the thickness of the multilayer film structure. In some embodiments, the skin layers collectively make up at least 20 percent of the thickness of the multilayer film structure. In some embodiments, the skin layers collectively make up at least 22 percent of the thickness of the multilayer film structure. In some embodiments, the skin layers collectively make up at least 24 percent of the thickness of the multilayer film structure. In some embodiments, the skin layers collectively make up at least 26 percent of the thickness of the multilayer film structure. In some embodiments, the skin layers collectively make up at least 28 percent of the thickness of the multilayer film structure.

In some embodiments, the skin layers collectively make up at most 50 percent of the thickness of the multilayer film structure. In some embodiments, the skin layers collectively make up at most 45 percent of the thickness of the multilayer film structure. In some embodiments, the skin layers collectively make up at most 40 percent of the thickness of the multilayer film structure. In some embodiments, the skin layers collectively make up at most 38 percent of the thickness of the multilayer film structure. In some embodiments, the skin layers collectively make up at most 36 percent of the thickness of the multilayer film structure. In some embodiments, the skin layers collectively make up at most 34 percent of the thickness of the multilayer film structure. In some embodiments, the skin layers collectively make up at most 32 percent of the thickness of the multilayer film structure.

In some embodiments, the skin layers collectively make up between 15 and 50 percent of the thickness of the multilayer film structure. In some embodiments, the skin layers collectively make up between 15 and 45 percent of the thickness of the multilayer film structure. In some embodiments, the skin layers collectively make up between 20 and 50 percent of the thickness of the multilayer film structure. In some embodiments, the skin layers collectively make up between 20 and 45 percent of the thickness of the multilayer film structure. In some embodiments, the skin layers collectively make up between 24 and 50 percent of the thickness of the multilayer film structure. In some embodiments, the skin layers collectively make up between 24 and 45 percent of the thickness of the multilayer film structure. In some embodiments, the skin layers collectively make up between 20 and 40 percent of the thickness of the multilayer film structure. In some embodiments, the skin layers collectively make up between 24 and 40 percent of the thickness of the multilayer film structure. In some embodiments, the skin layers collectively make up between 24 and 36 percent of the thickness of the multilayer film structure. In some embodiments, the skin layers collectively make up between 28 and 36 percent of the thickness of the multilayer film structure. In some embodiments, the skin layers collectively make up between 24 and 32 percent of the thickness of the multilayer film structure. In some embodiments, the skin layers collectively make up between 28 and 32 percent of the thickness of the multilayer film structure.

In some embodiments, the skin layers collectively make up about 30 percent of the thickness of the multilayer film structure.

In some embodiments, the core layer makes up between 50 and 85 percent and the skin layers collectively make up between 15 and 50 percent of the thickness of the multilayer film structure. In some embodiments, the core layer makes up between 55 and 80 percent and the skin layers collectively make up between 20 and 45 percent of the thickness of the multilayer film structure. In some embodiments, the core layer makes up between 60 and 80 percent and the skin layers collectively make up between 20 and 40 percent of the thickness of the multilayer film structure. In some embodiments, the core layer makes up between 64 and 76 percent and the skin layers collectively make up between 24 and 36 percent of the thickness of the multilayer film structure. In some embodiments, the core layer makes up between 68 and 72 percent and the skin layers collectively make up between 28 and 32 percent of the thickness of the multilayer film structure.

In some embodiments, the core layer makes up about 70 percent and the skin layers collectively make up about 30 percent of the thickness of the multilayer film structure.

In some embodiments, the core layer makes up between 50 and 85 percent and a single skin layer makes up between 5 and 25 percent of the thickness of the multilayer film structure. In some embodiments, the core layer makes up between 55 and 80 percent and a single skin layer makes up between 10 and 25 percent of the thickness of the multilayer film structure. In some embodiments, the core layer makes up between 60 and 80 percent and a single skin layer makes up between 10 and 20 percent of the thickness of the multilayer film structure. In some embodiments, the core layer makes up between 64 and 76 percent and a single skin layer makes up between 12 and 18 percent of the thickness of the multilayer film structure. In some embodiments, the core layer makes up between 68 and 72 percent and a single skin layer makes up between 14 and 16 percent of the thickness of the multilayer film structure.

In some embodiments, the core layer makes up about 70 percent and a single skin layer makes up about 15 percent of the thickness of the multilayer film structure.

In some embodiments, the core layer makes up between 60 and 80 percent, a first skin layer makes up between 10 and 20 percent, and a second skin layer makes up between 10 and 20 percent of the thickness of the multilayer film structure. In some embodiments, the core layer makes up between 64 and 76 percent, a first skin layer makes up between 12 and 18 percent, and a second skin layer makes up between 12 and 18 percent of the thickness of the multilayer film structure. In some embodiments, the core layer makes up between 68 and 72 percent, a first skin layer makes up between 14 and 16 percent, and a second skin layer makes up between 14 and 16 percent of the thickness of the multilayer film structure.

In some embodiments, the core layer makes up about 70 percent, a first skin layer makes up about 15 percent, and a second skin layer makes up about 15 percent of the thickness of the multilayer film structure.

In some embodiments, the multilayer film structure has a thickness of at most 250 μm. In some embodiments, the multilayer film structure has a thickness of at most 80 μm. In some embodiments, the multilayer film structure has a thickness of at most 75 μm. In some embodiments, the multilayer film structure has a thickness of at most 70 μm. In some embodiments, the multilayer film structure has a thickness of at most 65 μm. In some embodiments, the multilayer film structure has a thickness of at most 62 μm. In some embodiments, the multilayer film structure has a thickness of at most 60 μm. In some embodiments, the multilayer film structure has a thickness of at most 58 μm.

In some embodiments, the multilayer film structure has a thickness of at least 10 μm. In some embodiments, the multilayer film structure has a thickness of at least 30 μm. In some embodiments, the multilayer film structure has a thickness of at least 35 μm. In some embodiments, the multilayer film structure has a thickness of at least 40 μm. In some embodiments, the multilayer film structure has a thickness of at least 45 μm. In some embodiments, the multilayer film structure has a thickness of at least 50 μm. In some embodiments, the multilayer film structure has a thickness of at least 52 μm. In some embodiments, the multilayer film structure has a thickness of at least 54 μm. In some embodiments, the multilayer film structure has a thickness of at least 56 μm.

In some embodiments, the multilayer film structure has a thickness of between 10 and 250 μm. In some embodiments, the multilayer film structure has a thickness of between 30 and 80 μm. In some embodiments, the multilayer film structure has a thickness of between 35 and 80 μm. In some embodiments, the multilayer film structure has a thickness of between 40 and 80 μm. In some embodiments, the multilayer film structure has a thickness of between 35 and 75 μm. In some embodiments, the multilayer film structure has a thickness of between 40 and 75 μm. In some embodiments, the multilayer film structure has a thickness of between 40 and 70 μm. In some embodiments, the multilayer film structure has a thickness of between 45 and 75 μm. In some embodiments, the multilayer film structure has a thickness of between 45 and 70 μm. In some embodiments, the multilayer film structure has a thickness of between 45 and 65 μm. In some embodiments, the multilayer film structure has a thickness of between 50 and 65 μm. In some embodiments, the multilayer film structure has a thickness of between 54 and 65 μm. In some embodiments, the multilayer film structure has a thickness of between 54 and 60 μm. In some embodiments, the multilayer film structure has a thickness of between 54 and 58 μm. In some embodiments, the multilayer film structure has a thickness of between 56 and 60 μm. In some embodiments, the multilayer film structure has a thickness of between 56 and 58 μm.

In some embodiments, the multilayer film structure has a thickness of about 57 μm (about 2.25 mil).

### Properties of the Multilayer Film Structure

In some embodiments, the multilayer film structure has a dart impact strength of at least 117 g/mil, for example at least 120 g/mil, at least 125 g/mil, at least 135 g/mil, at least 145 g/mil, at least 155 g/mil, at least 165 g/mil, at least 170 g/mil, at least 172 g/mil, or at least 175 g/mil.

In some embodiments, the multilayer film structure has an MD tear of at least 100 g/mil, for example at least 105 g/mil, at least 108 g/mil, at least 115 g/mil, at least 120 g/mil, or at least 125 g/mil.

In some embodiments, the multilayer film structure has a TD tear of at least 350 g/mil, for example at least 400 g/mil, at least 500 g/mil, at least 600 g/mil, at least 700 g/mil, at least 750 g/mil, or at least 800 g/mil.

In some embodiments, when measured at a film thickness of about 57 μm, the multilayer film structure has a 1% MD secant modulus of at least 160 MPa, for example at least 170 MPa, at least 180 MPa, at least 200 MPa, at least 220 MPa, at least 240 MPa, or at least 245 MPa.

In some embodiments, when measured at a film thickness of about 57 μm, the multilayer film structure has a haze value of less than 10%, for example less than 9%, less than 8%, less than 7%, or less than 6%.

In some embodiments, when measured at a film thickness of about 57 μm, the multilayer film structure has a gloss at 45° of at least 70 GU (gloss units), for example at least 74 GU, at least 76 GU, or at least 78 GU.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about”, it will be understood that the particular value forms another embodiment. The term “about” in relation to a numerical value is optional and means, for example, +/−10%.

The following examples are presented for the purpose of illustrating selected embodiments of this disclosure; it being understood that the examples presented do not limit the claims presented.

### EXAMPLES

### General Testing Procedures

Prior to testing, each polymer specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene copolymer composition densities were determined using ASTM D792-13 (Nov. 1, 2013).

### Melt Index

Ethylene copolymer composition melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. Herein, the term “stress exponent”, or its acronym “S.Ex.”, is defined by the following relationship: S.Ex.=log(I₆/I₂)/log(6480/2160) wherein I₆ and I₂ are the melt flow rates measured at 190° C. using 6.48 kg and 2.16 kg loads, respectively.

### Conventional Size Exclusion Chromatography (SEC)

Ethylene copolymer composition samples (polymer) solutions (1 to 3 mg/mL) were prepared by heating the polymer in 1,2,4-trichlorobenzene (TCB) and rotating on a wheel for 4 hours at 150° C. in an oven. An antioxidant (2,6-di-tert-butyl-4-methylphenol (BHT)) was added to the mixture in order to stabilize the polymer against oxidative degradation. The BHT concentration was 250 ppm. Polymer solutions were chromatographed at 140° C. on a PL 220 high-temperature chromatography unit equipped with four Shodex columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC columns were calibrated with narrow distribution polystyrene standards. The polystyrene molecular weights were converted to polyethylene molecular weights using the Mark-Houwink equation, as described in the ASTM standard test method D6474-12 (December 2012). The GPC raw data were processed with the CIRRUS® GPC software, to produce molar mass averages (Mₙ, M_{w}, M_{z}) and molar mass distribution (e.g. Polydispersity, M_{w}/Mₙ). In the polyethylene art, a commonly used term that is equivalent to SEC is GPC, i.e. Gel Permeation Chromatography.

### Triple Detection Size Exclusion Chromatography (3D-SEC)

Ethylene copolymer composition samples (polymer) solutions (1 to 3 mg/mL) were prepared by heating the polymer in 1,2,4-trichlorobenzene (TCB) and rotating on a wheel for 4 hours at 150° C. in an oven. An antioxidant (2,6-di-tert-butyl-4-methylphenol (BHT)) was added to the mixture in order to stabilize the polymer against oxidative degradation. The BHT concentration was 250 ppm. Sample solutions were chromatographed at 140° C. on a PL 220 high-temperature chromatography unit equipped with a differential refractive index (DRI) detector, a dual-angle light scattering detector (15 and 90 degree) and a differential viscometer. The SEC columns used were either four Shodex columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 μL. The SEC raw data were processed with the CIRRUS GPC software, to produce absolute molar masses and intrinsic viscosity ([η]). The term “absolute” molar mass was used to distinguish 3D-SEC determined absolute molar masses from the molar masses determined by conventional SEC. The viscosity average molar mass (Mv) determined by 3D-SEC was used in the calculations to determine the Long Chain Branching Factor (LCBF).

### GPC-FTIR

Ethylene copolymer composition (polymer) solutions (2 to 4 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a Waters GPC 150C chromatography unit equipped with four Shodex columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS FTIR software and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e. methyl end groups. Thus, the raw GPC-FTIR data must be corrected by subtracting the contribution from methyl end groups. To be more clear, the raw GPC-FTIR data overestimates the amount of short chain branching (SCB) and this overestimation increases as molecular weight (M) decreases. In this disclosure, raw GPC-FTIR data was corrected using the 2-methyl correction. At a given molecular weight (M), the number of methyl end groups (NE) was calculated using the following equation; N_{E}=28000/M, and NE (M dependent) was subtracted from the raw GPC-FTIR data to produce the SCB/1000C (2-Methyl Corrected) GPC-FTIR data.

### CRYSTAF/TREF (CTREF)

The “Composition Distribution Breadth Index”, hereinafter CDBI, of the ethylene copolymer compositions (and Comparative Examples) was measured using a CRYSTAF/TREF 200+ unit equipped with an IR detector, hereinafter the CTREF. The acronym “TREF” refers to Temperature Rising Elution Fractionation. The CTREF was supplied by Polymer Char S.A. (Valencia Technology Park, Gustave Eiffel, 8, Paterna, E-46980 Valencia, Spain). The CTREF was operated in the TREF mode, which generates the chemical composition of the polymer sample as a function of elution temperature, the Co/Ho ratio (Copolymer/Homopolymer ratio) and the CDBI (the Composition Distribution Breadth Index), i.e. CDBI₅₀ and CDBI₂₅.

A polymer sample (80 to 100 mg) was placed into the reactor vessel of the CTREF. The reactor vessel was filled with 35 ml of 1,2,4-trichlorobenzene (TCB) and the polymer was dissolved by heating the solution to 150° C. for 2 hours. An aliquot (1.5 mL) of the solution was then loaded into the CTREF column which was packed with stainless steel beads. The column, loaded with sample, was allowed to stabilize at 110° C. for 45 minutes. The polymer was then crystallized from solution, within the column, by dropping the temperature to 30° C. at a cooling rate of 0.09° C./minute. The column was then equilibrated for 30 minutes at 30° C. The crystallized polymer was then eluted from the column with TCB flowing through the column at 0.75 mL/minute, while the column was slowly heated from 30° C. to 120° C. at a heating rate of 0.25° C./minute. The raw CTREF data were processed using Polymer Char software, an Excel spreadsheet and CTREF software developed in-house.

CDBI₅₀ was defined as the percent of polymer whose composition is within 50% of the median comonomer composition; CDBI₅₀ was calculated from the composition distribution cure and the normalized cumulative integral of the composition distribution curve, as described in U.S. Pat. No. 5,376,439. Those skilled in the art will understand that a calibration curve is required to convert a CTREF elution temperature to comonomer content, i.e. the amount of comonomer in the ethylene/α-olefin polymer fraction that elutes at a specific temperature. The generation of such calibration curves are described in the prior art, e.g. Wild, et al., J. Polym. Sci., Part B, Polym. Phys., Vol. 20 (3), pages 441-455: hereby fully incorporated by reference.

The CTREF procedures described above are also used to determine the modality of a TREF profile, the temperatures or temperatures ranges where elution intensity maxima (elution peaks) occur, and the weight percent (wt %) of the ethylene copolymer composition which elutes at a temperature of from 90° C. to 105° C. (i.e. the integrated area of the fraction, in weight percent, of the ethylene copolymer composition which elutes at from 90° C. to 105° C. in a CTREF analysis).

### Neutron Activation (Elemental Analysis)

Neutron Activation Analysis, hereinafter N.A.A., was used to determine catalyst metal residues in ethylene copolymer compositions as follows. A radiation vial (composed of ultrapure polyethylene, 7 mL internal volume) was filled with an ethylene copolymer composition sample and the sample weight was recorded. Using a pneumatic transfer system the sample was placed inside a SLOWPOKE™ nuclear reactor (Atomic Energy of Canada Limited, Ottawa, Ontario, Canada) and irradiated for 30 to 600 seconds for short half-life elements (e.g., Ti, V, Al, Mg, and Cl) or 3 to 5 hours for long half-life elements (e.g. Zr, Hf, Cr, Fe and Ni). The average thermal neutron flux within the reactor was 5×10¹¹/cm²/s. After irradiation, samples were withdrawn from the reactor and aged, allowing the radioactivity to decay; short half-life elements were aged for 300 seconds or long half-life elements were aged for several days. After aging, the gamma-ray spectrum of the sample was recorded using a germanium semiconductor gamma-ray detector (Ortec model GEM55185, Advanced Measurement Technology Inc., Oak Ridge, TN, USA) and a multichannel analyzer (Ortec model DSPEC Pro). The amount of each element in the sample was calculated from the gamma-ray spectrum and recorded in parts per million relative to the total weight of the ethylene copolymer composition sample. The N.A.A. system was calibrated with Specpure standards (1000 ppm solutions of the desired element (greater than 99% pure)). One mL of solutions (elements of interest) were pipetted onto a 15 mm×800 mm rectangular paper filter and air dried. The filter paper was then placed in a 1.4 mL polyethylene irradiation vial and analyzed by the N.A.A. system. Standards are used to determine the sensitivity of the N.A.A. procedure (in counts/μg).

### Unsaturation

The quantity of unsaturated groups, i.e. double bonds, in an ethylene copolymer composition was determined according to ASTM D3124-98 (vinylidene unsaturation, published March 2011) and ASTM D6248-98 (vinyl and trans unsaturation, published July 2012). An ethylene copolymer composition sample was: (a) first subjected to a carbon disulfide extraction to remove additives that may interfere with the analysis; (b) the sample (pellet, film or granular form) was pressed into a plaque of uniform thickness (0.5 mm); and (c) the plaque was analyzed by FTIR.

### Comonomer Content: Fourier Transform Infrared (FTIR) Spectroscopy

The quantity of comonomer in an ethylene copolymer composition was determined by FTIR and reported as the Short Chain Branching (SCB) content having dimensions of CH₃#/1000C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### ¹³C Nuclear Magnetic Resonance (NMR)

Between 0.21 and 0.30 g of polymer sample was weighed into 10 mm NMR tubes. The sample was then dissolved with deuterated ortho-dichlorobenzene (ODCB-d4) and heated to 125° C.; a heat gun was used to assist the mixing process. ¹³C NMR spectra (24000 scans per spectra) were collected on a Bruker AVANCE III HD 400 MHZ NMR spectrometer fitted with a 10 mm PABBO probehead maintained at 125° C. Chemical shifts were referenced to the polymer backbone resonance, which was assigned a value of 30.0 ppm. ¹³C spectra were processed using exponential multiplication with a line broadening (LB) factor of 1.0 Hz. They were also processed using Gaussian multiplication with LB=−0.5 Hz and GB=0.2 to enhance resolution.

Differential Scanning calorimetry (DSC)

Primary melting peak (C), melting peak temperatures (° C.), heat of fusion (J/g) and crystallinity (%) were determined using differential scanning calorimetry (DSC) as follows: the instrument was first calibrated with indium; after the calibration, a polymer specimen was equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The DSC Tm, heat of fusion and crystallinity are reported from the 2^{nd} heating cycle.

### Dynamic Mechanical Analysis (DMA)

Oscillatory shear measurements under small strain amplitudes were carried out to obtain linear viscoelastic functions at 190° C. under N₂ atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 μm and a diameter of 25 mm. In this experiment a sinusoidal strain wave was applied and the stress response was analyzed in terms of linear viscoelastic functions. The zero shear rate viscosity (no) based on the DMA frequency sweep results was predicted by Ellis model (see R. B. Bird et al. “Dynamics of Polymer Liquids. Volume 1: Fluid Mechanics” Wiley-Interscience Publications (1987) p. 228) or Carreau-Yasuda model (see K. Yasuda (1979) PhD Thesis, IT Cambridge). In this disclosure, the LCBF (Long Chain Branching Factor) was determined using the DMA determined no.

### Melt Strength

The melt strength is measured on Rosand RH-7 capillary rheometer (barrel diameter=15 mm) with a flat die of 2-mm Diameter, L/D ratio 10:1 at 190° C. Pressure Transducer: 10,000 psi (68.95 MPa). Piston Speed: 5.33 mm/min. Haul-off Angle: 52°. Haul-off incremental speed: 50-80 m/min² or 65+15 m/min². A polymer melt is extruded through a capillary die under a constant rate and then the polymer strand is drawn at an increasing haul-off speed until it ruptures. The maximum steady value of the force in the plateau region of a force versus time curve is defined as the melt strength for the polymer.

### Film Dart Impact

Film dart impact strength was determined using ASTM D1709-09 Method A (May 1, 2009). In this disclosure the dart impact test employed a 1.5 inch (38 mm) diameter hemispherical headed dart.

### Film Tensile

The following film tensile properties were determined using ASTM D882-12 (Aug. 1, 2012): tensile break strength (MPa), elongation at break (%), tensile yield strength (MPa), tensile elongation at yield (%) and film toughness or total energy to break (ft-lb/in³). Tensile properties were measured in the both the machine direction (MD) and the transverse direction (TD) of the blown films.

### Film Secant Modulus

The secant modulus is a measure of film stiffness. The secant modulus is the slope of a line drawn between two points on the stress-strain curve, i.e. the secant line. The first point on the stress-strain curve is the origin, i.e. the point that corresponds to the origin (the point of zero percent strain and zero stress), and; the second point on the stress-strain curve is the point that corresponds to a strain of 1%; given these two points the 1% secant modulus is calculated and is expressed in terms of force per unit area (MPa). The 2% secant modulus is calculated similarly. This method is used to calculated film modulus because the stress-strain relationship of polyethylene does not follow Hook's law; i.e. the stress-strain behavior of polyethylene is non-linear due to its viscoelastic nature. Secant moduli were measured using a conventional Instron tensile tester equipped with a 200 lbf load cell. Strips of monolayer film samples were cut for testing with following dimensions: 14 inch long, 1 inch wide and 2.25 mil thick; ensuring that there were no nicks or cuts on the edges of the samples. Film samples were cut in both the machine direction (MD) and the transverse direction (TD) and tested. ASTM conditions were used to condition the samples. The thickness of each film was accurately measured with a hand-held micrometer and entered along with the sample name into the Instron software. Samples were loaded in the Instron with a grip separation of 10 inch and pulled at a rate of 1 inch/min generating the strain-strain curve. The 1% and 2% secant modulus were calculated using the Instron software.

### Film Puncture-Propagation Tear

Puncture-propagation tear resistance of blown film was determined using ASTM D2582-09 (May 1, 2009). This test measures the resistance of a blown film to snagging, or more precisely, to dynamic puncture and propagation of that puncture resulting in a tear. Puncture-propagation tear resistance was measured in the machine direction (MD) and the transverse direction (TD) of the blown films.

### Film Elmendorf Tear

Film tear performance was determined by ASTM D1922-09 (May 1, 2009); an equivalent term for tear is “Elmendorf tear”. Film tear was measured in both the machine direction (MD) and the transverse direction (TD) of the blown films.

### Film Opticals

Film optical properties were measured as follows: Haze, ASTM D1003-13 (Nov. 15, 2013); and Gloss ASTM D2457-13 (Apr. 1, 2013).

### Film Dynatup Impact

Instrumented impact testing was carried out on a machine called a DYNATUP® Impact Tester purchased from Illinois Test Works Inc., Santa Barbara, CA, USA; those skilled in the art frequently call this test the DYNATUP impact test. Testing was completed according to the following procedure. Test samples are prepared by cutting about 5 inch (12.7 cm) wide and about 6 inch (15.2 cm) long strips from a roll of blown film; film was about 2.25 mil thick. Prior to testing, the thickness of each sample was accurately measured with a handheld micrometer and recorded. ASTM conditions were employed. Test samples were mounted in the 9250 DYNATUP Impact drop tower/test machine using the pneumatic clamp. DYNATUP tup #1, 0.5 inch (1.3 cm) diameter, was attached to the crosshead using the Allen bolt supplied. Prior to testing, the crosshead is raised to a height such that the film impact velocity is 10.9+0.1 ft/s. A weight was added to the crosshead such that: 1) the crosshead slowdown, or tup slowdown, was no more than 20% from the beginning of the test to the point of peak load and 2) the tup must penetrate through the specimen. If the tup does not penetrate through the film, additional weight is added to the crosshead to increase the striking velocity. During each test the DYNATUP Impulse Data Acquisition System Software collected the experimental data (load (lb) versus time). At least 5 film samples are tested and the software reports the following average values: “DYNATUP Maximum (Max) Load (lb)”, the highest load measured during the impact test; “DYNATUP Total Energy (ft. lb)”, the area under the load curve from the start of the test to the end of the test (puncture of the sample); and “DYNATUP Total Energy at Max Load (ft-lb)”, the area under the load curve from the start of the test to the maximum load point.

### Long Chain Branching Factor (LCBF)

The LCBF (dimensionless) was determined for the ethylene copolymer composition using the method described in U.S. Pat. Appl. Pub. No. 2018/0305531 which is incorporated herein by reference.

### Ethylene Copolymer Compositions

Ethylene copolymer compositions were each made using a mixed dual catalyst system in an “in-series” dual reactor solution polymerization process. As a result, ethylene copolymer compositions each comprised a first ethylene copolymer made with a single site catalyst and a second ethylene copolymer made with a multi-site catalyst. An “in series” dual reactor, solution phase polymerization process, including one employing a mixed dual catalyst has been described in U.S. Pat. Appl. Pub. No. 2018/0305531. Basically, in an “in-series” dual reactor system the exit stream from a first polymerization reactor (R1) flows directly into a second polymerization reactor (R2).

The R1 pressure was from about 14 MPa to about 18 MPa; while R2 was operated at a lower pressure to facilitate continuous flow from R1 to R2. Both R1 and R2 were continuously stirred reactors (CSTRs) and were agitated to give conditions in which the reactor contents were well mixed. The process was operated continuously by feeding fresh process solvent, ethylene, 1-octene and hydrogen to the reactors and in the removal of product. Methylpentane was used as the process solvent (a commercial blend of methylpentane isomers). The volume of the first CSTR reactor (R1) was 3.2 gallons (12 L), and the volume of the second CSTR reactor (R2) was 5.8 gallons (22 L). Monomer (ethylene) and comonomer (1-octene) were purified prior to addition to the reactor using conventional feed preparation systems (such as contact with various absorption media to remove impurities such as water, oxygen and polar contaminants). The reactor feeds were pumped to the reactors at the ratios shown in Table 1. Average residence times for the reactors are calculated by dividing average flow rates by reactor volume and is primarily influenced by the amount of solvent flowing through each reactor and the total amount of solvent flowing through the solution process.

The following single site catalyst (SSC) components were used to prepare the first ethylene copolymer in a first reactor (R1) configured in series to a second reactor (R2): diphenylmethylene (cyclopentadienyl) (2,7-di-t-butylfluorenyl) hafnium dimethide [(2,7-tBu2Flu) Ph₂C(Cp)HfMe₂]; methylaluminoxane (MMAO-07); trityl tetrakis(pentafluoro-phenyl) borate (trityl borate), and 2,6-di-tert-butyl-4-ethylphenol (BHEB). Methylaluminoxane (MMAO-07) and 2,6-di-tert-butyl-4-ethylphenol are premixed in-line and then combined with diphenylmethylene (cyclopentadienyl)(2,7-di-t-butylfluorenyl) hafnium dimethide and trityl tetrakis(pentafluoro-phenyl) borate just before entering the polymerization reactor (R1). The efficiency of the single site catalyst formulation was optimized by adjusting the mole ratios of the catalyst components and the R1 catalyst inlet temperature.

The following Ziegler-Natta (ZN) catalyst components were used to prepare the second ethylene copolymer in a second reactor (R2) configured in series to a first reactor (R1): butyl ethyl magnesium; tertiary butyl chloride; titanium tetrachloride; diethyl aluminum ethoxide; and triethyl aluminum. Methylpentane was used as the catalyst component solvent and the in-line Ziegler-Natta catalyst formulation was prepared using the following steps and then injected into the second reactor (R2). In step one, a solution of triethylaluminum and butyl ethyl magnesium (Mg:Al=20, mol:mol) was combined with a solution of tertiary butyl chloride and allowed to react for about 30 seconds to produce a MgCl₂ support. In step two, a solution of titanium tetrachloride was added to the mixture formed in step one and allowed to react for about 14 seconds prior to injection into second reactor (R2). The in-line Ziegler-Natta catalyst was activated in the reactor by injecting a solution of diethyl aluminum ethoxide into R2. The quantity of titanium tetrachloride added to the reactor is shown in Table 1. The efficiency of the in-line Ziegler-Natta catalyst formulation was optimized by adjusting the mole ratios of the catalyst components.

Polymerization in the continuous solution polymerization process was terminated by adding a catalyst deactivator to the second reactor exit stream. The catalyst deactivator used was octanoic acid (caprylic acid), commercially available from P&G Chemicals, Cincinnati, OH, U.S.A. The catalyst deactivator was added such that the moles of fatty acid added were 50% of the total molar amount of hafnium, titanium and aluminum added to the polymerization process; to be clear, the moles of octanoic acid added=0.5×(moles hafnium+moles titanium+moles aluminum).

A two-stage devolatilization process was employed to recover the ethylene copolymer composition from the process solvent, i.e. two vapor/liquid separators were used and the second bottom stream (from the second V/L separator) was passed through a gear pump/pelletizer combination. DHT-4V (hydrotalcite), supplied by Kyowa Chemical Industry Co. LTD, Tokyo, Japan was used as a passivator, or acid scavenger, in the continuous solution process. A slurry of DHT-4V in process solvent was added prior to the first V/L separator. The molar amount of DHT-4V added was 10-fold higher than the molar amount of tertiary butyl chloride and titanium tetrachloride added to the solution process.

Prior to pelletization the ethylene copolymer composition was stabilized by adding 500 ppm of IRGANOX® 1076 (a primary antioxidant) and 500 ppm of IRGAFOS® 168 (a secondary antioxidant), based on weight of the ethylene copolymer composition. Antioxidants were dissolved in process solvent and added between the first and second V/L separators.

Table 1 shows the reactor conditions used to make each of the inventive ethylene copolymer compositions. Table 1 includes process parameters, such as the ethylene and 1-octene splits between the reactors (R1 and R2), the reactor temperatures, the ethylene conversions, etc.

The properties of ethylene copolymer compositions comprised in inventive polymer blends (Inventive Examples 1 to 3), as well as those for several comparative resins (Comparative Examples 1 to 5 and 11) are shown in Table 2. Comparative Example 1 is EXCEED® 1018HA, a resin commercially available from ExxonMobil. Comparative Example 2 is INNATE® ST50, a resin commercially available from the Dow Chemical Company. Comparative Example 3 is ELITE® 5401G, a resin commercially available from the Dow Chemical Company. Comparative Example 4 is EX-FP034-C01, an ethylene/1-octene copolymer produced in a commercial scale single-reactor solution phase polymerization process, using a Ziegler-Natta catalyst at a target density of 0.934 g/cm³ and a target melt index of 0.55 g/10 min. Comparative Example 5 is TF-Y534-IP, a resin commercially available from the NOVA Chemicals Corporation.

Also described herein are the comparative resins of Comparative Examples 6 to 8. Comparative Example 6 is ELITE 5100, a resin commercially available from the Dow Chemical Company. Comparative Example 7 is ELITE 5400G, a resin commercially available from the Dow Chemical Company. Comparative Example 8 is ELITE 5500, a resin commercially available from the Dow Chemical Company.

Inventive Examples 1 to 3 and Comparative Examples 2 to 4, 6 to 8 and 11 are ethylene/1-octene copolymers. Comparative Examples 1 and 5 are ethylene/1-hexene copolymers. Comparative Examples 2, 3 and 6 to 8 are believed to be produced in a solution polymerization process, employing a single site catalyst formulation and a Ziegler-Natta catalyst formulation. Comparative Example 1 is believed to be produced in a gas-phase polymerization process. Comparative Example 5 is produced in a gas-phase polymerization process.

As can be seen in Table 2, the inventive compositions have higher amounts of long chain branching, indicated by greater network parameter (Δ_{int.}) and LCBF values, as discussed further below.

Details of the inventive ethylene copolymer composition components (the first ethylene copolymer and the second ethylene copolymer) are provided in Table 3, together with the composition components of Comparative Example 11. The ethylene copolymer composition component properties shown in Table 3 were determined using a combination of CTREF analytical methods and calculations from a Polymerization Process Model (e.g. for the determination of SCB1, SCB2, d1 and d2 [also known as ρ¹ and ρ²], wt1 and wt2, Mw1, Mw2, Mn1, Mn2, I₂¹ and I₂²).

### Polymerization Process Model

For multicomponent (or bimodal resins) polyethylene polymers, the M_{w}, Mₙ, and M_{w}/Mₙ were calculated herein, by using a reactor model simulation using the input conditions which were employed for actual pilot scale run conditions (for references on relevant reactor modeling methods, see “Copolymerization” by A. Hamielec, J. MacGregor, and A. Penlidis in Comprehensive Polymer Science and Supplements, volume 3, Chapter 2, page 17, Elsevier, 1996 and “Copolymerization of Olefins in a Series of Continuous Stirred-Tank Slurry-Reactors using Heterogeneous Ziegler-Natta and Metallocene Catalysts. I. General Dynamic Mathematical Model” by J. B. P. Soares and A. E. Hamielec in Polymer Reaction Engineering, 4 (2&3), p153, 1996).

The model takes for input the flow of several reactive species (e.g. catalyst, monomer such as ethylene, comonomer such as 1-octene, hydrogen, and solvent) going to each reactor, the temperature (in each reactor), and the conversion of monomer (in each reactor), and calculates the polymer properties (of the polymer made in each reactor, i.e., the first and second ethylene copolymers) using a terminal kinetic model for continuously stirred tank reactors (CSTRs) connected in series. The “terminal kinetic model” assumes that the kinetics depend upon the monomer unit within the polymer chain on which the active catalyst site is located (see “Copolymerization” by A. Hamielec, J. MacGregor, and A. Penlidis in Comprehensive Polymer Science and Supplements, Volume 3, Chapter 2, page 17, Elsevier, 1996). In the model, the copolymer chains are assumed to be of reasonably large molecular weight to ensure that the statistics of monomer/comonomer unit insertion at the active catalyst center is valid and that monomers/comonomers consumed in routes other than propagation are negligible. This is known as the “long chain” approximation.

The terminal kinetic model for polymerization includes reaction rate equations for activation, initiation, propagation, chain transfer, and deactivation pathways. This model solves the steady-state conservation equations (e.g., the total mass balance and heat balance) for the reactive fluid which comprises the reactive species identified above.

The total mass balance for a generic CSTR with a given number of inlets and outlets is given by:

$$0 = {\sum }_{i} {\dot{m}}_{i} \qquad ( 1 )$$

where \hat{m}ᵢ represents the mass flow rate of individual streams with index i indicating the inlet and outlet streams.

Equation (1) can be further expanded to show the individual species and reactions:

$$0 = \frac{{\sum }_{i}^{m {\dot{x}}_{ij}} / {M}_{i}}{{ρ}_{mix} V} + {R}_{j} / {ρ}_{mix} \qquad ( 2 )$$

where Mᵢ is the average molar weight of the fluid inlet or outlet (i), xᵢⱼ is the mass fraction of species j in stream i, ρₘᵢₓ is the molar density of the reactor mixture, V is the reactor volume, Rⱼ is the reaction rate for species j, which has units of kmol/m³s.

The total heat balance is solved for an adiabatic reactor and is given by:

$$0 = ( \sum {\dot{m}}_{i} Δ {H}_{i} + {q}_{R x} V + \dot{W} - \dot{Q} ) \qquad ( 3 )$$

where, \dot{m}ᵢ is the mass flow rate of stream i (inlet or outlet), ΔHᵢ is the difference in enthalpy of stream i versus a reference state, q_{Rx} is the heat released by reaction(s), Vis the reactor volume, \dot{W} is the work input (i.e., agitator), \dot{Q} is the heat input/loss.

The catalyst concentration input to each reactor is adjusted to match the experimentally determined ethylene conversion and reactor temperature values in order solve the equations of the kinetic model (e.g., propagation rates, heat balance and mass balance).

The H₂ concentration input to each reactor may be likewise adjusted so that the calculated molecular weight distribution of a polymer made over both reactors (and, hence, the molecular weight of polymer made in each reactor) matches that which is observed experimentally.

The weight fraction, wt1 and wt2 of material made in each reactor, R1 and R2, is determined from knowing the mass flow of monomer and comonomer into each reactor along with knowing the conversions for monomer and comonomer in each reactor calculated based on kinetic reactions.

The degree of polymerization (dpₙ) for a polymerization reaction is given by the ratio of the rate of chain propagation reactions over the rate of chain transfer/termination reactions:

$${dp}_{n} = \frac{( {k}_{p 11} {ϕ}_{1} [ {m}_{1} ] + {k}_{p 12} {ϕ}_{1} [ {m}_{2} ] + {k}_{p 21} {ϕ}_{2} [ {m}_{2} ] )}{\begin{matrix}{k}_{tm 11} [ {m}_{1} ] {ϕ}_{1} + {k}_{tm 12} [ {m}_{2} ] {ϕ}_{1} + {k}_{tm 21} [ {m}_{2} ] {ϕ}_{2} + \\ {k}_{ts 1} {ϕ}_{1} + {k}_{ts 2} {ϕ}_{2} + {k}_{tH 1} [ H ] + {k}_{tH 2} [ H ]\end{matrix}} = \frac{{R}_{p}}{{R}_{t}} \qquad ( 4 )$$

where kₚ₁₂ is the propagation rate constant for adding monomer 2 to a growing polymer chain ending with monomer 1, [m₁] is the molar concentration of monomer 1 (ethylene) in the reactor, [m₂] is the molar concentration of monomer 2 (1-octene) in the reactor, kₜₘ₁₂ the termination rate constant for chain transfer to monomer 2 for a growing chain ending with monomer 1, Kₜₛ₁ is rate constant for the spontaneous chain termination for a chain ending with monomer 1, k_{tH1} is the rate constant for the chain termination by hydrogen for a chain ending with monomer 1. ϕ₁ and ϕ₂ and the fraction of catalyst sites occupied by a chain ending with monomer 1 or monomer 2 respectively.

The number average molecular weight (Mₙ) for a polymer follows from the degree of polymerization and the molecular weight of a monomer unit. From the number average molecular weight of polymer in a given reactor, and assuming a Flory-Schulz distribution for a single site catalyst, the molecular weight distribution is determined for the polymer using the following relationships.

$$w ( n ) = n {τ}^{2} {e}^{- τ n} \qquad ( 5 )$$

where n is the number of monomer units in a polymer chain, w(n) is the weight fraction of polymer chains having a chain length n, and τ is calculated using the equation:

$$τ = \frac{1}{{dp}_{n}} = \frac{{R}_{t}}{{R}_{p}}$$

where dpₙ is the degree of polymerization, Rₚ is the rate of propagation and Rₜ is the rate of termination.

The Flory-Schulz distribution can be transformed into the common log scaled GPC trace by applying:

$$\frac{dW}{d log ( M )} = ln ( 10 ) \frac{{n}^{2}}{{dp}_{n} 2} {e}^{( - \frac{n}{{dp}_{n}} )} \qquad ( 6 )$$

where

$$\frac{d W}{d log ( MW )}$$

is the differential weight fraction of polymer with a chain length n (n=MW/28 where 28 is the molecular weight of the polymer segment corresponding to a C₂H₄ unit) and dpₙ is the degree of polymerization.

Assuming a Flory-Schultz model, different moments of molecular weight distribution can be calculated using the following:

$${μ}_{i} = {\int }_{0}^{∞} {n}^{i} W ( n ) dn$$

$$thus ,$$

$${μ}_{0} = 1 ,$$

$${μ}_{1} = {dp}_{n} , and$$

$${μ}_{2} = 2 {dp}_{n}^{2} ;$$

$$so ,$$

$${M}_{n} = {Mw}_{monomer} \frac{{μ}_{1}}{{μ}_{0}} = {Mw}_{monomer} {dp}_{n}$$

$${M}_{w} = {Mw}_{monomer} \frac{{μ}_{2}}{{μ}_{1}} = 2 {Mw}_{monomer} {dp}_{n}$$

where Mwₘₒₙₒₘₑᵣ is the molecular weight of the polymer segment corresponding to a C₂H₄ unit of monomer.

Alternatively, when a Ziegler-Natta catalyst is employed, the molecular weight distribution of the polymer made in a given reactor by a Ziegler-Natta catalyst, can be modeled as above but using the sum of four such single site catalyst sites, each of which is assumed to have a Flory-Schultz distribution. When considering the kinetics of the process model for a Ziegler-Natta catalyst, the total amount of the Ziegler-Natta catalyst components fed to a reactor are known, and it is assumed that there is the same weight fraction of each of the four active catalyst sites modeled, but where each site has its own kinetics.

Finally, when a single site catalyst produces long chain branching, the molecular weight distribution is determined for the polymer using the following relationships (see “Polyolefins with Long Chain Branches Made with Single-Site Coordination Catalysts: A Review of Mathematical Modeling Techniques for Polymer Microstructure” by J. B. P. Soares in Macromolecular Materials and Engineering, volume 289, issue 1, pages 70-87, Wiley-VCH, 2004 and “Polyolefin Reaction Engineering” by J. B. P. Soares and T. F. L. McKenna, Wiley-VCH, 2012).

$$w ( n ) = \frac{( 1 - α ) {τ}_{B} {e}^{- {τ}_{B} n}}{( 1 + α )} {I}_{1} ( 2 \frac{{τ}_{B} n \sqrt{α}}{1 + α} )$$

where n is the number of monomer units in a polymer chain, w(n) is the weight fraction of polymer chains having a chain length n, and τ_{B} and α are calculated using equations below:

$${τ}_{B} = \frac{1}{{dp}_{n}^{B}} = \frac{{R}_{t} + {R}_{LCB}}{{R}_{p}}$$

$$α = \frac{{R}_{LCB}}{{R}_{p}}$$

where

$${dp}_{n}^{B}$$

is degree of polymerization, Rₚ is the rate propagation, Rₜ is the rate of termination and R_{LCB} is the rate of long chain branching formation calculated using equation below:

$${R}_{LCB} = {k}_{p 13} {ϕ}_{1} [ {m}_{3} ]$$

where kₚ₁₃ is the propagation rate constant for adding monomer 3 (macromonomer which is formed in the reactor) to a growing polymer chain ending with monomer 1, [m₃] is the molar concentration of macromonomer in the reactor.
The weight distribution can be transformed into the common log scaled GPC trace by applying:

$$\frac{dW}{d log ( M )} = ln ( 10 ) \frac{( 1 - α ) {τ}_{B} {e}^{- {τ}_{B} n}}{( 1 + α ) \sqrt{α}} {I}_{1} ( 2 \frac{{τ}_{B} n \sqrt{α}}{1 + α} ) \qquad ( 7 )$$

where

$$\frac{dW}{d log ( MW )}$$

is the differential weight fraction of polymer with a chain length n (n=MW/28 where 28 is the molecular weight of the polymer segment corresponding to a C₂H₄ unit).

From the weight distribution, different moments of molecular weight distribution can be calculated using the following:

$${M}_{n} = {Mw}_{monomer} {dp}_{n}^{B} \frac{1 + α}{1 - α}$$

$${M}_{w} = 2 {Mw}_{monomer} {dp}_{n}^{B} \frac{1 + α}{{( 1 - α )}^{2}}$$

where

$${dp}_{n}^{B}$$

is degree of polymerization, and α is calculated as above.

The short chain branch frequency of the second ethylene copolymer is calculated based on kinetic equations and co-monomer consumption using the following equation:

$$BF = \frac{{R}_{BF}}{{R}_{p}} = ( \frac{SCB 2}{1000 C} ) \qquad ( 8 )$$

where R_{BF} is the rate of short chain branching formation calculated using the equation:

$${R}_{BF} = {k}_{p 21} {ϕ}_{2} [ {m}_{1} ] + {k}_{p 22} {ϕ}_{2} [ {m}_{2} ] + {k}_{tm 12} {ϕ}_{1} [ {m}_{2} ] + {k}_{tm 22} {ϕ}_{2} [ {m}_{2} ]$$

The short chain branch frequency of the first ethylene copolymer is estimated using the following equation:

$${SCB}_{1} = ( SCB - {w}_{2} {SCB}_{2} ) / {w}_{1} \qquad ( 9 )$$

where the SCB₁, SCB₂ and SCB are the short chain branches per 1000 carbons of the first ethylene copolymer, the second ethylene copolymer (as determined above) and the overall experimentally determined short chain branching frequency for the polyethylene composition (i.e. as determined by FTIR analysis) respectively, and where w₁ and w₂ represent the respective weight fractions of the first and second ethylene copolymer components.

TABLE 1
Reactor Operating Conditions

| Example No. | Inv. 1 | Inv. 2 | Comp. 11 | Inv. 3 |
|---|---|---|---|---|
| Total Solution Rate [TSR] (kg/h) | 550 | 550 | 550 | 550 |
| Ethylene Concentration (wt % overall) | 13.0 | 15.4 | 15.5 | 16.0 |
| Ethylene Split Between Reactors | 45.0 | 45.0 | 45.0 | 45.0 |
| [R1/(R1 + R2)] | | | | |
| 1-Octene/ethylene (wt %) [total] | 0.560 | 0.432 | 0.378 | 0.150 |
| 1-Octene Split Between Reactors | 0.23 | 0.22 | 0.50 | 0.26 |
| [R1/(R1 + R2)] | | | | |
| Polymer Production Rate (kg/h) | 63.4 | 84.9 | 83.6 | 82.0 |
| [by near infrared] | | | | |
| Reactor 1 (R1) | | | | |
| Total Solution Rate in R1 (kg/h) | 266 | 304 | 288 | 293 |
| Ethylene Concentration (wt %) in R1 | 12.1 | 12.5 | 13.3 | 13.5 |
| 1-Octene/ethylene in Fresh Feed (g/g) | 0.31 | 0.23 | 0.46 | 0.09 |
| Primary Feed Inlet Temperature in R1 (° C.) | 35.0 | 35.0 | 25.0 | 25.0 |
| R1 Control Temperature (° C.) | 167.0 | 172.4 | 169.2 | 172.2 |
| Ethylene Conversion in R1 (%) | 80.02 | 81.95 | 77.99 | 81.95 |
| [by near infrared] | | | | |
| Hydrogen Feed (ppm) | 3.00 | 2.20 | 3.64 | 2.86 |
| Single Site Catalyst (ppm) to R1 | 0.43 | 0.43 | 0.46 | 0.27 |
| SSC - Al/Hf (mol/mol) | 30.0 | 30.1 | 30.1 | 30.1 |
| SSC - BHEB/Al (mol/mol) | 0.41 | 0.21 | 0.49 | 0.20 |
| SSC - B/Hf (mol/mol) | 1.20 | 1.21 | 1.20 | 1.21 |
| R1 Diluent Temperature (° C.) | 28.6 | 24.2 | 21.2 | 23.8 |
| Reactor 2 (R2) | | | | |
| Total Solution Rate in R2 (kg/h) | 284 | 246 | 262 | 256 |
| Ethylene Fresh Feed to R2 Concentration (wt %) | 13.8 | 19.0 | 17.9 | 18.9 |
| 1-Octene/ethylene in Fresh Feed (g/g) | 0.50 | 0.50 | 0.49 | 0.50 |
| Primary Feed Temperature in R2 (° C.) | 40.0 | 25.0 | 24.9 | 25.1 |
| R2 Control Temperature (° C.) | 189.4 | 209.3 | 207.1 | 209.9 |
| Ethylene Conversion in R2 (%) | 82.27 | 82.75 | 83.11 | 82.96 |
| [by near infrared] | | | | |
| Hydrogen Feed (ppm) | 0.50 | 2.00 | 4.38 | 9.42 |
| Multi-Site Catalyst (Ti ppm) to R2 | 3.89 | 4.99 | 5.75 | 3.65 |
| ZN - tert-butylchloride/Mg (mol/mol) | 1.52 | 1.98 | 1.50 | 1.98 |
| ZN - diethylaluminium ethoxide/Ti (mol/mol) | 1.35 | 1.35 | 1.35 | 1.35 |
| ZN - Mg/Ti (mol/mol) | 0.35 | 0.37 | 0.37 | 0.37 |
| R2 Diluent Temperature (° C.) | 32.1 | 29.9 | 29.9 | 30.1 |

TABLE 2
Properties of Ethylene Copolymer Compositions

| Example No. | Comp. 1 | Comp. 2 | Comp. 3 | Inv. 1 | Inv. 2 | Comp. 11 |
|---|---|---|---|---|---|---|
| Density (g/cm³) | 0.9187 | 0.9179 | 0.9179 | 0.9180 | 0.9206 | 0.9177 |
| Melt Index I₂ (g/10 min) | 0.91 | 0.84 | 1.01 | 0.5 | 0.63 | 0.81 |
| Melt Index I₆ (g/10 min) | 3.16 | 3.59 | 4.39 | 2.47 | 3.14 | 3.63 |
| Melt Index I₂₁ (g/10 min) | 14.8 | 24.8 | 30.8 | 17 | 22.2 | 24.5 |
| Melt Flow Ratio (I₂₁/I₂) | 15.8 | 29.5 | 30.2 | 33 | 35.6 | 30.8 |
| Stress Exponent | 1.11 | 1.32 | 1.33 | 1.43 | 1.47 | 1.38 |
| Mₙ | 55850 | 35355 | 35904 | 33770 | 36374 | 38009 |
| M_{w} | 110641 | 104729 | 98469 | 111210 | 101729 | 100078 |
| M_{z} | 186289 | 219654 | 214101 | 242371 | 217441 | 196285 |
| Polydispersity Index (M_{w}/Mₙ) | 1.98 | 2.96 | 2.74 | 3.29 | 2.8 | 2.63 |
| CTREF - High Temperature | 93.1 | 95.4 | 95.1 | 95.9 | 95.3 | 95.7 |
| Elution Peak (° C.) | | | | | | |
| CTREF - CDBI₅₀ | 70.8 | 43.4 | 57.1 | 68.7 | 70.8 | 32.1 |
| CTREF - Weight percent | 9.1 | 27.7 | 15.7 | 13.7 | 13.6 | 18.9 |
| Eluting at From 90 to 105° C. | | | | | | |
| Co/Ho—Copolymer to | 10 | 2.6 | 5.4 | 6.3 | 6.4 | 4.3 |
| Homopolymer ratio | | | | | | |
| HD Fraction wt % | 9.1 | 27.7 | 15.7 | 13.7 | 13.6 | 18.9 |
| Primary Melting Peak (° C.) | 109.52 | 93.76 | 102.32 | 103.4 | 109.2 | 121.6 |
| Heat of Fusion (J/g) | 127.0 | 123.59 | 121.31 | 126.8 | 138.0 | 123.8 |
| Crystallinity (%) | 44 | 42.6 | 41.8 | 43.7 | 47.6 | 42.7 |
| Branch Freq/1000 C. | 13.4 | 14.7 | 14.2 | 14.4 | 11.3 | 14.7 |
| Comonomer | 1-hexene | 1-octene | 1-octene | 1-octene | 1-octene | 1-octene |
| Comonomer Content | 2.7 | 2.9 | 2.8 | 2.9 | 2.3 | 2.9 |
| (mole %) | | | | | | |
| Comonomer Content (wt %) | 9.9 | 10.8 | 10.5 | 10.6 | 8.4 | 10.8 |
| Network parameter (Δ_{int.}) | 0.0000 | 0.0466 | 0.0517 | 0.0618 | 0.0655 | 0.0611 |
| Ti (ppm) | <0.100 | 1.650 | 1.952 | 4.672 | 5.341 | 5.316 |
| Hf (ppm) | <0.010 | 0.167 | <0.010 | 0.471 | 0.471 | 0.519 |
| Mean Melt Strength - | 2.45 | 3.94 | 3.9 | 6.86 | 5.97 | 5.04 |
| 190° C. (cN) | | | | | | |
| LCBF | 0.0000 | 0.0049 | 0.0130 | 0.0337 | 0.0461 | 0.0221 |
| Internal Unsaturation/100 C. | 0.002 | 0.004 | 0.004 | 0.007 | 0.007 | 0.006 |
| Side Chain | 0.004 | 0.002 | 0.002 | 0.005 | 0.005 | 0.01 |
| Unsaturation/100 C. | | | | | | |
| Terminal Unsaturation/100 C. | 0.01 | 0.025 | 0.025 | 0.034 | 0.04 | 0.034 |

| Example No. | Comp. 4 | Comp. 5 | Inv. 3 |
|---|---|---|---|
| Density (g/cm³) | 0.9329 | 0.9346 | 0.9332 |
| Melt Index I₂ (g/10 min) | 0.52 | 0.71 | 0.44 |
| Melt Index I₆ (g/10 min) | 2.12 | 2.86 | 2.49 |
| Melt Index I₂₁ (g/10 min) | 13.8 | 17.7 | 18.7 |
| Melt Flow Ratio (I₂₁/I₂) | 27.8 | 25.1 | 41.5 |
| Stress Exponent | 1.33 | 1.27 | 1.56 |
| Mₙ | 43585 | 32343 | 37597 |
| M_{w} | 126065 | 127321 | 109166 |
| M_{z} | 324777 | 396274 | 237368 |
| Polydispersity Index (M_{w}/Mₙ) | 2.89 | 3.94 | 2.9 |
| CTREF - High Temperature | 95.1 | 96.6 | 94.9 |
| Elution Peak (° C.) | | | |
| CTREF - CDBI₅₀ | 72.4 | 43.2 | 77 |
| CTREF - Weight Percent | 65.7 | 58.3 | 38.9 |
| Eluting at from 90 to 105° C. | | | |
| Co/Ho—Copolymer to | 0.5 | 0.7 | 1.6 |
| homopolymer ratio | | | |
| HD Fraction wt % | 65.7 | 58.3 | 38.9 |
| Primary Melting Peak (° C.) | 123.85 | 126.53 | 124 |
| Heat of Fusion (J/g) | 167.1 | 165.7 | 168.5 |
| Crystallinity (%) | 58 | 57.1 | 58.1 |
| Branch Freq/1000 C. | 4.3 | 6 | 5.1 |
| Comonomer | 1-octene | 1-hexene | 1-octene |
| Comonomer Content | 0.9 | 1.2 | 1 |
| (mole %) | | | |
| Comonomer Content (wt %) | 3.4 | 3.5 | 3.9 |
| Network parameter (Δ_{int.}) | <0.0100 | <0.0100 | 0.0705 |
| Ti (ppm) | 7.373 | 0.981 | 4.425 |
| Hf (ppm) | <0.010 | <0.010 | 0.215 |
| Mean Melt Strength - | 6.08 | 3.91 | 6.83 |
| 190° C. (cN) | | | |
| LCBF | 0.0000 | 0.0002 | 0.1136 |
| Internal Unsaturation/100 C. | 0.003 | 0 | 0.005 |
| Side Chain | 0.003 | 0.003 | 0.003 |
| Unsaturation/100 C. | | | |
| Terminal Unsaturation/100 C. | 0.048 | 0.017 | 0.044 |

TABLE 3
Properties of Components of Ethylene Copolymer Compositions

| Example No. | Inv. 1 | Inv. 2 | Comp. 11 | Inv. 3 |
|---|---|---|---|---|
| The First Ethylene Copolymer | | | | |
| Catalyst Type 1 | Single Site | Single Site | Single Site | Single Site |
| | Catalyst | Catalyst | Catalyst | Catalyst |
| Weight Fraction [wt¹] (wt %) | 0.42 | 0.42 | 0.42 | 0.43 |
| I₂¹ (g/10 min) | 0.39 ^{c} | 0.40 ^{c} | 0.47 ^{c} | 0.22 ^{c} |
| ρ₁ (g/cm³) | 0.9096 ^{a} | 0.9168 ^{a} | 0.9047 ^{a} | 0.9269 ^{a} |
| Mn1 | 62414 | 61626 | 60097 | 71321 |
| Mw1 | 132396 | 132079 | 126482 | 154497 |
| Mw1/Mn1 | 2.12 | 2.14 | 2.10 | 2.17 |
| Short Chain Branches per | 16.17 | 11.07 | 20.11 | 5.59 |
| 1000 carbons (SCB1) | | | | |
| The Second Ethylene Copolymer | | | | |
| Catalyst Type 2 | Ziegler-Natta | Ziegler-Natta | Ziegler-Natta | Ziegler-Natta |
| | Catalyst | Catalyst | Catalyst | Catalyst |
| Weight Fraction [wt²] (wt %) | 0.58 | 0.58 | 0.58 | 0.57 |
| I₂² (g/10 min) | 1.82 ^{c} | 5.94 ^{c} | 8.33 ^{c} | 10.44 ^{c} |
| ρ² (g/cm³) | 0.9241 ^{b} | 0.9234 ^{b} | 0.9271 ^{b} | 0.9380 ^{b} |
| Mn2 | 25819 | 20476 | 19377 | 19509 |
| Mw2 | 91654 | 66395 | 60776 | 56930 |
| Mw2/Mn2 | 3.55 | 3.24 | 3.13 | 2.92 |
| Short Chain Branches per | 13.12 | 10.47 | 10.78 | 4.73 |
| 1000 carbons (SCB2) | | | | |

^{a} ρ¹ = (−a₁ − (a₁² − 4*a₀*(a₂ − (SCB1C6/1000 C)))^{0.5}))/(2*a₀); where a₀ = 9341.81, a₁ = −17765.91 and a₂ = 8446.849.
^{b} ρ² = (ρ^{f} − wt¹*ρ¹)/(wt²); where ρ ¹, ρ² and ρ^{f} are the densities of the first ethylene copolymer, the second ethylene copolymer and the overall (ethylene copolymer composition) density respectively, and wt¹ and wt² represent the respective weight fractions of the first and second ethylene copolymer components.
^{c} Melt Index (I₂, dg/min): Log I₂ = 7.8998042 − 3.9089344*log(Mw/1000) − 0.27994391*Mn/Mw; where Mw is weight average molecular weight of the respective component and Mn is number average molecular weight of the respective component (i.e. the first or the second ethylene copolymer) as determined by polymerization process modeling (see Polymerization Process Model section).

### Blown Film (Multilayer)

Multilayer blown film was produced on a three-layer line, commercially available from Brampton Engineering (Brampton ON, Canada). The structure of the three-layer films produced is summarized in Table 4 below. In the three-layer film structure, the polymer blend as described above is the core layer, sandwiched between two commercially available LLDPE layers.

Layers 1 and 3 (the skin layers) contained SURPASS® SPs116-A, an ethylene/1-octene copolymer resin available from NOVA Chemicals Corporation, having a density of about 0.916 g/cm³ and a melt index (I₂) of about 1 g/10 min. More specifically, layers 1 and 3 contained 98 wt % of SURPASS SPs116-A, 1.0 wt % of an antiblock masterbatch and 1.0 wt % of a slip masterbatch, such that layers 1 and 3 contained 2500 ppm of antiblock (silica (diatomaceous earth)) and 500 ppm of slip (eurcamide). Note that the additive masterbatch carrier resins were LLDPE, and had a melt index (I₂) of about 2.0 g/10 min and a density of about 0.918 g/cm³.

Layer 1 was the insider layer, i.e. inside the bubble as the multilayer film was produced on the blown film line. Layer 3 was the outsider layer, i.e. outside the bubble as the multilayer film was produced on the blown film line. The total thickness of the 3-layer film was held constant at 2.25 mil (57 μm); the thickness of layer 1 was 0.338 mil (8.6 μm), i.e. 15% of 2.25 mil. Similarly, the thickness of layer 3 was 0.338 mil (8.6 μm), i.e. 15% of 2.25 mil.

Layer 2 is the core layer; the thickness of layer 2 was 1.574 mil (40.0 μm), i.e. 70% of 2.25 mil (see Table 4). Layer 2 contained a blend of 40% of NOVAPOL® LF-Y320-A, a high pressure low density polyethylene resin available from NOVA Chemicals Corporation, having a density of about 0.920 g/cm³ and a melt index (I₂) of about 0.25 g/10 min, together with 60% of either an inventive ethylene copolymer composition made according to the present disclosure or a comparative resin. Resin blends used in Layer 2 were prepared by placing the target weight percentages of each component (i.e. 40% of NOVAPOL LF-Y320-A, a high pressure low density polyethylene resin available from NOVA Chemicals Corporation, having a density of about 0.920 g/cm³ and a melt index of about 0.25 g/10 min, together with 60% of either an inventive ethylene copolymer composition made according to the present disclosure or a comparative resin) into a batch mixer and tumble blending for at least 15 minutes. Finished blends were fed directly into the Layer 2 extruder hopper as a dry blend.

The multilayer blown film line consists of a three-layer pancake die design with nickel-plated flow paths on a FLEX-STACK Co-extrusion die technology. The die has an exit lip diameter of 4-inches, in this disclosure a 50 mil die gap width was used. Film was produced at a Blow-Up Ratio (BUR) of 2.7:1 at a constant held output rate of 100 lbs/hr, to create a targeted 2.25 mil film thickness. The remaining equipment specifications comprise 3-1¾″ diameter bi-metallic lining one-piece extruder barrels, with a 30:1 length over diameter (L/D) ratio. A and C extruders (skin layers) are equipped with low-output general purpose screws, while the B extruder (core) has a general-purpose screw with deeper flights for higher outputs. All extruders are blower cooled and operated on 20 horsepower motors, with gravimetric blenders. The air ring uses a conventional lip set and external chilled air blower on a distributor manifold. Nip assembly uses a driven rubber roller and a water-chilled, chromed steel roller that has non-oscillating haul-off. Film travels through the collapsing frame covered in low friction nylon rollers and is also equipped with a dual-turret winder with position linear lay-on rolls for gap winding and tapered tension control.

TABLE 4
Three-Layer Film Structure

| Film Thickness | 2.25 mil (57 μm) | | |
|---|---|---|---|
| Layer Position | Layer 1 - | Layer 2 - | Layer 3 - |
| | Skin Layer | Core Layer | Skin Layer |
| Material | (1) 98% LLDPE | (1) 40% LDPE | (1) 98% LLDPE |
| | [SPs116-A] | [LF-Y320-A] | [SPs116-A] |
| | (1 MI and | (0.25 MI and | (1 MI and |
| | 0.916 g/cm³) | 0.920 g/cm³) | 0.916 g/cm³) |
| | (2) 2% Additive | (2) 60% inv./ | (2) 2% Additive |
| | masterbatches | comp. ethylene | masterbatches |
| | | copolymer | |
| | | composition | |
| Layer (% Film | 15 | 70 | 15 |
| Thickness) | | | |

In the following experimental tests, inventive and comparative polymer blends (having defined molecular features) were evaluated in the three-layer coextruded film structure of Table 4. These tests included studies of shrink characteristics, physical properties and packaging performance.

### Oven Shrink

An oven shrink test method was used for determining the film shrinkage percentage versus temperature in a convection oven in the machine direction (MD).

Test specimens of 4 inch by 4 inch were coated in talc powder and sandwiched in a craft paper and then placed on an oven rack with an open slot, utilized to provide uniform airflow to the specimens. A total of two specimens were tested at each temperature, and an average was reported. A conditioning time of 10 minutes in the oven was used. A standard testing temperature range of 95 to 140° C. was used. The testing was conducted at the initiation of shrinkage through to the point at which shrinkage subsided or the specimens began to melt. Full shrink curves of percentage shrinkage versus temperature were generated.

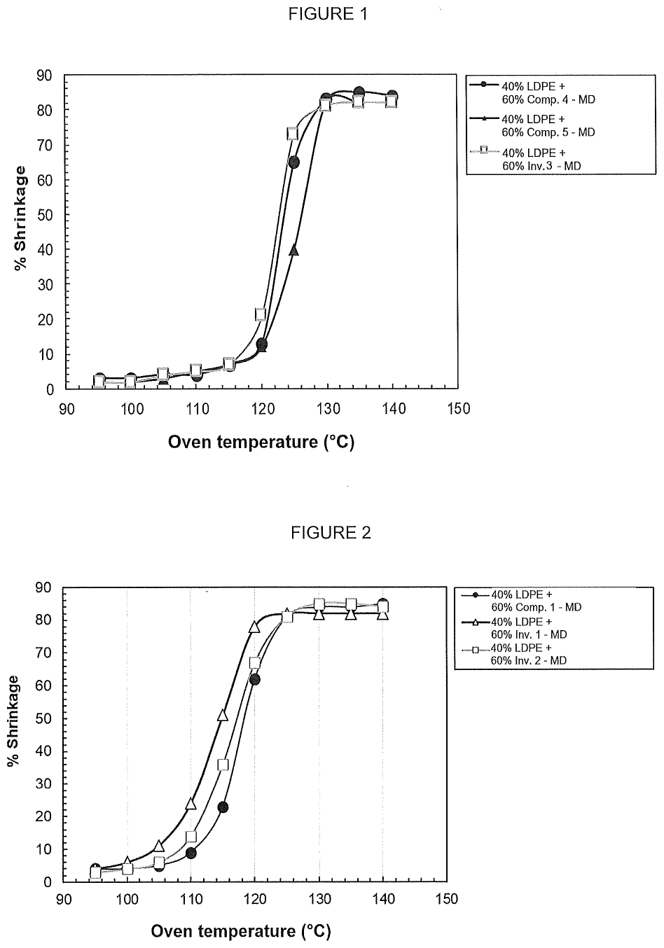

FIGS. 1 and 2 show percentage shrinkage of 2.25 mil (57 μm) three-layer coextruded film specimens (in accordance with the structure of Table 4) in the MD direction with different test materials (i.e. the ethylene copolymer composition of the polymer blend in the core layer was varied).

FIG. 1 shows a comparison of Inventive Example 3 with Comparative Examples 4 and 5, which all comprise a polymer blend in the core layer that comprises an ethylene copolymer composition having a density of approximately 0.934 g/cm³.

FIG. 2 shows a comparison of Inventive Examples 1 and 2 with Comparative Example 1, which all comprise a polymer blend in the core layer that comprises an ethylene copolymer composition having a density of between 0.918 and 0.921 g/cm³.

As can be seen, the multilayer film structures of the invention show improved shrinkage over the comparative structures of approximately the same density. For instance, the blend of Inventive Example 1 shows a significant improvement over the blend of Comparative Example 1, while the enhanced shrinkage is also particularly shown for the blend of Inventive Example 2 at an oven temperature of between 11° and 120° C.

### Shrink Force Method

A shrink force method was employed, allowing for quantification of the amount of theoretical force being exerted by a multilayer film structure of the invention onto a wrapped product.

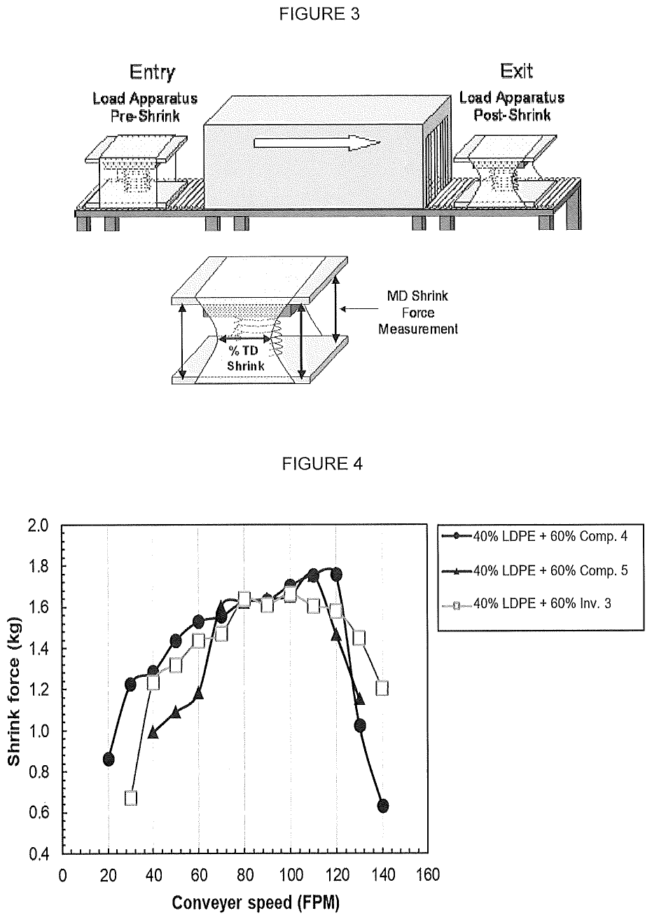

A schematic representation of the shrink force measurement system is shown in FIG. 3.

The method involved wrapping a 3-inch by 29-inch multilayer film structure specimen around an apparatus, which includes a digital kitchen balance onto a scissor jack lab scale. The test was completed with an oven temperature of 190 to 200° C., while varying the conveyor speeds by 10 FPM increments. For each test specimen, three samples in the MD direction were tested.

The details of the method were as follows. A specimen was wrapped around the balance by creating a lap seal with tape. The lap seal was moved to the bottom of the apparatus. The balance was turned on (reading zero) and the dial on the jack was turned until approximately 300 grams of load was displayed. The apparatus was picked up and placed back on the table; after any slack or misalignment was accounted for, the load displayed approximately 200+10 grams of load. The jack was lowered until the height of the top plate was 5.75 inches from the table and the scale displayed zero grams. The balance was then turned off, and the apparatus was carried to the discharge table of the shrink tunnel and set carefully on a conveyor belt (see FIG. 3).

The cycle was started, so that the scale moved through the tunnel and exited onto the cooling conveyor at the other end, where it was allowed to cool for 2 minutes. The scale was then moved to the inspection table where it was turned on. The film was cut and the shrink force was recorded in kg. The process was then repeated until there was a noticeable drop in force, and a shrink force curve was plotted at different FPM speeds.

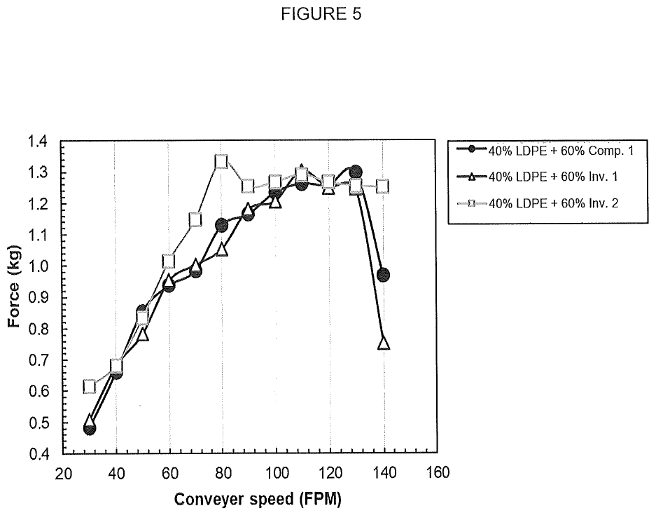

FIGS. 4 and 5 show shrink force curves obtained by measuring shrink force at different FPM speeds of 2.25 mil (57 μm) three-layer coextruded film specimens (in accordance with the structure of Table 4) in the MD direction with different test materials (i.e. the ethylene copolymer composition of the polymer blend in the core layer was varied). The oven temperature was 190° C.

FIG. 4 shows a comparison of Inventive Example 3 with Comparative Examples 4 and 5, which all comprise a polymer blend in the core layer that comprises an ethylene copolymer composition having a density of approximately 0.934 g/cm³.

FIG. 5 shows a comparison of Inventive Examples 1 and 2 with Comparative Example 1, which all comprise a polymer blend in the core layer that comprises an ethylene copolymer composition having a density of between 0.918 and 0.921 g/cm³.

As can be seen, the multilayer film structures of the invention show similar or better shrink force profiles, compared with comparative structures of approximately the same density. In particular, the shrink force of the blend of Inventive Example 1 is significantly greater than that of the blend of Comparative Example 1, particularly at a conveyer speed of between 60 and 100 FPM.

TABLE 5
Key Mechanical/Physical Properties of Multilayer Film Structures

| | Example No. | | | | | |
|---|---|---|---|---|---|---|
| | Comp. | Inv. | Inv. | Comp. | Comp. | Inv. |
| | 1 | 1 | 2 | 4 | 5 | 3 |
| Dart Impact (g/cm³) | 159 | 173 | 176 | 110 | 116 | 126 |
| DYNATUP Maximum Load | 9.13 | 9.18 | 8.91 | 8.01 | 7.52 | 8.5 |
| (lb) | | | | | | |
| DYNATUP Total Energy | 0.36 | 0.43 | 0.39 | 0.26 | 0.26 | 0.28 |
| (ft-lb) | | | | | | |
| 1% Secant Modulus - MD | 177 | 175 | 185 | 205 | 240 | 246 |
| (MPa) | | | | | | |
| Film Elmendorf Tear in MD | 72 | 109 | 108 | 73 | 107 | 127 |
| (g/mil) | | | | | | |
| Film Elmendorf Tear in TD | 967 | 795 | 817 | 346 | 349 | 417 |
| (g/mil) | | | | | | |
| Tensile at Break MD (MPa) | 33.0 | 36.8 | 32.9 | 30.6 | 32.3 | 27.5 |
| Tensile Yield MD (MPa) | 11.2 | 11.5 | 10.9 | 11.1 | 13.5 | 12.9 |
| Tensile at Break TD (MPa) | 31.1 | 30.4 | 28.9 | 24.7 | 37.6 | 26.6 |
| Tensile Yield TD (MPa) | 11.1 | 11.0 | 11.5 | 12.5 | 14.9 | 14.3 |
| Gloss at 45° (GU) | 80 | 78 | 79 | 73 | 75 | 79 |
| Haze Value (%) | 7.2 | 5.2 | 5.9 | 12.0 | 10.2 | 7.5 |

Physical properties of three-layer coextruded film specimens (in accordance with the structure of Table 4) are shown in Table 5 above.

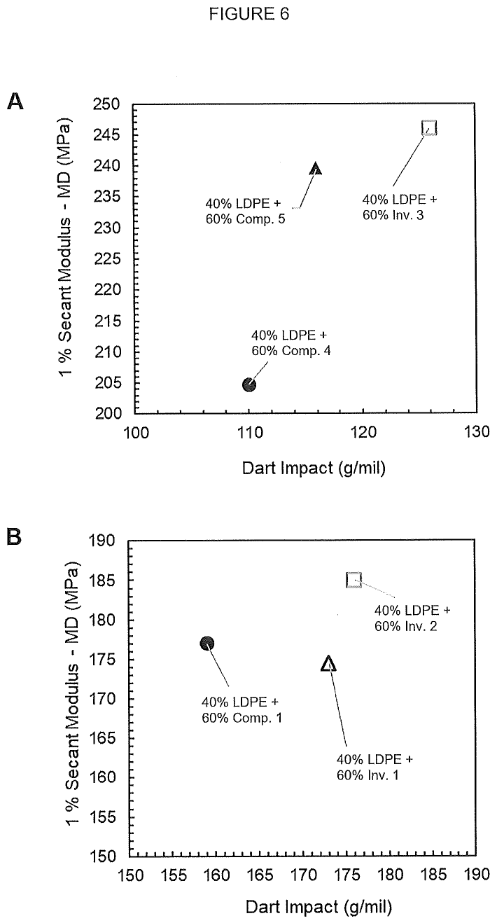

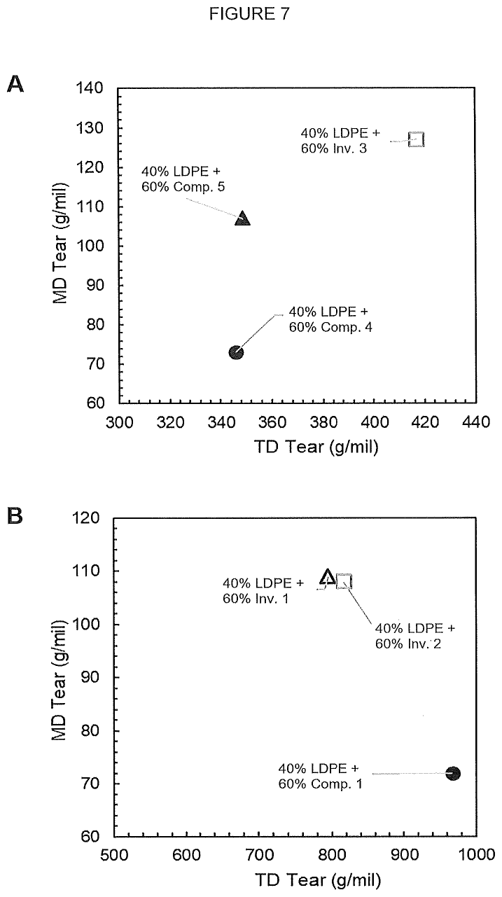

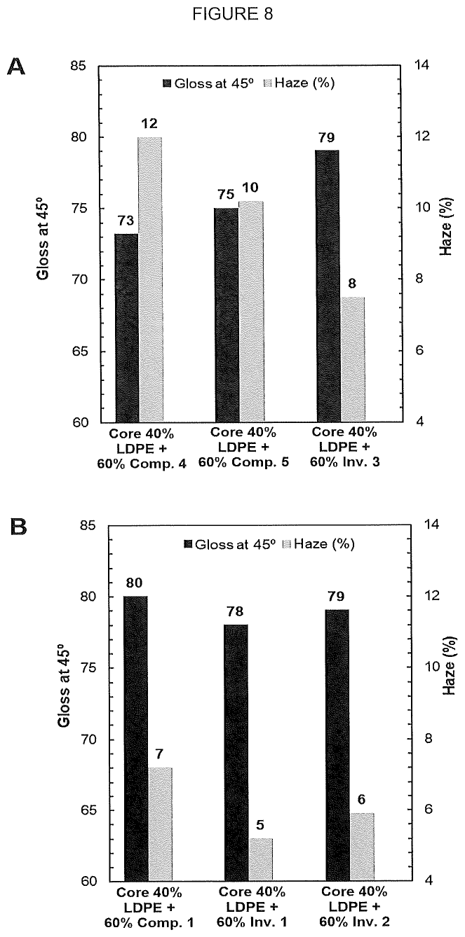

Some of these properties are also plotted in the graphs of FIGS. 6, 7 and 8. Specifically, FIG. 6 (A and B) shows 1% secant modulus (measure of stiffness) and dart impact (measure of toughness); FIG. 7 (A and B) shows MD tear versus TD tear; and FIG. 8 shows optical properties, namely gloss at 45° (left black bar for each specimen on graphs A and B) and haze values (right grey bar).

As can be seen, the multilayer film structures of the invention show an improved balance of stiffness-toughness and MD/TD tear properties, as well as excellent optical properties (generally reduced haze and increased or comparable gloss), when compared with comparative structures of approximately the same density.

In each of FIGS. 6, 7 and 8, graph A shows a comparison of Inventive Example 3 with Comparative Examples 4 and 5, which all comprise a polymer blend in the core layer that comprises an ethylene copolymer composition having a density of approximately 0.934 g/cm³; while graph B shows a comparison of Inventive Examples 1 and 2 with Comparative Example 1, which all comprise a polymer blend in the core layer that comprises an ethylene copolymer composition having a density of between 0.918 and 0.921 g/cm³.

In particular, the blend of Inventive Example 3 has greater 1% secant modulus (MD), dart impact, MD tear and TD tear than the blends of Comparative Examples 4 and 5, as well as reduced haze and increased gloss. Meanwhile, the blend of Inventive Example 1 has greater dart impact, greater MD tear and comparable 1% secant modulus (MD), compared with the blend of Comparative Example 1, while the blend of Inventive Example 2 exhibits improvements in all three of these parameters.

### Shrink Tunnel Package Integrity Testing

A Douglas S-30 Shrink Wrapper was used to understand the shrink performance of various multilayer film structures. Shrink performance, including shrink force, is important for understanding how a specific film structure will perform in a commercial application, such packaging of multiple bottles. To allow for the removal of any cardboard slip trays or liners, the film structure must allow for sufficient strength and shrink force to contain the contents.

A standard format for evaluation and ranking of different film structures was employed, using 12 generic 600 mL water bottles, filled with water and blue food coloring, allowing for more contrast between the clear film and bottles for easier evaluation. Based on the dimensions of the 12 bottles, the appropriate length of film was fed to create a 2-inch lap seal underneath the package, generally 15.75 to 16 inches. Once the equipment recipe was selected and the correct wand cams, infeed rails width and sag bet heights were set, the bottles were loaded onto the front end. The bottles were conveyed onto the wrapping table, and a wrapping wand was used to pick up the trailing end of the film and bring it around the bottles. As the bottles travelled from the wrapping table to the discharge table, the film was drawn underneath the bottles to complete the lap seal. The wrapped bottles then left the discharge table and were transferred onto a tunnel chain to be fed through an 8-foot oven. Two air knives ran along the distance of the tunnel walls, whose function was to direct air at the sides of the bottles to create bullseyes. The tunnel temperature was 196° C. (385° F.) and the air knife velocity was 4 cubic feet per minute (CFM). The finished package then exited the tunnel and was cooled under a fan for approximately 2 minutes, before being transferred to the inspection table.

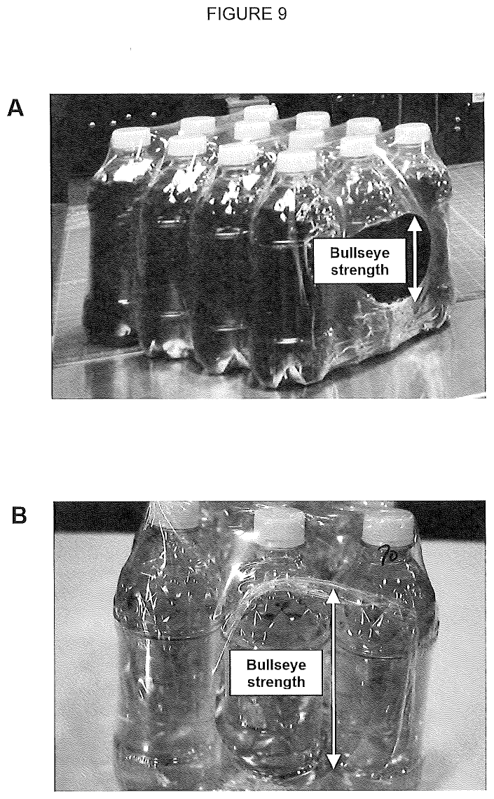

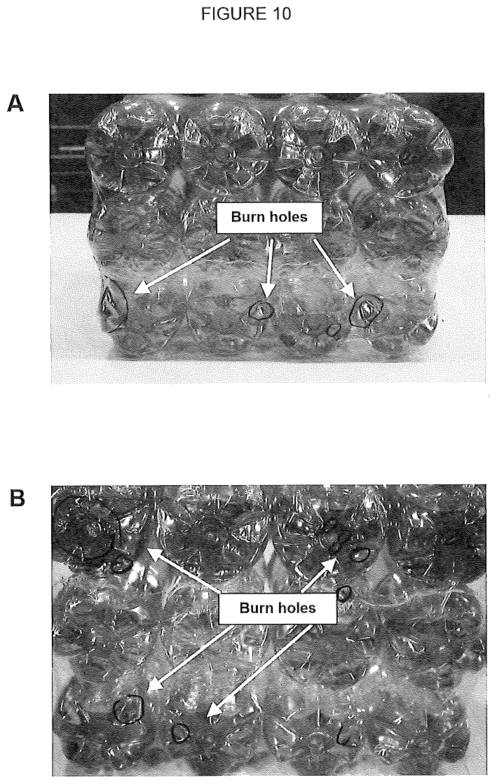

The packages were inspected for bullseye strength, bottle movement, how pronounced the valleys between the bottles were, burn holes and overall appearance. The process was repeated using various conveyer speeds from 20 to 80 FPM. FIGS. 9 and 10 show representative images of bottle packages. Specifically, FIG. 9 shows bullseyes in packages, with good bullseye strength shown in image A and poor bullseye strength shown in image B. Meanwhile, FIG. 10 shows burn holes in the base of packages in each of images A and B.

Shrink packaging integrity tests were carried out on three-layer coextruded film specimens (in accordance with the structure of Table 4), made using inventive and comparative examples. In each of these tests, 12 water bottles were shrink packed. Qualitative results were determined in terms of bottle movement, bullseye 5 strength and burn holes. The results are shown in Tables 6, 7 and 8 below.

TABLE 6
Shrink Package Integrity Test Results Using a Film
Structure of Table 4, Comprising a Polymer Blend
in the Core Layer that Comprises Comp. 4

| Conveyor | No Bottle | Bullseye | No Burn | Package |
|---|---|---|---|---|
| Speed (FPM) | Movement | Strength | Holes | Pass |
| 20 | ✓ | ✓ | x | x |
| 30 | ✓ | ✓ | x | x |
| 40 | ✓ | ✓ | ✓ | ✓ |
| 50 | ✓ | ✓ | ✓ | ✓ |
| 60 | ✓ | ✓ | ✓ | ✓ |
| 70 | x | x | ✓ | x |

TABLE 7
Shrink Package Integrity Test Results Using a Film
Structure of Table 4, Comprising a Polymer Blend
in the Core Layer that Comprises Comp. 5

| Conveyor | No Bottle | Bullseye | No Burn | Package |
|---|---|---|---|---|
| Speed (FPM) | Movement | Strength | Holes | Pass |
| 20 | ✓ | ✓ | x | x |
| 30 | ✓ | x | x | x |
| 40 | ✓ | ✓ | x | x |
| 50 | ✓ | ✓ | ✓ | ✓ |
| 60 | ✓ | ✓ | ✓ | ✓ |
| 70 | x | x | ✓ | x |

TABLE 8
Shrink Package Integrity Test Results Using a
Film Structure of Table 4, Comprising a Polymer
Blend in the Core Layer that Comprises Inv. 3

| Conveyor | No Bottle | Bullseye | No Burn | Package |
|---|---|---|---|---|
| Speed (Fpm) | Movement | Strength | Holes | Pass |
| 20 | ✓ | ✓ | x | x |
| 30 | ✓ | ✓ | ✓ | ✓ |
| 40 | ✓ | ✓ | ✓ | ✓ |
| 50 | ✓ | ✓ | ✓ | ✓ |
| 60 | ✓ | ✓ | ✓ | ✓ |
| 70 | x | x | ✓ | x |

As can be seen from Tables 6 to 8, in particular at conveyer speeds of 30 to 40 FPM, the multilayer film structure of the invention shows better shrink package integrity over the comparative examples of similar density.

The shrink integrity results shown in Tables 6 to 8 can be further interpreted in view of the rheological characteristics of the inventive polymer blends, as discussed below.

### Long Chain Branched Topologies as Determined Using Nonlinear Melt Rheology

The hafnocene/Ziegler-Natta catalyzed ethylene/alpha-olefin copolymers disclosed herein contain detectable levels of long chain branching (hereafter, “LCB”). A long chain branch is macromolecular in nature, i.e., a branch that has a length greater than the critical molecular weight for entanglement (i.e. 2 to 3 times larger than Mₑ≅900 g/mol for PE homopolymer; Mₑ is an ascending function of α-olefinic comonomer content in an ethylene/alpha-olefin copolymer) up to a branch that has a length similar to that of the macromolecule backbone to which the long chain branch is attached (e.g. see Doerpinghaus and Baird, Journal of Rheology 2003, 47, 717-736).

This disclosure employs the strain-dependence of intracycle shear-thickening behavior, referred to as “intracycle nonlinear function” (or “INF” hereafter), to determine presence of LCB structures in the disclosed compositions according to the following steps.

In the first step, a sample of the composition of interest in melt-state is subjected to an oscillating strain-wave at a fixed angular frequency and temperature with a step-wise increasing strain-amplitude from a lower limit strain-amplitude to an upper limit strain-amplitude, to obtain a stress-wave response and corresponding viscous Lissajous-Bowditch loop (i.e., stress versus strain-rate loops) at each strain-amplitude level.

In the second step, the intracycle nonlinear function, INF, is determined experimentally using the instantaneous dynamic viscosities at maximum strain-rate

$$( {η}_{L}^{′} )$$

and at minimum strain-rate

$$( {η}_{M}^{′} )$$

in the viscous Lissajous-Bowditch loop at each strain-amplitude level using

$$INF = \frac{{η}_{L}^{′} - {η}_{M}^{′}}{{η}_{L}^{′}}$$

(INF is dimensionless) by a rheology data processing software (e.g. Anton Paar RheoCompass).

Further, in the third step, the INF obtained for the composition of interest is compared with a reference INF predicted for a linear (non-long-chain branched) ethylene/alpha-olefin copolymer composition having a

$$\frac{{M}_{z}}{{M}_{w}}$$

equivalent to the composition of interest.

In the fourth step, presence of LCB in the composition of interest is detected according to a positive deviation from the predicted reference INF.

In the present disclosure, the instantaneous dynamic viscosities at maximum strain-rate

$$( {η}_{L}^{′} )$$

and at minimum strain-rate

$$( {η}_{M}^{′} )$$

in a viscous Lissajous-Bowditch loop at a certain strain-amplitude level were obtained by a stress decomposition method (the method introduced in Journal of Rheology 2005, 49, pp 747-758) and by fitting the Chebyshev polynomials of the first kind to the viscous stress response of tested linear or long-chain branched ethylene/alpha-olefin copolymers (as described in Journal of Rheology 2008, 52, pp 1427-1458).

INF is a material function that is initially zero (within the linear regime) and then changes its sign to positive (intracycle shear-thickening) and/or negative values (intracycle shear-thinning) as strain amplitude increases and a nonlinear response emerges.

A dimensionless scaling function (similar to that defined in Journal of Rheology 2010, 54, pp 27-63) was applied to the imposed strain-amplitude to γ₀ according to ζ=γ₀ cos δ|ₐ_{_{M}}_{ω=0.1 rad/s} where δ|ₐ_{_{M}}_{Ω=0.1 rad/s} is the phase-angle at a frequency of a_{M}ω=0.1 rad/s in which a_{M} was the time-molecular weight superposition shift factor applied to remove the effect of linear viscoelasticity and molecular weight.

In this disclosure, the INF values of linear and long-chain branched ethylene/α-olefin copolymers were obtained at 190° C. under nitrogen atmosphere, by applying a sinusoidal strain-wave at an angular frequency of 0.1 rad/s, at a strain-amplitude range of 1 and 103% and at a gap-size of 1 mm using a 25 mm stainless parallel-plate geometry. Multiple gap-size measurements indicated that these test conditions can generate a nearly instability-free stress signal suitable for further analysis. In all tests, a pre-compression molded disk of the composition of interest with a thickness of about 1.9-2 mm was loaded on the rheometer lower plate at a temperature close to 190° C. After reaching thermal equilibrium at 190° C., the upper plate was lowered, squeezing the molten polymer at a rate of 1000 to 100 μm/s without exceeding a normal force of 40 N. The upper plate was lowered to a vertical position of 30 μm above the testing gap height and the excess molten sample was trimmed and the gap was lowered to the testing position of 1 mm. The temperature was then kept constant to reach thermal equilibrium at 190±0.1° C. The melt-state sample was then subjected to an oscillating strain-wave at a fixed angular frequency and temperature with a step-wise increasing strain-amplitude from a lower limit strain-amplitude to an upper limit strain-amplitude, to obtain a stress-wave response and corresponding stress versus strain-rate loops (known in the art as viscous Lissajous-Bowditch loop) at each strain-amplitude level. To be specific, in these nonlinear rheology tests, twenty-two equidistantly spaced strain-amplitude values within the range of 1 to 103% were applied at an angular frequency of 0.1 rad/s.

The raw waveforms and viscous Lissajous-Bowditch loops were analyzed using RheoCompass 1.17 software. The INF of the linear ethylene/α-olefin copolymers (INF^{lin}) were observed to be well described by a double power-law function according to eq. 1 (INF is dimensionless):

$${{INF}^{lin} = - K {ζ}^{1.45} ( {ζ}^{{a}^{*}} - {C}^{*} ) ; ζ = {γ}_{0} cos δ \vert}_{{a}_{M} ω = 0.1 r a d / s} \qquad ( eq . 1 )$$

in which K is a constant equal 0.3722, γ₀ is the imposed strain amplitude, a_{M} is the time-molecular weight superposition shift factor defined as

$${a}_{M} = {( \frac{{M}_{w}}{{M}_{r e f}} )}^{3.41}$$

where M_{w} is the SEC weight-average molecular weight of said linear ethylene/α-olefin copolymer and M_{ref} is a reference molecular weight of 10⁵ g/mol.

In eq. 1, δ|ₐ_{_{M}}_{ω=0.1 rad/s} is the phase-angle at a frequency of a_{M}ω=0.1 rad/s which was interpolated using a 33-mode generalized Maxwell model described in the linear rheology section. It should be added that δ|ₐ_{_{M}}_{ω=0.1 rad/s} values larger than 88.5° were not used for these calculations and were replaced by the largest phase angle measured within a frequency range of 0.05-100 rad/s. Parameters a* and C* in Eq. 1 were calculated as a function of the SEC-determined weight-average molecular weight M_{w} and z-average molecular weight M_{z} as follows:

$${a}^{*} = f ( \frac{{M}_{z}}{{M}_{w}} ) = \{ \begin{matrix}0 & \frac{{M}_{z}}{{M}_{w}} \leq 1.64 \\ 0.8645 ( \frac{{M}_{z}}{{M}_{w}} - 1.5 ) - 0.1198 & 1.64 < \frac{{M}_{z}}{{M}_{w}} < 2.21 \\ \begin{matrix}0.5938 {( \frac{{M}_{z}}{{M}_{w}} - 1.5 )}^{2} - 1.1803 \\ ( \frac{{M}_{z}}{{M}_{w}} - 1.5 ) + 1.0455\end{matrix} & \frac{{M}_{z}}{{M}_{w}} \geq 2.21\end{matrix} \qquad ( eq . 2 )$$

$${C}^{*} = g ( \frac{{M}_{z}}{{M}_{w}} ) = \{ \begin{matrix}0 & \frac{{M}_{z}}{{M}_{w}} < 2.21 \\ 0.5944 ln ( \frac{{M}_{z}}{{M}_{w}} - 1.5 ) + 0.2057 & \frac{{M}_{z}}{{M}_{w}} \geq 2.21\end{matrix} \qquad ( eq . 3 )$$

Similarly, the measured INF values of herein disclosed LCB ethylene/α-olefin copolymer compositions were found to be describable using the following formula (INF is dimensionless):

$${INF = - K {ζ}^{1.45} ( {ζ}^{a} - C ) ; ζ = {γ}_{0} cos δ \vert}_{{a}_{M} ω = 0.1 r a d / s} \qquad ( eq . 4 )$$

in which K is a constant equal 0.3722 and γ₀, a_{M} and δ|ₐ_{_{M}}_{ω=0.1 rad/s} parameters have the same definition as in eq. 1. Parameters a and C in eq. 4 were used as fitted constants by minimizing sum of squared residuals for the measured INF data points with at least 0.1% nonlinearity (i.e., data point with a third-order harmonic ratio I_{3/1} of at least 0.001) within a ζ range of 0.01 to 0.7 to describe different experimental intracycle viscous nonlinear behaviors ranging from an intracycle shear-thinning (INF<0) behavior to an intracycle shear-thickening behavior (INF>0).

Based on the above formulations, the present disclosure defines a parameter purely reflecting the impact of long chain branching content on the intracycle nonlinear function, INF; specifically, a “network parameter” Δ_{int.} can be formulated based on the integrated area between the measured INF and INF^{lin} over an ζ interval of 0.01 to 0.7 as follows:

$${Δ}_{int .} = {\int }_{0.01}^{0.7} [ INF - {INF}^{l i n} ] d ζ = {[ \frac{- K}{a + 2.45} {ζ}^{a + 2.45} + \frac{K C}{2.45} {ζ}^{2.45} + \frac{K}{{a}^{*} + 2.45} {ζ}^{{a}^{*} + 2.45} - \frac{K {C}^{*}}{2.45} {ζ}^{2.45} ]}_{0.01}^{0.7} \qquad ( eq . 5 )$$

The above defined network parameter Δ_{int.} has high sensitivity to the presence of long-chain branched species in the disclosed compositions. Non-LCB ethylene/α-olefin copolymers will have a Δ_{int.} of less than 0.01. Without wishing to be bound by any theory, a Δ_{int.} value of greater than or equal to 0.01 translates into a delayed breakdown of the entanglement network under a strong oscillatory shear-field caused by the presence of long-chain branches having a length greater than the critical molecular weight for entanglement.

The network parameter and rheological/molecular characteristics required for calculation thereof (as detailed in eq. 1 to 5) are tabulated in Table 9 for Inventive Examples 1 to 3 as well as Comparative Examples 1, 6 to 8 and 11. While not shown in Table 9, Comparative Examples 2, 4 and 5 were non-LCB ethylene/α-olefin copolymer compositions having a Δ_{int.} of less than 0.01.

In this disclosure, the dimensionless nonlinear rheology network parameter Δ_{int.} of the ethylene copolymer compositions (preferably hafnocene/Ziegler-Natta compositions) has been fine-tuned to have an upper limit of less than or equal to 0.075, and in other cases less than or equal to 0.072, and in still other cases less than or equal to 0.071. The lower limit on the Δ_{int.} of the ethylene copolymer compositions (preferably hafnocene/Ziegler-Natta compositions) is greater than or equal to 0.055, in other cases greater than or equal to 0.057, and in still other cases greater than or equal to 0.058.

TABLE 9
Molecular & Rheological Features of Ethylene Copolymer Compositions, as Detailed in eq. 1 to 5

| | n_{c} | m_{b} | Mₑ | M_{w} | | | | | | | | |
|---|---|---|---|---|---|---|---|---|---|---|---|---|
| | mol % | g/mol | g/mol | kg/mol | M_{z}/M_{w} | cos δ | a* | C* | a | C | Δ_{int.} | Z |
| Inv. 1 | 2.9 | 15.2 | 1295.8 | 111.2 | 2.2 | 0.29 | 0.4675 | 0.0000 | 0.4759 | 0.9710 | 0.0618 | 85.8 |
| Inv. 2 | 2.3 | 15.0 | 1222.3 | 101.7 | 2.1 | 0.34 | 0.4313 | 0.0000 | 0.4386 | 1.0296 | 0.0655 | 83.2 |
| Comp.11 | 2.9 | 15.2 | 1295.8 | 100.1 | 2.0 | 0.24 | 0.2790 | 0.0000 | 0.6509 | 0.7776 | 0.0611 | 77.2 |
| Inv. 3 | 1.0 | 14.4 | 1073.2 | 109.2 | 2.2 | 0.49 | 0.4632 | 0.0000 | 0.3859 | 1.1513 | 0.0705 | 101.7 |
| Comp. 1 | 2.2 | 14.8 | 1167.0 | 107.4 | 1.7 | 0.02 | 0.0000 | 0.0000 | 0.0000 | 0.0000 | 0.0000 | 92.0 |
| Comp. 2 | 2.9 | 15.2 | 1295.8 | 104.7 | 2.1 | 0.14 | 0.3966 | 0.0000 | 0.7478 | 0.5754 | 0.0466 | 80.8 |
| Comp. 6 | 2.8 | 15.2 | 1283.3 | 103.5 | 2.4 | 0.20 | 0.4654 | 0.1364 | 0.5376 | 0.7884 | 0.0435 | 80.6 |
| Comp. 7 | 3.0 | 15.3 | 1308.3 | 98.3 | 2.1 | 0.20 | 0.4248 | 0.0000 | 0.4619 | 0.7964 | 0.0517 | 75.1 |
| Comp. 8 | 3.4 | 15.4 | 1359.4 | 87.8 | 2.2 | 0.11 | 0.4854 | 0.0000 | 0.4776 | 0.4142 | 0.0260 | 64.6 |

where “cos δ” in Table 9 is cosδ|ₐ_{_{M}}_{ω=0.1 rad/s}

### Linear Melt Rheology and Relaxation Time Spectrum

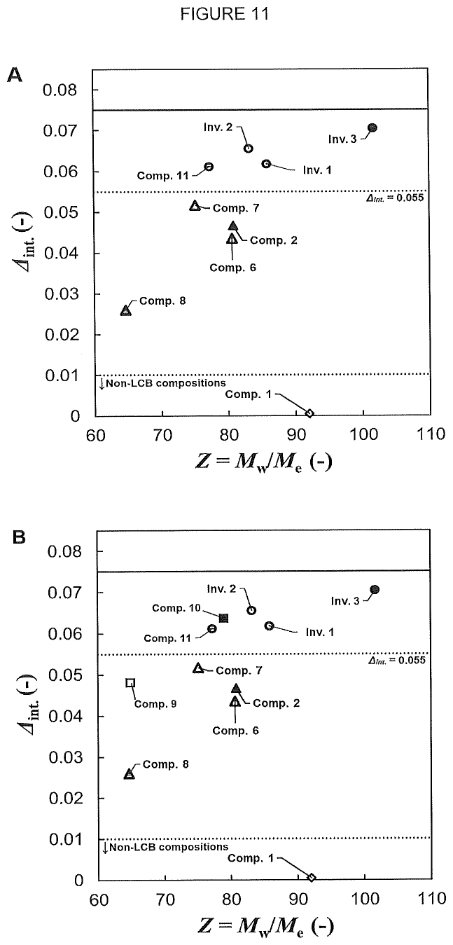

FIG. 11 (A and B) shows, for various ethylene copolymer compositions, the nonlinear rheology network parameter (Δ_{int.}) as a function of a normalized molecular weight Z=M_{w}/Mₑ in which M_{w} was the weight average molecular weight determined by conventional size exclusion chromatography (SEC) and Mₑ was the molecular weight between entanglements. For calculating Mₑ the equation with a power-law-like dependence on molecular weight per backbone bond m_{b} proposed by Feters et al. (Macromolecules, 1994, 27, pp 4639-4647) was used for m_{b}s between 14 to 28 g/mol:

$${M}_{e} = \frac{4}{5} \frac{ρ R T {m}_{b}^{3.49}}{24820} \qquad ( eq . 6 )$$

in which m_{b} was the molecular weight per backbone bond. As can be seen, m_{b} was a function of comonomer type and content. The parameter T was the absolute temperature at which Δ_{int.} was measured, ρ was the melt-state density at the temperature Δ_{int.} was measured (i.e. 0.780 g/cm³ at 190° C., or 463.15 Kelvin) and R was the universal gas constant with a value of 8.314 J/(mol·Kelvin). The molecular weight per backbone bond m_{b} was calculated in units of g/mol as defined by Chen et al. in J. Rheol. 2010, 54, pp 393-406 as follows:

$${m}_{b} = \frac{{n}_{c} {M}_{w / c} + 28 ( 1 - {n}_{c} )}{2} \qquad ( eq . 7 )$$

where n_{c} is the comonomer content in mole fraction determined by Fourier transform infrared (FTIR) spectroscopy according to ASTM D6645-01 (2001) and M_{w/c} is the molecular weight of the comonomer (e.g. 112.22 g/mol for 1-octene). As demonstrated in graph A, the unique LCB topologies present in these compositions lead to a Δ_{int.} larger than 0.055, which is well beyond the network parameter observed for comparative and commercial resins produced using a mixed catalyst system.

In this disclosure, the normalized molecular weight Z=M_{w}/Mₑ of the ethylene copolymer compositions (preferably hafnocene/Ziegler-Natta compositions) has been fine-tuned to have an upper limit of less than or equal to 120, and in other cases less than or equal to 115, and in still other cases less than or equal to 110. The lower limit on the normalized molecular weight Z=M_{w}/Mₑ of the ethylene copolymer compositions (preferably hafnocene/Ziegler-Natta compositions) is greater than or equal to 80, in other cases greater than or equal to 85, and in still other cases greater than or equal to 90.

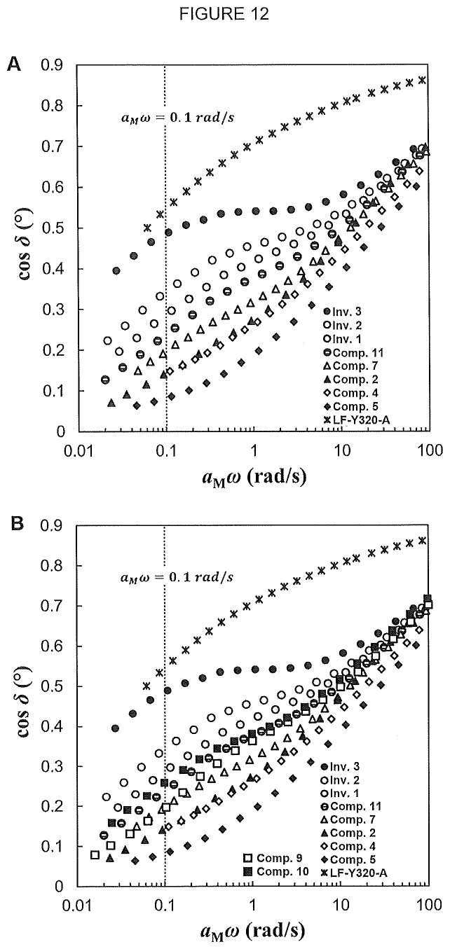

In FIG. 12, graph A shows, for various ethylene copolymer compositions, cosine of phase angle (cos δ) as a function of weighted angular frequency. The dotted vertical line compares cos δ of the plotted examples at a_{M}ω=0.1 rad/s. With reference to FIG. 12 and Table 10, the hafnocene/Ziegler-Natta compositions disclosed herein had an intensified elastic response, which was evidenced by their significantly larger cosine of phase angle δ values relative to commercially available comparative products at a given a_{M}ω. Particularly in the low angular frequency region, as shown by the dotted line in FIG. 12, it was observable that the cos δ versus a_{M}ω response obtained for Inventive Examples 1 to 3 approached that of the LDPE material, LF-Y320-A.

For each of FIGS. 11 and 12, graph B is the same as graph A but with additional data points shown for further Comparative Examples 9 and 10, which are previously disclosed hafnocene/Ziegler-Natta compositions. Comparative Example 9 is Example 3 of WO 2018/193375, which composition has an LCBF of 0.0205, a network parameter Δ_{int.} of 0.0484, a Z value of 64.9, and a weight-average relaxation time τ_{w} of 11.1 s (as measured by the applicant, who is the applicant of both the present and prior applications). Comparative Example 10 is Example 4 of WO 2018/193375, which composition has an LCBF of 0.0291, a network parameter Δ_{int.} of 0.0637, a Z value of 78.9 (as disclosed in US2020224013), and a weight-average relaxation time τ_{w} of 25.8 s (as measured by the applicant). Long-chain branching factor (LCBF) is a LCB measure defined based deviation from a linear reference line in a no versus [ [symbol] ] plot (see FIG. 1 of WO 2018/193375). The contents of WO 2018/193375 and US2020224013 are incorporated herein by reference.

Comparative Examples 9 and 10 together with the Comparative Example 11 are prepared using a single site catalyst formulation comprising diphenylmethylene (cyclopentadienyl)(2,7-di-t-butylfluorenyl) hafnium dimethide [(2,7-tBu2Flu)Ph₂C(Cp)HfMe₂] and an in-line Ziegler-Natta catalyst formulation in first and second reactors configured in series under conditions to produce multi-component ethylene copolymer compositions having a Δᵢₙₜ-Z coordinates outside a Δ_{int.} range of from 0.055 to 0.075, and a Z range from 80 to 120. This can be specifically seen in FIG. 11 graph B and FIG. 12 graph B.

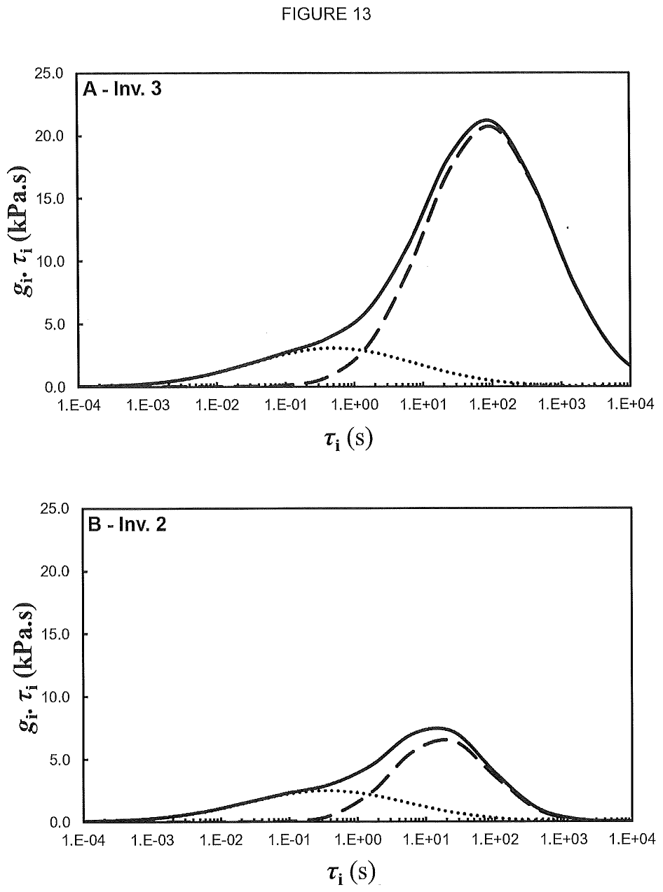

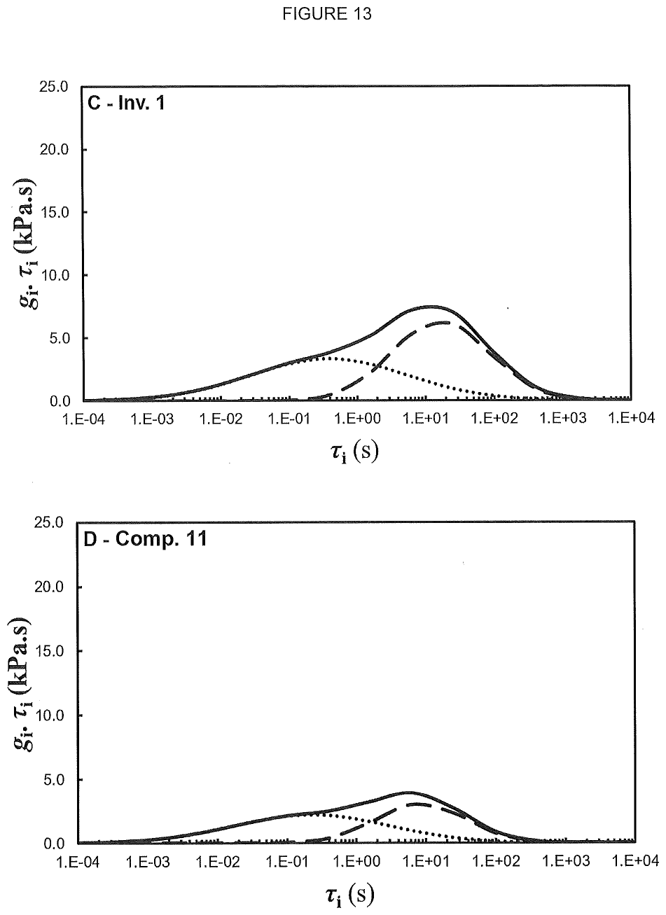

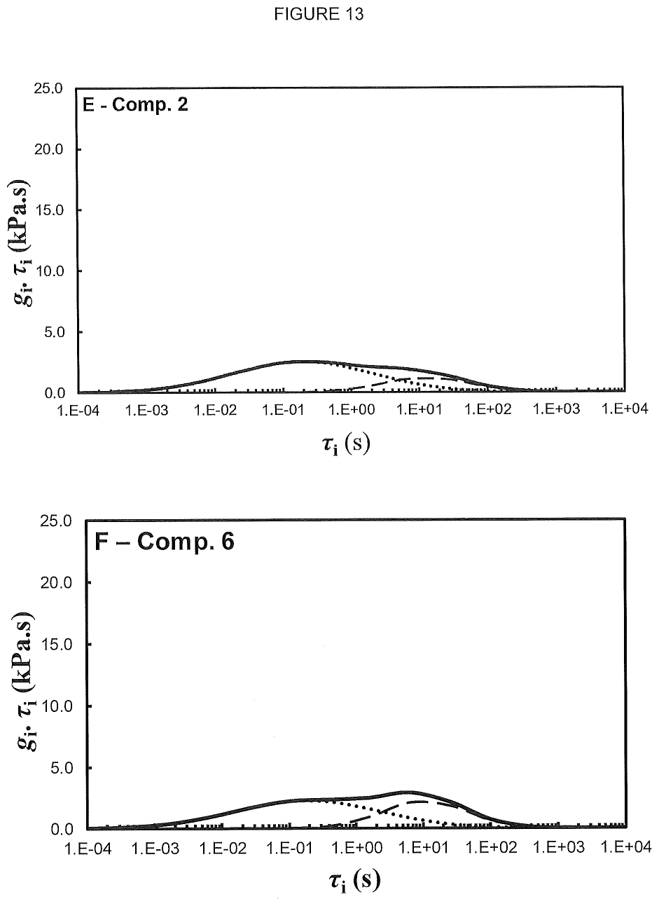

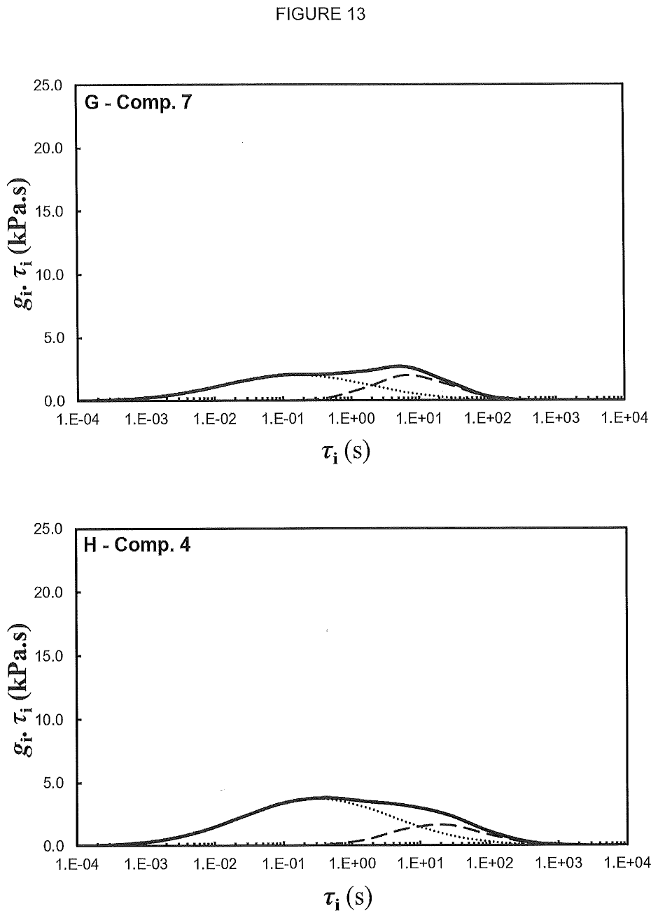

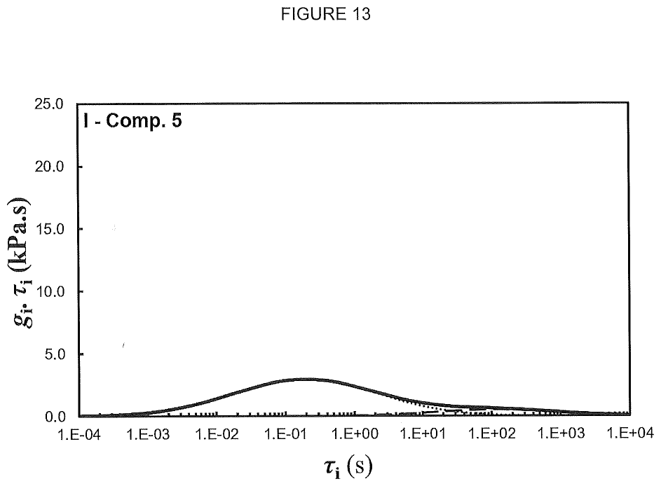

Meanwhile, FIG. 13 shows weighted relaxation time spectra (gᵢτᵢ vs τᵢ) of various ethylene copolymer compositions. A different spectrum is shown for each of the tested compositions (see spectra A to I), which include hafnocene/Ziegler-Natta compositions that can be employed in polymer blends of the invention (spectra A to C) and also comparative compositions (spectra D to I). For each composition, the overall spectrum (solid line) is decomposed into a slow relaxation mode (dashed line) and a fast relaxation mode (dotted line).

The weight-average relaxation times (τ_{w}s) can be used to compare the importance of the slow relaxation mode in the studied compositions. The weight-average relaxation times (τ_{w}s) in Table 10 and FIG. 13 (spectra A to I) show that the inventive compositions have a relaxation spectrum dominated by relaxation processes occurring at time scales significantly longer than the characteristic time of the heat shrinkage process (i.e. the residence time in the shrink tunnel at any given conveyor speed).

As aforementioned, LFY320-A is a commercial LDPE product available from NOVA Chemicals Corporation, which is produced in a high-pressure tubular process with a melt index 12 of 0.25 g/10 min and a density of 0.920 g/cm³. High-pressure low-density polyethylene materials are known in the art to be highly long-chain branched with a branch-on-branch structure exhibiting a predominantly elastic rheological behavior and an ultra-slow relaxation process.

Without wishing to be limited by any theory, the improved dynamic symmetry between the disclosed hafnocene/Ziegler-Natta compositions with a fine-tuned LCB content and the LDPE component, by making the stress partitioning more uniform between components, has led to a superior package integrity performance for the coextruded films, which included the hafnocene/Ziegler-Natta composition and LF-Y320-A in their core layer (as confirmed by the data shown in Tables 6 to 8). Moreover, one may postulate that their slower relaxation process, combined with their improved elasticity, may have also improved the shrink integrity performance of the coextruded films prepared from the hafnocene/Ziegler-Natta compositions of the present disclosure, by either suppressing failure or increasing the induction time of failure to time scales longer than the residence time in the shrink tunnel. This latter assumption is supported by the fact that the broadened processing window observed for the films prepared from the hafnocene/Ziegler-Natta compositions was mainly due to no observation of burn holes.

Increased LCB content of the hafnocene/Ziegler-Natta compositions disclosed herein may have further enhanced a biaxial state of orientation during the film-blowing process at a given set of processing conditions (e.g., BUR, DDR, FLH, etc.), which can be particularly responsible for a more isotropic tear behavior for the hafnocene/Ziegler-Natta-based film structures (as confirmed by the data plotted in FIG. 7 for MD and TD tear of these films).

TABLE 10
Linear Melt Rheology Parameters

| | M_{w} | | | η₀ | | |
|---|---|---|---|---|---|---|
| | (kg/mol) | M_{w}/Mₙ | M_{z}/M_{w} | (kPa · s) | τ_{w} (s) | cosδ\|ₐ_{_{M}}_{ω=0.1 rad/s} |
| Inv. 1 | 111.2 | 3.29 | 2.18 | 34.5 | 39.5 | 0.29 |
| Inv. 2 | 101.7 | 2.80 | 2.14 | 32.0 | 44.5 | 0.34 |
| Comp. 11 | 100.1 | 2.63 | 1.96 | 18.3 | 14.2 | 0.27 |
| Inv. 3 | 109.2 | 2.90 | 2.17 | 93.9 | 667.0 | 0.49 |
| Comp. 1 | 107.4 | 2.18 | 1.71 | 8.4 | 1.2 | 0.02 |
| Comp. 2 | 110.6 | 1.98 | 1.68 | 13.8 | 10.5 | 0.14 |
| Comp. 4 | 126.0 | 2.89 | 2.58 | 21.6 | 17.3 | 0.14 |
| Comp. 5 | 127.3 | 3.94 | 3.11 | 14.6 | 110.0 | 0.11 |
| Comp. 6 | 103.5 | 3.53 | 2.39 | 15.7 | 12.5 | 0.2 |
| Comp. 7 | 98.3 | 2.78 | 2.13 | 13.9 | 8.1 | 0.2 |
| Comp. 8 | 87.8 | 2.74 | 2.20 | 7.3 | 6.3 | 0.11 |

### Linear Melt Rheology Test Method

Oscillatory shear measurements under small strain-amplitudes were carried out to obtain linear viscoelastic functions at 190° C. under N₂ atmosphere, at a strain amplitude of 10% and over a frequency range of 0.02-126 rad/s at 5 points per decade. Frequency sweep experiments were performed with a TA Instruments DHR3 stress-controlled rheometer using a cone-plate geometry with a cone angle of 5°, a truncation of 137 μm and a diameter of 25 mm. In this experiment, a sinusoidal strain-wave was applied and the stress-wave response was analyzed in terms of linear viscoelastic functions (i.e., complex viscosity, complex modulus, etc.).

The obtained elastic and loss moduli versus angular frequency curves were fitted to a generalized Maxwell model to determine the relaxation time spectra of tested samples. The curve fitting was achieved by minimizing:

$${\sum }_{j} \frac{\begin{matrix}\{ {[ log {G}_{exp .}^{′} ( {ω}_{j} ) - log {G}_{p red .}^{′} ( {ω}_{j} ) ]}^{2} \times 0.7 + \\ {[ log {G}_{exp .}^{″} ( {ω}_{j} ) - log {G}_{p red .}^{″} ( {ω}_{j} ) ]}^{2} \times 0.3 \}\end{matrix}}{{[ log {G}_{exp .}^{′} ( {ω}_{j} ) ]}^{2} + {[ log {G}_{exp .}^{″} ( {ω}_{j} ) ]}^{2}} \qquad ( eq . 8 )$$

where

$${G}_{exp .}^{′} , {G}_{exp .}^{″} , {G}_{p red .}^{′} and {G}_{p red .}^{″}$$

are experimentally measured and predicted storage and loss moduli at an angular frequency of w; within the frequency range of 0.02-126 rad/s. The relaxation time spectrum was assumed to comprise two second order BSW components. Details of calculations could be found in Li et al., “Reproducible Relaxation Spectrum of Polyethylene via Global Log-Polynomial Kernel”, as published in SPE ANTEC 2014 Proceedings. The obtained relaxation time spectrum was further analyzed to determine the weight-average relaxation time (τ_{w}) of the tested samples, where:

$${τ}_{w} = {\sum }_{i = 1}^{i = 33} {τ}_{i}^{2} {g}_{i} / {\sum }_{i = 1}^{i = 33} {τ}_{i} {g}_{i} .$$

The zero-shear rate viscosity (no) based on the linear regime frequency sweep results was calculated using a 33-mode discrete relaxation time spectrum according to:

$${η}_{0} = {\sum }_{i = 1}^{i = 33} {τ}_{i} {g}_{i}$$

where τᵢ and gᵢ are relaxation times and strengths pairs. The obtained discrete relaxation time spectrum was further used to interpolate the phase-angle at a frequency of a_{M}ω=0.1 rad/s (δ|ₐ_{_{M}}_{ω=0.1 rad/s}).

### INDUSTRY APPLICABILITY

Provided is a polymer blend which comprises a low-density polyethylene and an ethylene copolymer composition. The polymer blend is suitable for use in a multilayer film structures which may find application in collation shrink packaging.

1. A polymer blend comprising from 20 to 50 weight percent of a low-density polyethylene (LDPE), and from 80 to 50 weight percent of an ethylene copolymer composition; wherein the ethylene copolymer composition is an ethylene-alpha-olefin copolymer composition comprising:
(i) from 30 to 50 weight percent of a first ethylene copolymer having a density of from 0.890 to 0.930 g/cm³, a molecular weight distribution (M_{w}/Mₙ) of from 1.7 to 2.3, and a melt index (I₂) of from 0.1 to 20 g/10 min;
(ii) from 50 to 70 weight percent of a second ethylene copolymer having a density of from 0.925 to 0.945 g/cm³, a molecular weight distribution (M_{w}/Mₙ) of from 2.3 to 6.0, and a melt index (I₂) of from 0.3 to 100 g/10 min; and
(iii) from 0 to 20 weight percent of a third ethylene copolymer;
wherein the number of short chain branches per thousand carbon atoms in the first ethylene copolymer (SCB1) is greater than the number of short chain branches per thousand carbon atoms in the second ethylene copolymer (SCB2);
the density of the second ethylene copolymer is greater than the density of the first ethylene copolymer;
the ethylene copolymer composition has a density of from 0.916 to 0.940 g/cm³, a molecular weight distribution (M_{w}/Mₙ) of from 2.3 to 6.0, a melt index (I₂) of less than 1 g/10 min, a nonlinear rheology network parameter (Δ_{int.}) of from 0.055 to 0.075, and a normalized molecular weight (Z) of from 80 to 120 wherein the normalized molecular weight is defined by Z=M_{w}/Mₑ;
and the LDPE has a melt index (I₂) of less than 3 g/10 min;
wherein the weight percent of the first, second or third ethylene copolymer is defined as the weight of the first, second or third copolymer respectively divided by the weight of the sum of (i) the first ethylene copolymer; (ii) the second ethylene copolymer; and (iii) the third ethylene copolymer, multiplied by 100; and the weight percent of the LDPE or the ethylene copolymer composition is defined as the weight of the LDPE or the ethylene copolymer composition respectively divided by the weight of the sum of the LDPE and the ethylene copolymer composition, multiplied by 100.

2. The polymer blend according to claim 1, wherein the ethylene copolymer composition has a molecular weight distribution (M_{w}/Mₙ) of from 2.3 to 5.0.

3. The polymer blend according to claim 1, wherein the ethylene copolymer composition has a melt flow ratio (I₂₁/I₂) of from 20 to 50.

4. The polymer blend according to claim 1, wherein the first ethylene copolymer has from 10 to 50 short chain branches per thousand carbon atoms (SCB1).

5. The polymer blend according to claim 1, wherein the second ethylene copolymer has from 3 to 25 short chain branches per thousand carbon atoms (SCB2).

6. The polymer blend according to claim 1, wherein the first ethylene copolymer is present in from 35 to 45 weight percent.

7. The polymer blend according to claim 1, wherein the second ethylene copolymer is present in from 55 to 65 weight percent.

8. The polymer blend according to claim 1, wherein the third ethylene copolymer is present in 0 weight percent.

9. The polymer blend according to claim 1, wherein the first ethylene copolymer is present in from 35 to 45 weight percent; the second ethylene copolymer is present in from 55 to 65 weight percent; and the third ethylene copolymer is present in 0 weight percent.

10. The polymer blend according to claim 1, wherein the third ethylene copolymer is present in from 5 to 15 weight percent.

11. The polymer blend according to claim 1, wherein the ethylene copolymer composition has a composition distribution breadth index (CDBI₅₀) of from 50 to 75 weight percent.

12. The polymer blend according to claim 1, wherein the ethylene copolymer composition has a weight average relaxation time of from 30 seconds to 1000 seconds.

13. The polymer blend according to claim 1, wherein the ethylene copolymer composition has at least 0.8 mole percent of one or more than one alpha-olefin.

14. The polymer blend according to claim 1, wherein the ethylene copolymer composition has from 0.8 to 10 mole percent of one or more than one alpha-olefin.

15. The polymer blend according to claim 1, wherein the ethylene copolymer composition has from 1 to 8 mole percent of one or more than one alpha-olefin.

16. The polymer blend according to claim 13, wherein said one or more than one alpha-olefin is selected from the group comprising 1-hexene, 1-octene and mixtures thereof.

17-20. (canceled)

21. The polymer blend according to claim 1, wherein the first ethylene copolymer is made with a single-site catalyst system comprising a metallocene catalyst having the formula (I): 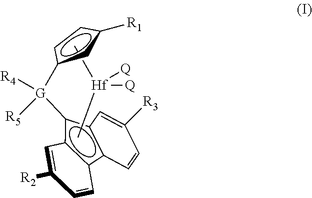
wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

22. The polymer blend according to claim 1, wherein the first ethylene copolymer has a composition distribution breadth index (CDBI₅₀) of at least 75 weight percent.

23-25. (canceled)

26. The polymer blend according to claim 1, wherein the second ethylene copolymer has a M_{w}/Mₙ of from 2.5 to 5.0.

27. The polymer blend according to claim 1, wherein the ethylene copolymer composition has from 0.050 ppm to 2.5 ppm of hafnium.

28-32. (canceled)

33. A film layer comprising the polymer blend according to claim 1.

34-46. (canceled)

47. An ethylene copolymer composition comprising:
(i) from 30 to 50 weight percent of a first ethylene copolymer having a density of from 0.890 to 0.930 g/cm³, a molecular weight distribution (M_{w}/Mₙ) of from 1.7 to 2.3, and a melt index (I₂) of from 0.1 to 20 g/10 min;
(ii) from 50 to 70 weight percent of a second ethylene copolymer having a density of from 0.925 to 0.945 g/cm³, a molecular weight distribution (M_{w}/Mₙ) of from 2.3 to 6.0, and a melt index (I₂) of from 0.3 to 100 g/10 min; and
(iii) from 0 to 20 weight percent of a third ethylene copolymer;
wherein the number of short chain branches per thousand carbon atoms in the first ethylene copolymer (SCB1) is greater than the number of short chain branches per thousand carbon atoms in the second ethylene copolymer (SCB2);
the density of the second ethylene copolymer is greater than the density of the first ethylene copolymer;
the ethylene copolymer composition has a density of from 0.916 to 0.940 g/cm³, a molecular weight distribution (M_{w}/Mₙ) of from 2.3 to 6.0, a melt index (I₂) of less than 1 g/10 min, a nonlinear rheology network parameter (Δ_{int.}) of from 0.055 to 0.075, and a normalized molecular weight (Z) of from 80 to 120 wherein the normalized molecular weight is defined by Z=M_{w}/Mₑ;
wherein the weight percent of the first, second or third ethylene copolymer is defined as the weight of the first, second or third copolymer respectively divided by the weight of the sum of (i) the first ethylene copolymer; (ii) the second ethylene copolymer; and (iii) the third ethylene copolymer, multiplied by 100.

48-75. (canceled)
